(19) United States
(12) Patent Application Publication
(10) Pub. No.: US 2001/0044781 A1
(43) Pub. Date: Nov. 22, 2001

(54) Computer implemented and/or assisted method and system for facilitating the licensing of media content

(75) Inventor: Christina S. Shutes, Washington, DC (US)

Correspondence Address: HALE & DORR LLP, THE WILLARD OFFICE BUILDING, 1455 PENNSYLVANIA AVE, NW, WASHINGTON, DC, 20004, US

(73) Assignee: PhotoAssist, Inc., Washington, DC (US)

(21) Appl. No.: 09/798,073

(22) Filed: Mar. 5, 2001

Related U.S. Application Data
(60) Provisional application No. 60/204,743, filed on May 17, 2000.

(51) Int. Cl. G06F 17/60; H04L 9/00; H04K 1/00

(52) U.S. Cl. 705/59; 705/52; 705/53; 705/7

(57) ABSTRACT

The present invention provides an Apparatus and a Process to expedite the licensing and management of content for communications projects, including books, magazines, newsletters, posters, advertisements, videos, films, television, CD ROMs, digital media, multimedia, and other content. The Apparatus allows the User to expedite several of the administrative tasks necessary to research, obtain, track and license content. In addition, it allows the User to quickly determine the technical and contractual viability of potential designs or drafts of the project. The Process allows the User to streamline negotiation, implementation, and payment of licensing contracts by efficiently gathering, organizing, and utilizing project information, technical specifications, and/or licensing terms. It also assists the User in tracking budgets and managing resources within the production of the project. The electronic portion of the Apparatus can be accessed using a personal computer, an internal network and a server, an external network and a server, dial-up system, or other electronic communications method. The electronic portion of the Apparatus will also be able to communicate and/or integrate with third party software used to design and edit communications projects.

### 1. RELATED APPLICATIONS

This Application claims the benefit of Provisional Patent Application Ser. No. 60/204,743, filed May 17, 2000, incorporated herein by reference.

### BACKGROUND OF THE INVENTION

2. Field of Invention

This invention relates to the licensing of content within the field of communications. More particularly, it relates to a computer implemented and/or assisted Process and Apparatus to streamline the licensing of image related content.

3. Background of the Related Art

Licensing of pre-existing content is a common practice in the communications field. However, the negotiation, documentation, maintenance, implementation, and archiving of licensing information for a communication project requires a substantial amount of time and effort. Traditionally, there has not been a unified approach to the basic steps in the licensing process, storage and use of licensing information during the licensing process, and the archiving of licensing information after the project is complete. This often results in wasteful repetition of work and confusion regarding the terms and implementation of licensing contracts. These problems are heightened by the common practice of re-licensing content for new editions, ancillary products, or extended production runs based on the terms of the original licensing contracts. Ultimately, repetition of work negatively effects the project's budget, and confusion regarding the licensing terms for content can lead to unintentional copyright infringement and its associated penalties.

One attempt to modernize the licensing of contracts is presented by U.S. Pat. No. 5,765,152, to Erickson, Jun. 9, 1998, incorporated herein by reference, which relates to a system for managing copyrighted electronic media. The system of the '152 patent provides for the secure electronic copyright management and automatic identification of ownership of creative works distributed as digital or electronic media, particularly over computer networks (Col. 3, lines 18-21). In that invention, a digital file is constructed by packaging the electronic media into a secure document format which manages or otherwise enables the control, access, and/or licensing of the media. (See Col. 3 lines 13-17). The packaged media has some minimum permission set associated with it, and the permission set can be updated to an auxiliary permission data set through on-line licensing should the User be interested in more advanced licensing. See Col. 3, lines 35-44, Col. 4 lines 30-36.

The following is an embodiment of the invention described in the U.S. Pat. No. 5,765,152. FIG. 1A (prior art) illustrates system 200 constructed according to the U.S. Pat. No. 7,765,152. The system 200 includes a server 202 which operates as a registration and authorization server for any of the DOCUMENTs 204a, 204b, 204c, and 204d stored in a library 206. By way of example, the library 206 can be a publisher's library of any or all of the original works owned by or authored for the publisher. Author 208, for example, illustrates one such author connected to the library 206 through a personal computer 210 and communication line 212. The computer 210 is a data processor that includes a PACKAGER 214 constructed according to the invention and as described herein above. In the preferred embodiment, the PACKAGER 214 is a software module stored within the computer's internal memory 210a to control the data processor's actions in accord with the invention. Through the PACKAGER 214, the author 208 can create and package any of the DOCUMENTs 204. The computer 210 also includes a communication section 210a, to facilitate on-line communications, and a computer display 210b. (NOT FOUND IN FIGURE)

The DOCUMENTs 204 are secure containers of electronic media, as described herein, and are stored in the library 206 as digital files, such as within a CD-ROM, or within a computer's memory. Preferably, the DOCUMENTs are stored such that a User such as User 216 can access the DOCUMENTs through an on-line connection 218 between the User's personal computer 220 and the library 206.

The owner of the library 206 may also have copyrights in DOCUMENTs such as DOCUMENT 204e, which represents a CD-ROM of a media-packaged work that is distributed to the User 216 by mail. The CD-ROM 204e exemplifies one other published work that is created by the author 208 and packaged by the PACKAGER 214. As above, the server 202 also functions as the registration and authorization server for DOCUMENT 204e.

In accord with the invention, the User's computer 220 is a data processor that includes a VIEWER 222 constructed according to the invention and as described herein above. In the preferred embodiment, the VIEWER 222 is a software module stored within the computer's internal memory 220a to control the data processor's actions in accord with the invention. A CD-ROM drive 224 is preferably connected to the User's computer 220 via data line 220d to facilitate access to CD-ROM files such as DOCUMENT 204e.

Through the VIEWER 222, User 216 can access any of the DOCUMENTs 204a-e up to the minimum permissions authorized by each of the DOCUMENTs. By way of example, the minimum permissions data set within each DOCUMENT typically authorizes the User 216 to view the DOCUMENTs 204a-e; but not to download, modify, save or otherwise electronically transfer the DOCUMENTs. The data transfers required to access the DOCUMENTs 204a-d up to the minimum permissions data set occur through communication line 218; while the only data transfers required to access the DOCUMENT 204e up to its minimum permissions data set are between the computer 220 and the CD-ROM drive 224.

If the User 216 wishes to augment the authorizations to any of the DOCUMENTs 204, for example to modify or save the DOCUMENT at the computer 220, she must communicate with the server 202 and transact a license with that server. The data processor 220 thus includes a communication section 220b that is connected for data transfers, over communication line 226, with a compatible communication section 202a of the server 202. Upon selection by the User 216, the VIEWER 222 determines from the selected DOCUMENT 204 that authorization server 202 is assigned to handle all licenses to that DOCUMENT, and the VEWER controls the computer 220 to connect to the server 202 at the right address so that an on-line licensing transaction can occur.

Specifically, once the User 216 indicates that additional permissions to the DOCUMENT 204 are desired, the VIEWER can display selected terms to the DOCUMENT, as stored within the DOCUMENT or as stored within the server 202. In either case, the VIEWER causes the computer 220 to generate a licensing request signal and issue that signal to the server 202. Preferably, the User 216 also designates—through the VIEWER—the desired use of the media within the DOCUMENT. The User 216 can thereafter accept the licensing terms to the DOCUMENT 204, and, if accepted, the User 216 receives notification from the server 202 that auxiliary permissions are granted for the desired use.

In the event that DOCUMENT 204 is a derivative work, the VIEWER 222 determines that auxiliary permissions are also required, for example, from server 228, the server designated by the original author of the media within DOCUMENT 204.

The server 202 stores transactional information about the DOCUMENTs 204. For example, each license transacted through the server 202 is stored in a file 229a, such as within a computer memory 230. In this way, the owner or administrator of the DOCUMENTs can assess the licensing fees generated by the DOCUMENTs. Likewise, the server 202 also stores information or files 229b that set forth the number of DOCUMENTs registered thereon, so that, again, the owner or DOCUMENT-administrator can assess server usage. The files 229a, 229b are preferably available through the communication section 202a.

In one embodiment of the invention, the server 202 includes an internal memory 202b, connected to the communication section 202a, that stores selected information about the DOCUMENTs registered thereon. For example, licensing terms to the DOCUMENT 204 can be stored within the memory 202b. A relay section 202c operates to relay such terms to the processor 220 in response to a license request signal prompted by the User 216. A data comparison section 220d operates to compare the User's reply to the licensing terms and to generate and transmit the requested auxiliary permissions when the response signals correspond to the requisite terms specified in the license information stored in memory 202b (or alternatively in the DOCUMENT). Accordingly, once the User 216 receives the auxiliary permissions, that User is provided with additional authorizations to use the media within the DOCUMENT 204; and the VIEWER 222 enables the User 216 to access the DOCUMENT 204 up to the maximums allowed in the bumped-up permissions data set.

As indicated in the Erickson patent, the system provides and manages copyrighted electronic media, thereby solving or reducing pirating of the copyrighted data. The system also provides a method for maintaining an electronic bibliographic record of successive data transfers of protected electronic media. The Erickson patent also provides a system for packaging and unpackaging electronic media within an electronic container to facilitate the management of copyrighted electronic media. Thus, the Erickson patent is related to the protecting of copyrighted data by the copyright owner or agent.

However, the Erickson patent is unrelated to assisting both the licensor and licensee with the licensing process. It makes no provisions for negotiation, tracking, documentation, implementation, revisions, or archiving of the licensing terms for the packaged media. It fails to allow the licensor to manage a project's licensing information in a unified manner, and therefore fails to eliminate wasteful duplication of work throughout the process. For example, Erickson does not capture project and licensing information in a manner that allows for the efficient, automatic creation of administrative reports, licensing contracts and documents, cost estimates, and/or other project documents. The Erickson patent is also unrelated to and/or incapable of effectuating an efficient re-licensing procedure. Hence, the Erickson patent does not provide the User with the process or tools to efficiently manage the licensing of content.

Furthermore, the Erickson patent licenses pieces of content individually, and does not consider licensing on a project-wide basis. For instance, the Erickson patent does not contemplate the licensing of multiple pieces of content, each used in a different manner. Nor does Erickson allow the licensor to compare the terms of the packaged media license to the license of another piece of content from a different vendor. Hence, the Erickson patent does not provide the User with the process or tools to manage licensing information for entire projects.

Erickson's patent does not allow for the tracking of technical requirements for the content of the project. For example, it does not allow for the licensor to automatically include technical requirements for the content with the licensing documentation sent to the Content Vendor. Hence, the Erickson patent does not provide the User with the process or tools to efficiently integrate licensing information with other project related information, thereby expediting the production process.

### 4. OBJECTS & ADVANTAGES

Accordingly, it is desirable to utilize a standardized, interactive licensing procedure which has been streamlined to eliminate much of the wasteful repetition of effort which has traditionally been part of licensing content, and re-licensing content, for a communications project.

It is desirable to manage and administer the licensing of content on a project-wide basis.

It is desirable to track technical requirements and other project specifications when licensing content, and to efficiently communicate this information to Content Vendors.

It is further desirable to provide the User including optionally the licensor and/or the potential licensee with the tools to manage licensing information for projects in a unified manner. For instance, it is desirable to track licensing terms in such a way that the User can automatically create licensing documents, such as permission letters and the like, for multiple pieces of content with minimal repetition of work.

It is further desirable to provide the User with tools to administer and manage the licensing of content on a project-wide basis.

It is also desirable to provide tools to track technical requirements and project specifications, so they can be efficiently communicated to vendors.

In summary, it is desirable to streamline the traditional licensing procedure of content for a project. It is also desirable to provide a system/tools that administers and/or manages content in a manner which facilitates the licensing process, for example, by providing cost estimates for design drafts and/or administering the myriad of requirements, specifications and/or other licensing related information to effectuate the licensing process. It is also desirable to provide a system that effectuates an efficient re-licensing procedure.

Further objects and advantages of the invention will become apparent from a consideration of the drawings and ensuing description.

### SUMMARY OF THE INVENTION

The current invention seeks to streamline the licensing process itself. It provides in one embodiment of the invention, an interactive Process and an Apparatus to expedite the licensing and management of content for communications projects, including but not limited to, books, magazines, newsletters, posters, advertisements, videos, films, television, CD ROMs, and other digital media. The Process and Apparatus are particularly useful, for example, for large projects such as a secondary school textbook, which can regularly contain over 1,000 licensed pieces of content from potentially 200 different sources.

The Process allows the User to streamline negotiation, implementation, and payment of licensing contracts related to multiple pieces of content from multiple content licensors by efficiently gathering, organizing, and utilizing project information, technical specifications, and/or licensing terms. For example, the Process herein calls for the User to optionally negotiate licensing fees for a variety of potential uses of content before the design process begins. Thereby, the User can determine the cost associated with different design drafts and determine which will meet her budget requirements.

The Apparatus allows the User to expedite several of the administrative tasks necessary to research, obtain, track and license content. In addition, it allows the User to quickly determine the financial, technical, and contractual viability of potential designs or drafts of the project. For example, the Apparatus allows the User to record administrative information that applies to all of the content licenses once. It then matches the administrative information with individual licenses automatically, thereby saving the User from having to enter the administrative information for each license seapartely.

The electronic portion of the Apparatus can be accessed using a personal computer, an internal computer network and a server, an external computer network and a server, dial-up system, or other electronic communication methods. The electronic portion of the Apparatus is able to communicate and/or integrate with third party software used to design and edit communications projects.

Accordingly, it is a feature and advantage of the present invention to utilize a standardized, interactive licensing process which has been streamlined to eliminate much of the wasteful repetition of effort which has traditionally been the case when licensing, and re-licensing, content for a communications project.

It is another feature and advantage of the present invention to manage and administer the licensing of content or groups of content on a project-wide basis.

It is another feature and advantage of the present invention to track project specifications and technical requirements when licensing content, and to efficiently communicate them to Content Vendors.

It is a feature and advantage of the present invention to provide the User including optionally the licensor and/or the potential licensee with the tools to manage licensing and re-licensing of content in an efficient and organized manner.

It is another feature and advantage of the present invention to provide the User with the tools to administer and manage the licensing of content on a project-wide basis.

It is another feature and advantage of the present invention to provide the tools to track technical requirements and project specifications in the licensing of copyrighted content, so they can be efficiently communicated to Content Vendors.

In summary, it is a feature and advantage of the present invention to streamline the licensing procedure traditionally used in the licensing of content for a project. It is also a feature and advantage to provide a system that administers and/or manages content in a manner which facilitates the licensing process, for example, by providing cost estimates for design drafts and/or administering the myriad of requirements, specifications and/or other licensing related information to effectuate the licensing process.

It is another feature and advantage of the present invention to provide a system that effectuates an efficient re-licensing procedure.

The system or Apparatus is made up of the four modules listed below:

1) The Information Storage System(s) allow the User to store information pertaining to the project in a central location. It may include:

a) Electronic Storage

b) Hard Copy Storage

2) The Electronic Data Record Groups allow the User to track, exploit, and organize content and content data. They can be organized within a single database or within multiple databases that communicate with each other. They may include:

a) Working Copy Records

b) Content Data Records

c) Manipulated Content Records

3) The Communication Links allow the Apparatus to communicate with data generated outside of the Apparatus, including data from a design/editing system (s) and/or an accounting system(s) and/or other optional modules.

4) The Project Record Archive allows the User to store all of the information, data, and project records in a central location, where they can be easily accessed, reviewed, and manipulated to provide the User with a variety of administrative and financial forms and reports. It may include:

a) Electronic Storage

b) Hard Copy Storage

The electronic portions of the Apparatus will communicate with each other directly, allowing information to flow between Apparatus modules as necessary. It can be created using existing software products and/or languages, and/or can be created using unique software products and languages.

The Apparatus may include additional modules, which assist the User with tasks related to the project. For example, the User might choose to include design/editing, accounting, printing, internal communication, and/or project management system(s) modules within the Apparatus. Similarly, the Apparatus might be included as a module of a larger production system—such as a book or magazine publishing system.

Should the User choose to include optional modules within the Apparatus, she may:

1) employ third party system(s) that communicate with the Apparatus using the Communication Links

2) choose to create unique, original system(s) which will directly communicate with other modules of the Apparatus.

The Process of the present invention facilitates the licensing of content, management and tracking of content and other valuable materials during production, tracking of budget expenditures, management of technical requirements for content, compliance with contractual responsibilities, and the archiving of records. It can be divided into four sections, each based upon a family of tasks within the larger process:

Section A of the Process includes gathering and storing project specific information necessary to efficiently communicate (and document that communication) with third parties, such as Content Vendors and service providers. This information might include administrative details (such as publishing specifications, budgets, service providers and their accounting information, staff members, etc. . . . ) technical details (such as minimum digital image sizes, acceptable data formats, etc. . . . ), and contractual details (such as licensing terms, final specifications of the content's use, payment deadlines, etc. . . . ) By storing this information in a manner which allows quick access, the User may efficiently create the myriad of correspondence, documents, and reports necessary to administer and manage the project and to license selected content.

Should the User choose to use the Electronic Storage Files to store this information, she could further expedite her work by creating templates to extract pertinent information from the Electronic Storage Files and organize it into correspondence, documentation, and report formats. Advantageously, the Apparatus can access the same piece of information for multiple purposes. The User enters each piece of information just once, then accesses it to create the multitude of administrative, technical, and contractual communications and records that require it. For example, the User might record the licensing fees for a Content Vendor once. That information could then be used to create a licensing contract, a final use notification, a purchase order or other accounting documentation, a re-licensing notification, and/or a comparison of vendor prices.

The Apparatus may also allow the User to electronically transmit correspondence, documentation, and reports directly to Content Vendors, project staff, and other third parties.

Section B of the process allows the User to track valuable materials, including but not limited to content, throughout the production procedures. The User records the submission information for each piece of, or group of, valuable materials she receives. She records similar information for each transfer and/or return of valuable materials. By creating records of all materials received, transferred to third parties, and returned to their source, the User can accurately account for all of the valuable materials submitted to her during the course of the project. By storing the submission, transfer, and return records within the Electronic Storage Files of the Apparatus, and using a template process similar to that in Section A, the User can create correspondence, documents, and reports to assist her in completing and documenting each submission, transfer, and return.

Section C in the Process links the master, working, and manipulated content copies to their content data, technical specifications, and licensing terms. The User may then create a draft of her project using a design/editing system, manipulating the content within it as she needs. By accessing the identification link within the manipulated content copy used in the draft and matching it to the other content records, the Apparatus will assist the User in quickly and easily reviewing the financial, contractual, and technical responsibilities and/or viability of her project draft. It will also assist her in communicating production information to third parties by organizing reports, such as a list of credit lines for the project's index.

In Section D of the process, when a design has been finalized, the User may employ the Apparatus to store the final pricing specifications for each piece of content. By storing this information in a manner which allows the User to access it quickly, and integrating it with technical and contractual information previously entered, she may efficiently create use notifications (listing final use specifications, associated licensing terms, and compliance instructions) to convey to Content Vendors.

If the User has stored all of the administrative, contractual, technical, and use information electronically, she could also employ the Apparatus to create use notifications, using a template process to access and organize pertinent information, such as in Section A above.

The User may record her compliance with licensing terms, such as payment information, in the Apparatus. The User may also choose to link the Apparatus with other optional modules (such as accounting, shipping, printing, and/or project management systems) using the Communication Links, thus integrating the payment or and/or compliance with licensing terms with her own records.

The User may then archive all of the project records. She may wish to include materials from other sections of the production process, such as copies of design layouts from design/editing systems or printing press specifications. The User may choose to store the project records in electronic form (such as on a CD ROM), in hard copy form, or in a combination of both. The User may wish to archive the records within a larger archive that contains the records from other projects.

Finally, the User may wish to access the project records in the archive to review and make use of various details of the project at a later date. For example, she may verify compliance with licensing terms, create forms and documents to assist her in re-licensing content for new editions/variations of the project, creating a series of reports comparing project or vendor information with similar information from other projects, and/or creating estimates for new projects.

Advantageously, the present invention provides a User interface and/or functionality to generate reports and other information that further assist the licensor and licensee in administering the license, particularly in the area of licensing of, for example, copyright protected data or other data.

In accordance with one embodiment of the invention, a computer implemented or computer assisted interactive process facilitates at least one of licensing, management and tracking of valuable materials during production, tracking of budget expenditures, management of technical specifications, management of production specifications, compliance with contractual responsibilities, and archiving of records associated therewith with a User. The process authorizes the User to use the content comprising at least one of images and data to be licensed within a project in accordance with the publishing specifications, the project specifications, and the technical specifications. The process includes at least one of the sequential, non-sequential and sequence-independent steps of generating administrative correspondence, documentation, and reports including administrative, technical, and contractual information to communicate and document at least one communication with third parties including at least one of Content Vendors, service providers and project staff. The process also includes tracking the content using a plurality of records, wherein at least one record is associated with a different piece of content to be licensed and the project includes a plurality of different data content to be licensed, and generating correspondence, documents, and reports to at least one of assist the User in completing and documenting the content to be licensed. The process also includes determining the licensing terms and the technical requirements, and generating a project proposal for the project to assist the User in obtaining and reviewing a financial estimate, contractual, and technical information relating to the licensing of the content.

A computer system, computer readable medium, and process is also provided.

There has thus been outlined, rather broadly, the main features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the Figures. The invention is capable of other embodiments and of being practiced and carried out in various ways. Also, it is to be understood that the phraseology and terminology employed herein are for the purpose of description and should not be regarded as limiting. Specifically, for the purpose of illustration, the detailed description of the invention often uses “images” as an example of a type of content that could be licensed using the invention. This should in no way be interpreted as limiting the use of the invention to images and/or other visual content.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

The above objects of the invention, together with other apparent objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF DRAWINGS

FIG. 1A—Prior Art showing the technical process of Erickson, (U.S. Pat. No. 5,765,152, Jun. 9, 1998)

FIG. 1—Conceptual drawing of the Apparatus

FIG. 2—Conceptual drawing of the Licensing Process

FIGS. 3, 4, 5, 6, 7, 8, 9, 10—Conceptual drawings of Section A of the Licensing Process (Creating Administrative Correspondence, Documentation, and Reports)

FIGS. 11, 12, 13, 14, 15—Conceptual drawings of Section B of the Licensing Process (Tracking Valuable Materials Using Submission, Transfer, and Return Records)

FIGS. 16, 17, 18, 19, 20, 21, 22, 23, 24, 25, 26—Conceptual drawings of Section C of the Licensing Process (Designing and/or Editing Content, Determining Associations of Manipulated Content, Licensing Terms, and Technical Requirements)

FIGS. 27, 28, 29, 30, 31, 32, 33, 34, 35—Conceptual drawings of Section D of the Licensing Process (Confirming Final Use of Content, Complying with Licensing Terms, Archiving Records, and Accessing and Analyzing Records)

FIG. 36—Conceptual drawing of other applications for the Process and Apparatus

FIG. 37—Main menu of sample embodiment of invention

FIGS. 38, 38A, 38B, 38C, 38D, 38E, 38F, 38G, 38H—Project information screens, reports, and correspondence of sample embodiment of invention

FIGS. 39, 39A, 39B, 39C, 39D, 39E, 39F, 39G, 39H, 39I, 39J, 39K—Licensing screens, reports, and correspondence of sample embodiment of invention

FIGS. 40, 40A, 40B, 40C, 40D, 40E—Image Requests screens, reports, and correspondence of sample embodiment of invention

FIGS. 41, 41A, 41B, 41C, 41D, 41E, 41F, 41G, 41H, 41I, 41J—Valuable Materials Tracking screens, reports, and correspondence of sample embodiment of invention

FIGS. 42, 42A, 42B, 42C, 42D, 42E, 42F, 42G, 42H, 42I, 42J, 42K—Image Information screens, reports, and correspondence of sample embodiment of invention

FIGS. 43, 43A, 43B, 43C, 43D, 43E, 43F, 43G, 43H, 43I, 43J, 43K, 43L, 43M—Use and Payment screens, reports, and correspondence of sample embodiment of invention.

FIGS. 44, 44A, 44B, 44C, 44D—Re-licensing screens, reports, and correspondence of sample embodiment of invention

FIGS. 45 and 45A—Financial analysis reports

FIG. 46—Illustration of a main central processing unit for implementing the computer processing in accordance with a computer implemented embodiment of the present invention.

FIG. 47—Illustration of a block diagram of the internal hardware of the computer of FIG. 46.

FIG. 48—Illustration of a block diagram of the internal hardware of the computer of FIG. 46 with a second embodiment.

FIG. 49—Illustration of an exemplary memory medium which can be used with disk drives

FIG. 50—Illustration of the architecture of the combined internet, POTS and ADSL architecture for use in the present invention.

### NOTATIONS AND NOMENCLATURE

A Glossary of terms used within the detailed description is included at the end of the present application.

The detailed descriptions which follow may be presented in terms of program procedures executed on a computer or on a network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to an apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

### DETAILED DESCRIPTION OF PREFERRED EMBODIMENT OF THE INVENTION

Reference now will be made in detail to the presently preferred embodiments of the invention. Such embodiments are provided by way of explanation of the invention, which is not intended to be limited thereto. In fact, those of ordinary skill in the art may appreciate upon reading the present specification and viewing the present drawings that various modifications and variations can be made.

For example, features illustrated or described as part of one embodiment can be used on other embodiments to yield a still further embodiment. Additionally, certain features may be interchanged with similar devices or features not mentioned yet which perform the same or similar functions. It is therefore intended that such modifications and variations are included within the totality of the present invention.

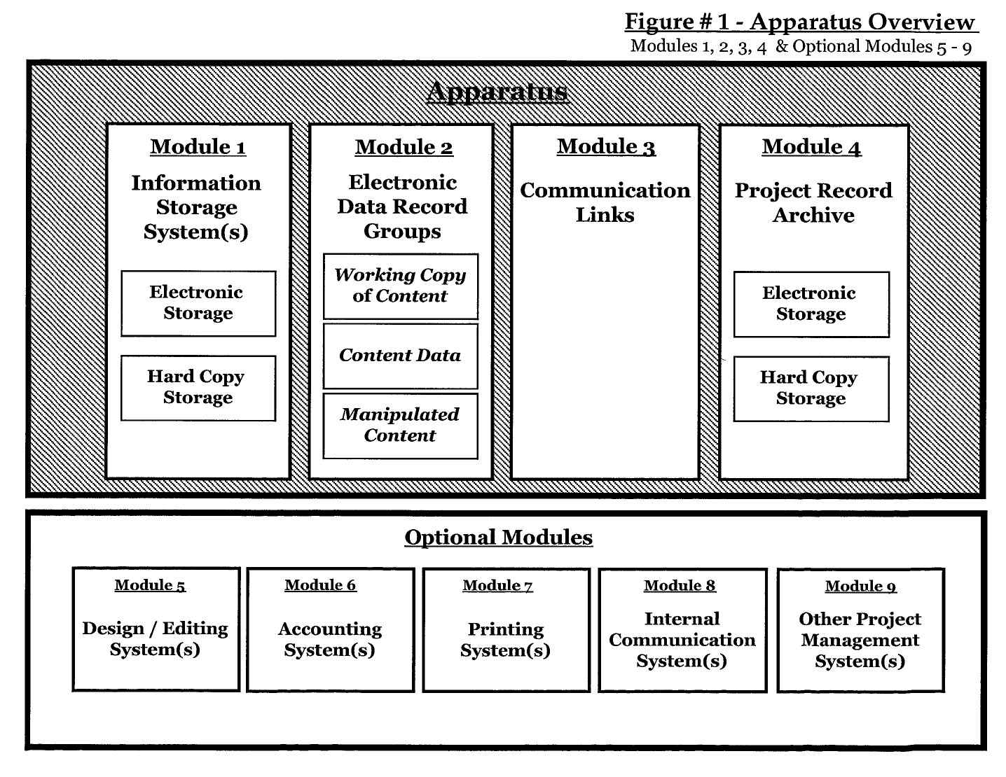

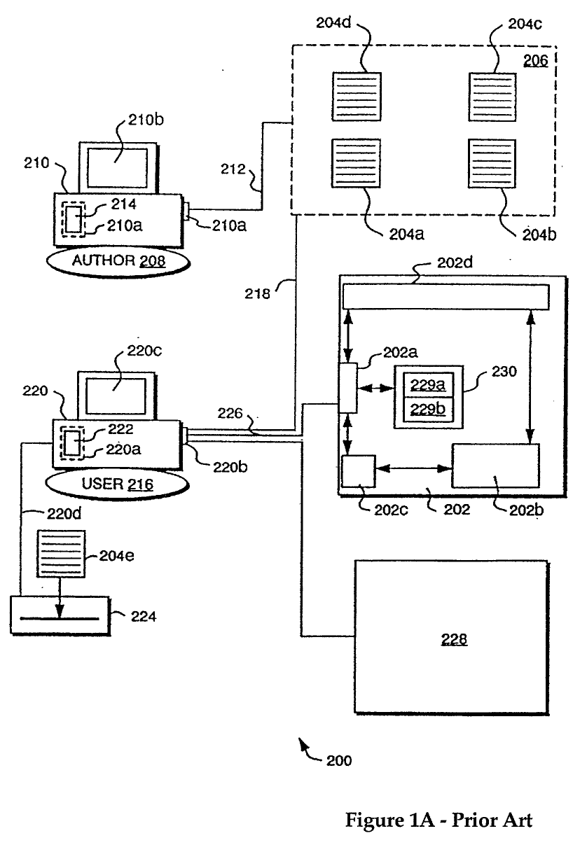

Apparatus Overview (FIG. 1)

The Apparatus allows the User to efficiently utilize project and licensing information, thereby facilitating a variety of administrative tasks. Further, the Apparatus is flexible enough to allow the User to accommodate changes in work flow and production plans during the course of the project.

Apparatus Modules

The Apparatus is made up of the four modules listed below. Records for multiple projects can be stored simultaneously within the Apparatus. While the Apparatus exists in whole, as outlined in FIG. 1, only active modules of the Apparatus are included in the Process Drawings.

Module 1) The Information Storage System(s) allow the User to store information pertaining to the project in a central location. It may include:

a) Electronic Storage

b) Hard Copy Storage

Module 2) The Electronic Data Record Groups allow the User to track, exploit, and organize content and content data. They can be organized within a single database or within multiple databases that communicate with each other. They may include:

a) Working Copy Records

b) Content Data Records

c) Manipulated Content Records

Module 3) The Communication Links allow the Apparatus to communicate with data generated outside of the Apparatus, for example, data from a design/editing system(s), an accounting system(s), and/or other optional modules.

Module 4) The Project Record Archive allows the User to store all of the information, data, and project records in a central location, where they can be easily accessed, reviewed, and manipulated to provide the User with a variety of administrative and financial forms and reports. It may include:

a) Electronic Storage

b) Hard Copy Storage

The electronic portions of the Apparatus will communicate with each other directly, allowing information to flow between Apparatus modules as necessary.

The Apparatus can be created using commercially available software programs or by using custom built program(s) and/or software language(s).

Variations of Apparatus (Optional Modules)

The Apparatus may include additional modules, which assist the User with tasks related to the project. For example, the User might choose to include design/editing, accounting, printing, internal communication, and/or project management system(s) modules within the Apparatus (as outlined in Apparatus Overview—FIG. 1). Similarly, the Apparatus might be included as a module of a larger production system—such as a book or magazine publishing system.

Should the User choose to include optional modules within the Apparatus, she may:

1) employ third party system(s) that communicate with the Apparatus using the Communication Links

2) choose to create unique, original system(s) which will directly communicate with other modules of the Apparatus.

For the purposes of the Process Outline drawings of this application, we have shown the Apparatus without the optional modules incorporated into it. Instead, optional modules are shown as separate entities, which communicate with the Apparatus using the Communication Links.

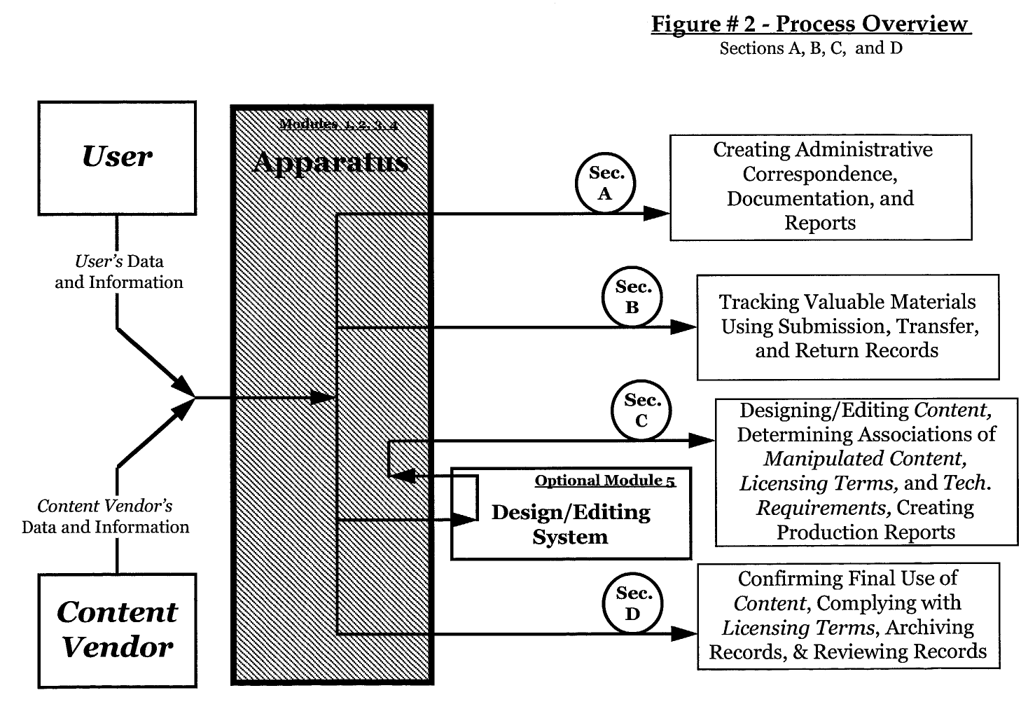

Process Overview FIG. 2

The Process outlined here facilitates the licensing of content, management and tracking of content and other valuable materials during production, tracking of budget expenditures, management of technical requirements for content, compliance with contractual responsibilities, and the archiving of records. It can be divided into four sections, each based upon a family of tasks within the larger process.

Section A—Creating Administrative Correspondence, Documentation, and Reports

The first steps of the Process include gathering and storing information necessary to efficiently communicate (and document that communication) with third parties, such as Content Vendors and service providers.

By storing administrative, technical, and contractual information in a manner which allows quick access, the User may efficiently create the myriad of correspondence, documents, and reports necessary to manage the project and license selected content without wasteful repetition.

Should the User choose to use the Electronic Storage Files to store this information, she could further expedite her work by creating templates to extract pertinent information from the Electronic Storage Files and organize it into correspondence, documentation, and report formats. As the Apparatus can access the same piece of information for multiple purposes, the User is able to enter each piece of information just once to create almost all of the administrative communications and records she will need.

The Apparatus may also allow the User to electronically transmit correspondence, documentation, and reports directly to Content Vendors, project staff, and other third parties.

Section B—Tracking Valuable Materials Using Submission, Transfer, and Return Records

Section B of the Process allows the User to track valuable materials, including but not limited to content, throughout the production procedures. The User records the submission information for each piece of or group of valuable materials she receives. She records similar information for each transfer and/or return of valuable materials. By creating records of all materials received, transferred to third parties, and returned to their source, the User can accurately account for all of the valuable materials she has received.

By storing the submission, transfer, and return records within the Electronic Storage Files of the Apparatus, and using a template process similar to that in Section A, the User can create correspondence, documents, and reports to assist her in completing and documenting each submission, transfer, and return.

Section C—Designing/Editing Content; Determining Associations of Manipulated Content, Licensing Terms, & Technical Requirements, Creating Production Reports

This portion of the Process links the master, working, and manipulated content copies to their content data, technical specifications, and licensing terms. The User may then create a draft of her project using a design/editing system (shown here outside of the Apparatus), manipulating the content within it as she needs. Accessing the identification link within the manipulated content copy used in the draft, and matching it to the other content records, the Apparatus will then assist the User in quickly and easily reviewing the financial, contractual, and technical responsibilities and/or viability of her project draft. It will also assist her in creating production reports containing details for the design, such as credit line and storage location lists.

Section D—Confirming Final Use of Content, Complying with Licensing Terms, Archiving Records, and Accessing and Analyzing Records.

When a design has been finalized, the User may employ the Apparatus to store the final pricing specifications for each piece of content. By storing this information in a manner which allows the User to access it quickly, and integrating it with technical and contractual information previously entered, she may efficiently create use notifications (listing final pricing specifications, associated licensing terns, and compliance instructions) to convey to Content Vendors.

If the User has stored all of the administrative, contractual, technical, and use information electronically, she could also employ the Apparatus to create use notifications, using a template to access and organize pertinent information.

In addition, the User may record her compliance with licensing terms, such as payment information, in the Apparatus. The User may choose to link the Apparatus with other optional modules (such as accounting, shipping, printing, and/or project management systems) using the Communication Links, thus integrating the payment or and/or compliance with licensing terms with her own records.

The User may archive all of the project records. She may wish to include materials from other sections of the production process, such as copies of design layouts from design/editing systems or printing press specifications. The User may choose to store the project records in electronic form (such as on a CD ROM), in hard copy form, or in a combination of both. The User may wish to archive the records within a larger archive that contains the records from other projects.

Finally, the User may wish to access the project records in the archive to review and make use of various details of the project at a later date. For example, she may verify compliance with licensing terms, create forms and documents to assist her in re-licensing content for later editions/variations of the project, create a series of reports comparing project or vendor information with similar information from other projects she has completed, and/or create estimates for new projects.

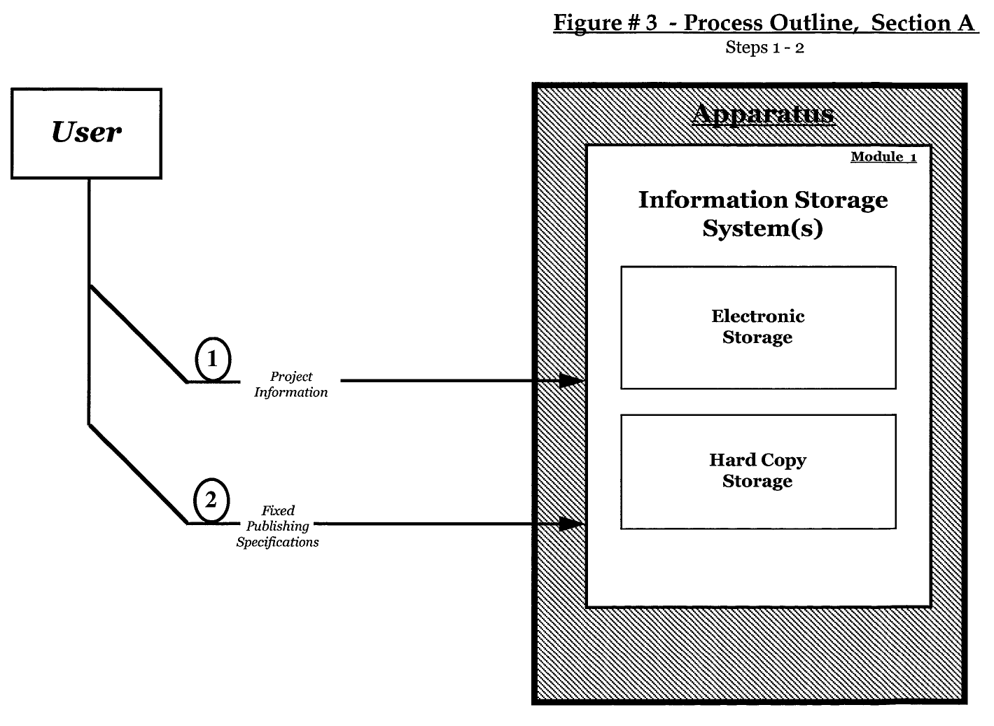

Process Outline (FIGS. 3-35)

While the ideal production scenario would have the User following the Process steps outlined herein, each step building on the next, the reality of producing a communication project will at times require the User to complete these steps in alternate orders. (Specific instances of this are noted by “**” in the Process outline.) The Process is designed to accommodate a flexible work flow.

Section A—Creating Administrative Correspondence, Documentation, and Reports

Step 1—Gathering & Storing Project Information (FIG. 3)

The User gathers and stores the project's project information. She may choose to store this information in an electronic form (such as in a database) and/or in hard copy form (such as in a file) within the Information Storage System(s) of the Apparatus, or within other conventional storage systems.

Step 2—Gathering & Storing Fixed Publishing Specifications (FIG. 3)

The User gathers and stores the project's fixed publishing specifications. She may choose to store this information in an electronic form (such as in a database) and/or in hard copy form (such as in a file) within the Information Storage System(s) of the Apparatus, or within other conventional storage systems.

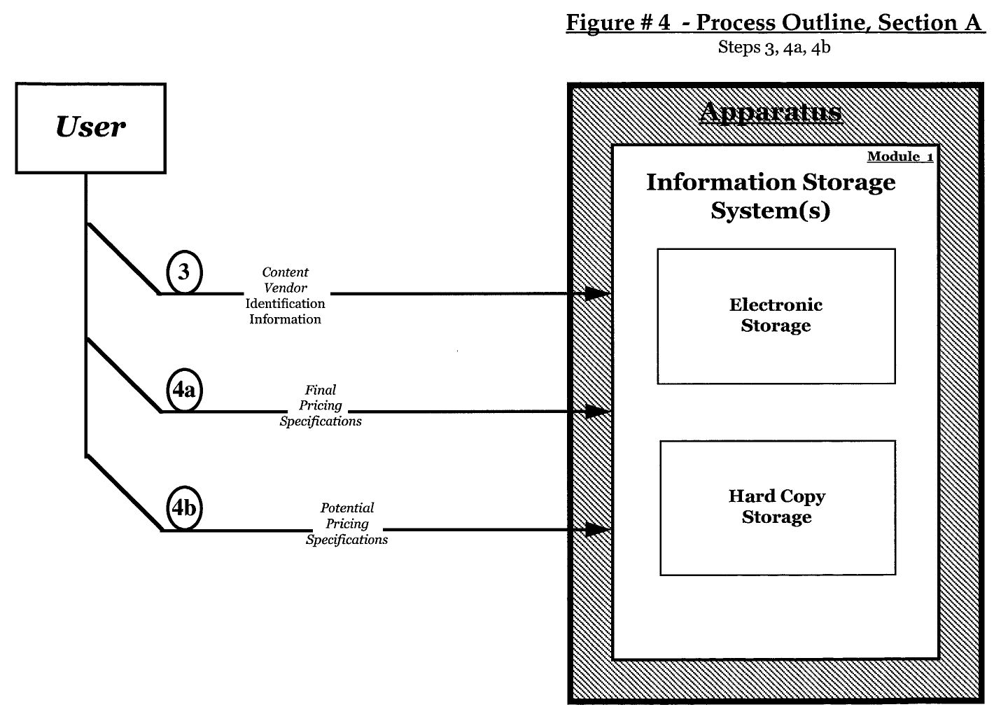

Step 3—Identifying a Content Vendor (FIG. 4)

The User identifies a Content Vendor for the type of content she needs. She then gathers and stores the Content Vendor's identification information. She may choose to store this information in an electronic form (such as in a database) and/or in hard copy form (such as in a file) within the Information Storage System(s) of the Apparatus, or within other conventional storage systems.

Step 4—Identifying Variable Pricing Specifications (FIG. 4)

Identifying Final Pricing Specifications (FIG. 4)

4a) If final pricing specifications are known, the User has the option of creating (or selecting from a pre-existing inventory) a list of the final pricing specifications that will apply to the content.

She may choose to store the list of final pricing specifications in an electronic form (such as in a database) and/or in hard copy form (such as in a file) within the Information Storage System(s) of the Apparatus, or within other conventional storage systems.

Identifying Potential Pricing Specifications (FIG. 4)

4b) If final pricing specifications are NOT known, the User has the option of creating (or selecting from a pre-existing inventory) a list of the variable pricing specifications that could apply to the content at a later time (the potential pricing specifications).

She may choose to store the potential pricing specifications in an electronic form (such as in a database) and/or in hard copy form (such as in a file) within the Information Storage System(s) of the Apparatus, or within other conventional storage systems.

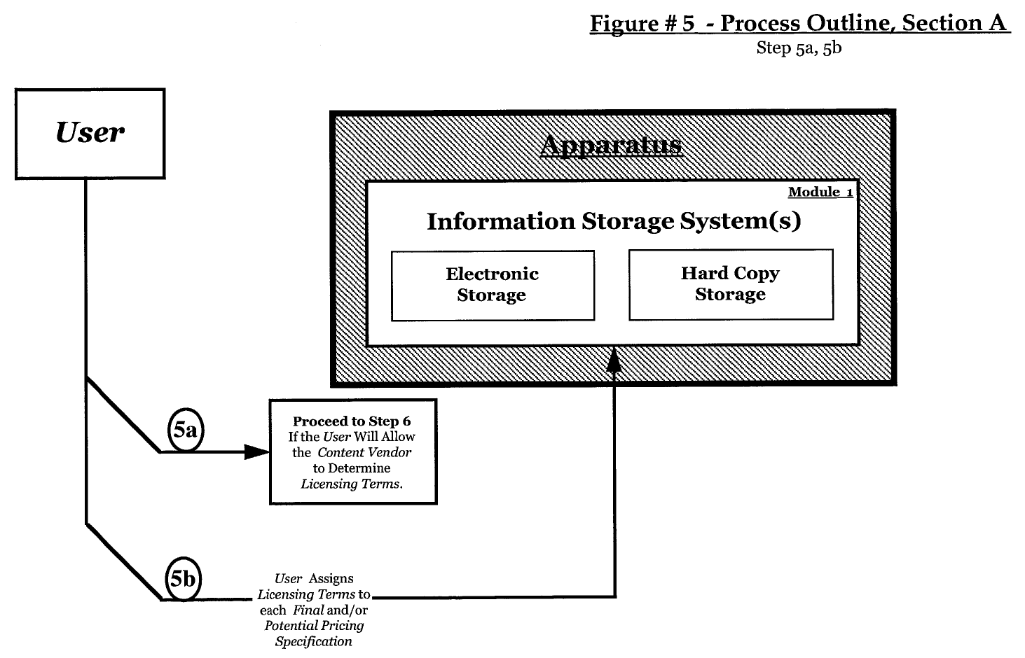

Step 5—Determining Content Licensing Terms (FIG. 5)

5a) If the User plans to allow the Content Vendor to determine licensing terms, she proceeds directly to step 6.

5b) If the User wishes to propose licensing terns to the Content Vendor, she assigns licensing terms to each of the final and/or potential pricing specifications.

The User may choose to store her proposed licensing terms for each of the final and/or potential pricing specifications in electronic form (such as in a database) and/or in hard copy form (such as in a file) within the Information Storage System(s) of the Apparatus, or within other conventional storage systems.

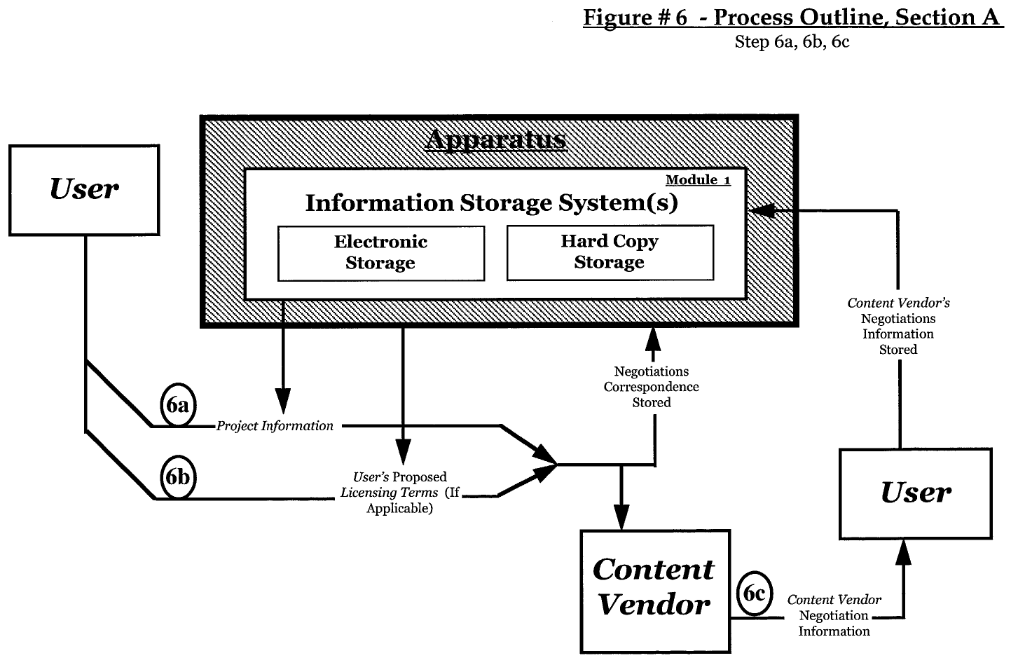

Step 6—Negotiating with the Content Vendor (FIG. 6)

The User negotiates licensing terms with the Content Vendor.

6a) To assist her in these negotiations, the User might convey information regarding the project to the Content Vendor. She could create a template within the Apparatus to access pertinent information previously entered (such as fixed publishing specifications and variable pricing specifications) and organize it to be conveyed to the Content Vendor. Or, the User might employ other means and processes to convey project information to the Content Vendor.

6b) The User might include her proposed licensing terms (if applicable) with the other project information conveyed to the Content Vendor in step 6a.

6c) The User may record information the Content Vendor supplies to her during negotiations.

The User may choose to store her negotiations, correspondence, and any other information relating to the negotiations in electronic form (such as in a database) and/or in hard copy form (such as in a file) within the Information Storage System(s) of the Apparatus, or within other conventional storage systems.

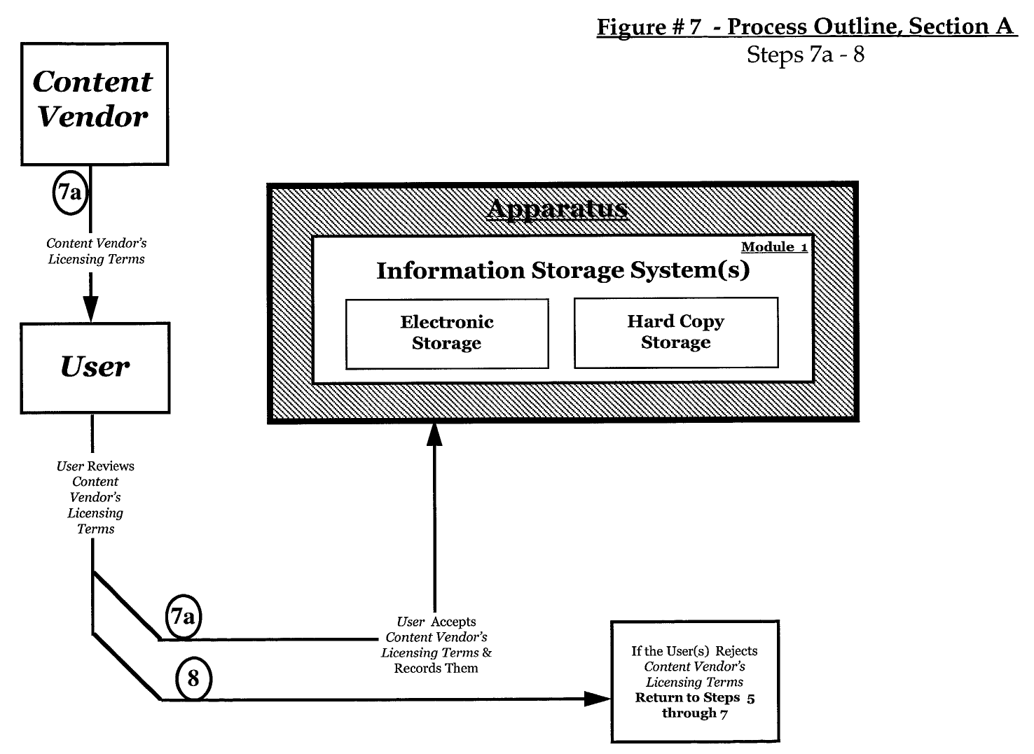

Step 7—Finalizing Licensing Terns (FIGS. 7 & 8)

Content Vendor's Licensing Terms (FIG. 7)

7a) If the Content Vendor is determining licensing terms for the variable pricing specifications, the Content Vendor will convey terms for each final and/or potential pricing specification to the User. The User will review the Content Vendor's licensing terns and convey her acceptance or denial back to the Content Vendor.

If the User accepts the Content Vendor's licensing terns, she has the option of storing them in electronic form (such as in a database) and/or in hard copy form (such as in a file) within the Information Storage System(s) of the Apparatus, or within other conventional storage systems.

If the User rejects the Content Vendor's licensing terms, she may proceed to step 8.

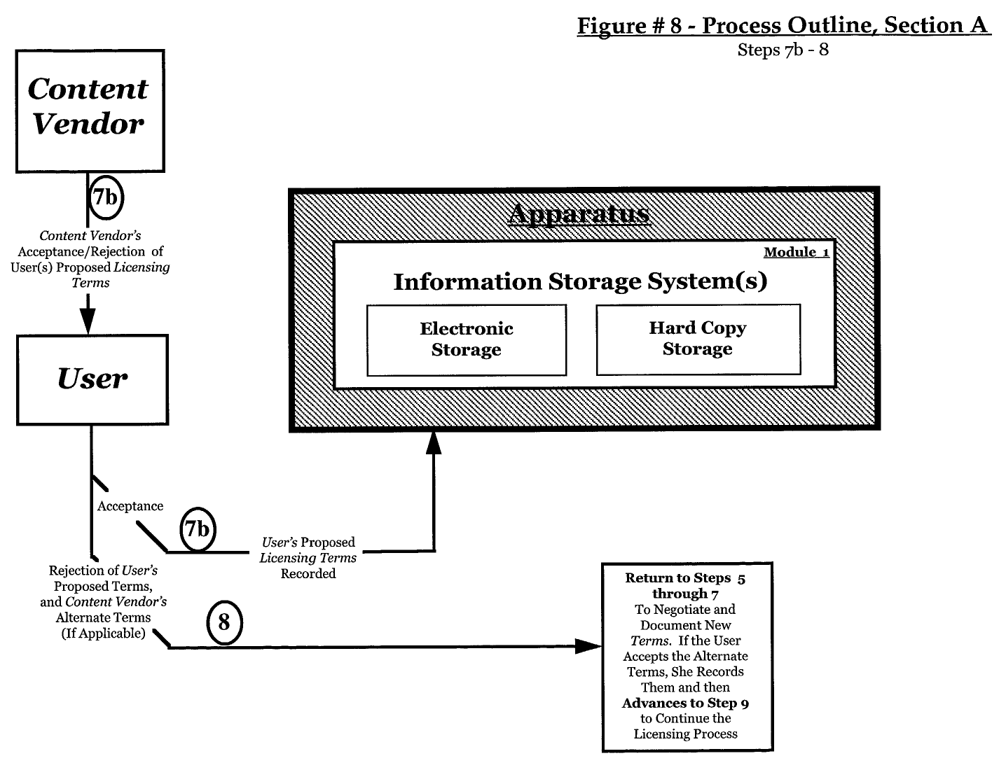

User's Proposed Licensing Terms (FIG. 8)

7b) If the User has proposed licensing terms for the content, the Content Vendor will review them and convey their acceptance or rejection of the licensing terns for each final and/or potential pricing specification back to the User.

If the Content Vendor accepts the User's proposed licensing terms, the User has the option of storing the licensing terms in electronic form (such as in a database) and/or in hard copy form (such as in a file) within the Information Storage System(s) of the Apparatus, or within other conventional storage systems.

If the Content Vendor rejects the User's proposed licensing terms, the Content Vendor may wish to convey alternate terms to the User with their rejection. If the User accepts the alternate terms, she would proceed to step 10. If the User does not accept the alternate terms, she would then proceed to step 8.

Step 8—Continuing Negotiations (FIGS. 7 & 8)

Should the User not agree to the Content Vendor's licensing terms, she has the option of continuing to negotiate by repeating steps 5 through 7 until an agreement is reached.

Should the Content Vendor not agree to the User's proposed licensing terms, the User has the option of continuing to negotiate by repeating steps 5 through 7 until an agreement is reached.

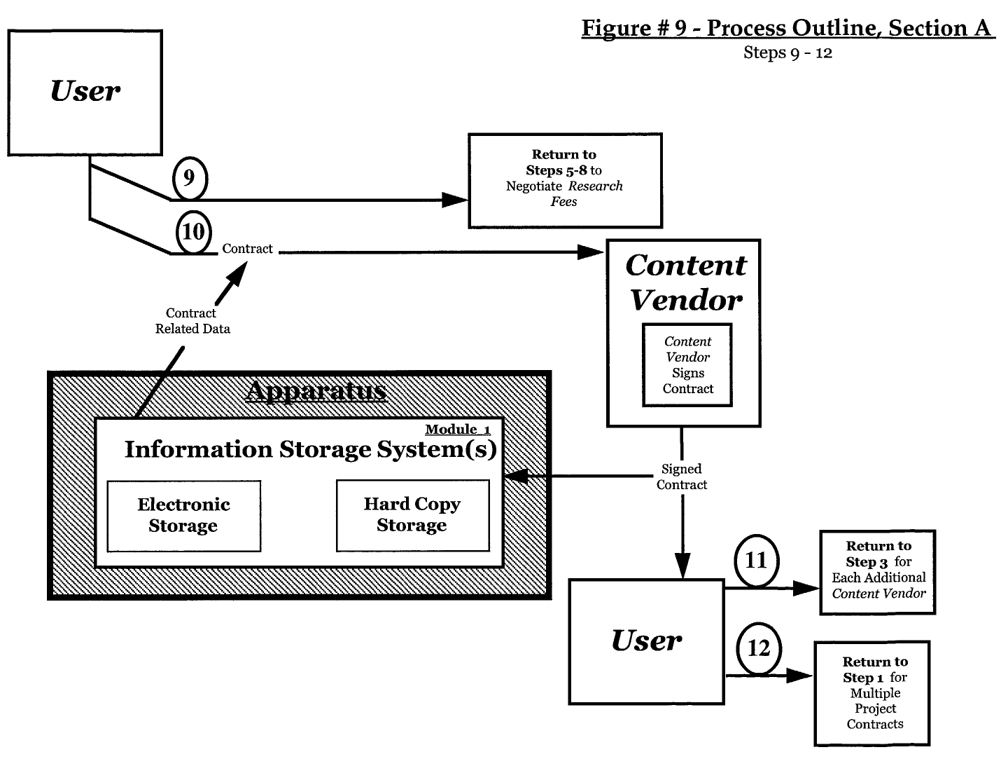

Step 9—Negotiating Research Fees (FIG. 9)

The User may negotiate research fees with the Content Vendor by following steps 5 through 8, while adjusting the information to address research fee issues. Or, she may choose to negotiate research fees and licensing terms simultaneously. The User might also employ other means and processes to negotiate and store research fees information.

Step 10—Creating, Conveying, and Storing a Contract (FIG. 9)

When licensing terms and research fees have been agreed to, the User has the option of generating a contract which confirms the final licensing terms she recorded during step 7, and assigns the contract a unique identification code.

The User may employ the Apparatus to generate the contract by using data previously entered (such as fixed publishing specifications, licensing terms, contract identifier, Content Vendor identification information, etc. . . . ), or may use other conventional methods to create the contract.

The User conveys the contract to the Content Vendor, who signs and returns a copy of the contract to the User. The User could also employ other means and processes to execute the contract.

The User may choose to store the signed contract in electronic form (such as in a database) and/or in hard copy form (such as in a file) within the Information Storage System(s) of the Apparatus, or within other conventional storage systems.

Step 11—Using Multiple Content Vendors within the Project (FIG. 9)

Should the User wish to gather content from a variety of Content Vendors, she may choose to repeat steps 3 through 10 for each Content Vendor she wishes to include in the project.

Step 12—Negotiating Multiple Project Contracts (FIG. 9)

Should the User wish to negotiate a contract to cover multiple projects, she has the option of adjusting the information entered in steps 1 through 10 to cover the needs of multiple projects. For example, a User might wish to negotiate licensing terms for a series of individual magazine articles to appear over a specific time period.

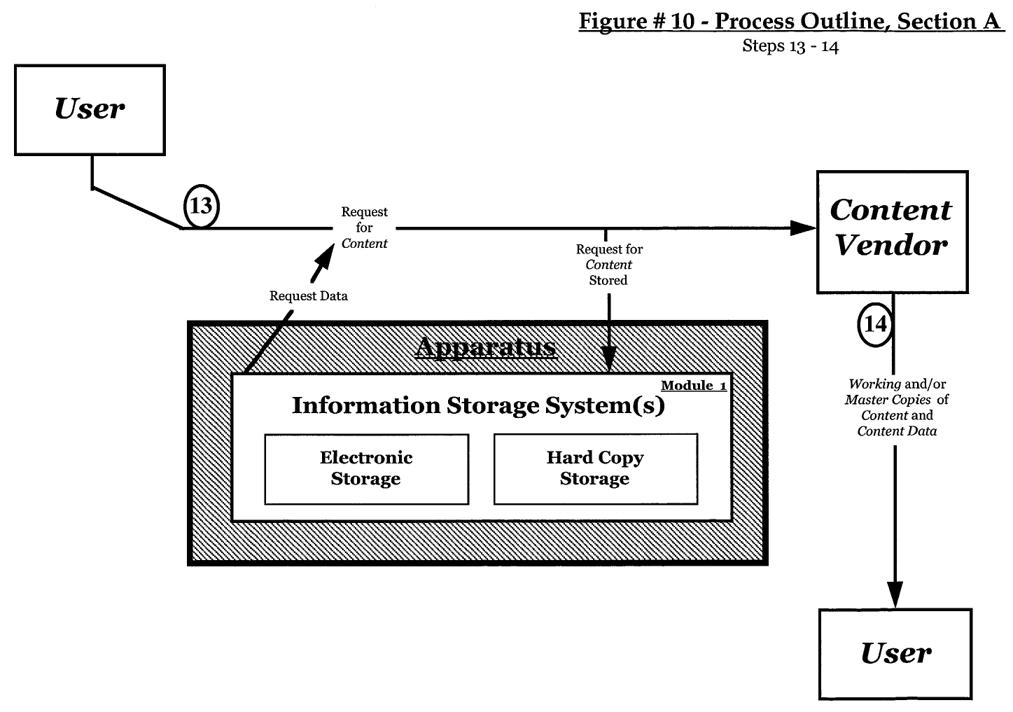

Step 13—Requesting Content (FIG. 10)

The User creates a request for the content she needs and conveys it to the Content Vendor. The User may employ the Apparatus to generate this request using data previously entered, (such as the Content Vendor's contact information, contract numbers, and preferred shipping companies or methods) or by augmenting data previously entered with new information (such as a detailed description of the content she requires). The User might organize and convey the request using other means and processes.

The User may choose to store her content requests in electronic form (such as in a database) and/or in hard copy form (such as in a file) within the Information Storage System(s) of the Apparatus, or within other conventional storage systems.

**It is possible for the User to request content from a Content Vendor and/or design a draft using that content before negotiating a licensing contract. The User might choose to do this to verify that the Content Vendor has appropriate content before negotiating a contract. Should the User choose to request content and/or design with content before negotiating licensing terms, she would complete step 13, the appropriate portion of Section B, and/or the appropriate portion of Section C, before returning to steps 4-10 to negotiate licensing terms and to create a contract.

Step 14—Sending Content (FIG. 10)

In response to the User's request, the Content Vendor conveys working and/or master copies of content and content data to the User.

Section B—Tracking Content Using Submission, Transfer, and Return Records

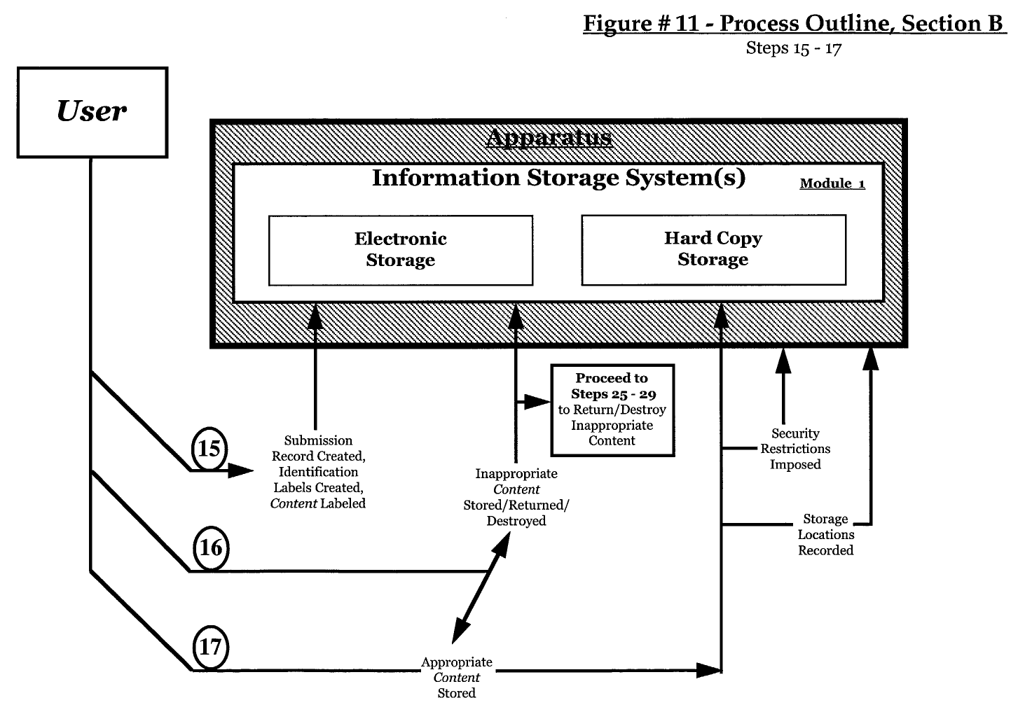

Step 15—Creating a Submission Record (FIG. 11)

When the User receives a submission of content, she has the option of creating a record of the submission's submission information.

The User may choose to label the submission components with an identification code that will link the components back to the submission record. If the User is storing the submission information within the electronic storage portion of the Apparatus, she may wish to have the Apparatus create the identification code labels.

The User may choose to store the submission record in electronic form (such as in a database) and/or in hard copy form (such as in a file) within the Information Storage System(s) of the Apparatus, or within other conventional storage systems.

Step 16—Editing the Submission (FIG. 11)

The User has the option of editing the submission to remove inappropriate content. She may choose to return or destroy inappropriate content immediately (using steps 25 through 29) or to file the inappropriate content separately from the appropriate content until she is ready to return it.

The User may choose to store the inappropriate content in electronic form (such as in a database) and/or in hard copy form (such as in a file) within the Information Storage System(s) of the Apparatus, or within other conventional storage systems.

The User then proceeds to work with only the appropriate content.

Step 17—Storing & Securing Content (FIG. 11)

The User has the option of storing content in electronic form (such as in a database) and/or in hard copy form (such as in a file) within the Information Storage System(s) of the Apparatus, or within other conventional storage systems.

The User might also choose to reference the content's storage location within other records of the Apparatus.

The User might also choose to install some form of security to protect the content from being inappropriately accessed. For example, the User could install a security system that would allow only specific User groups, User names, and/or IP addresses access to the content. The User might also employ other conventional security systems to control access to the content. (Should the User choose to implement a security system for content, she will need to integrate the steps necessary to access materials protected by the security system into this Process. For simplicity sake, these steps have not been included in the Process description and Figures.)

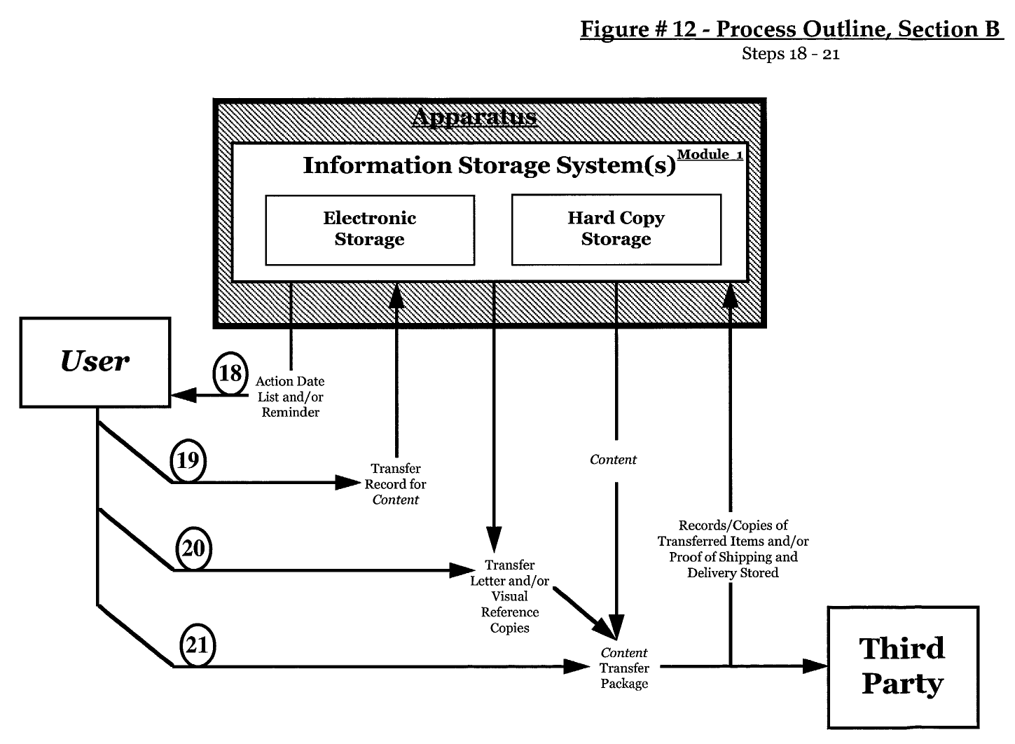

Step 18—Creating Action Date Lists/Reminders (FIG. 12)

If the User noted action dates for each submission in the submission record, she may wish to create action date lists to remind her of the pending tasks.

The User may employ the Apparatus to create the action date list by creating a template to access and organize the action dates into a report form. The User might also use the Apparatus to convey reminders of these dates and the associated tasks automatically through a communication system (such as email). The User could also employ other means and processes to create the action date lists and reminders.

** Depending on when and if the User must send content to a third party, she may jump ahead to Section C before returning to step 19.

Step 19—Creating a Transfer Record (FIG. 12)

Should any content need to be conveyed to a third party, the User has the option of recording the administrative details of the transfer (such as date, third party contact information, an item-by-item list of the content being transferred, and the content's submission information).

The transfer record might also include space for the User to keep notes on the transfer of content by the third party to other parties.

The User may choose to store the transfer record in electronic form (such as in a database) and/or in hard copy form (such as in a file) within the Information Storage System(s) of the Apparatus, or within other conventional storage systems.

Step 20—Creating a Transfer Cover Letter (FIG. 12)

The User has the option of creating a cover letter to accompany the content being transferred to a third party. The letter might include an item-by-item list of the content being transferred and its submission information. The User may employ the Apparatus to generate this letter using data previously entered. Or, the User may employ other means and processes to create a cover letter. The User might also include visual reference copies (if applicable) of the content being transferred, such as photocopies or print-outs of scans.

The User may choose to store the transfer letter and/or visual reference copies in electronic form (such as in a database) and/or in hard copy form (such as in a file) within the Information Storage System(s) of the Apparatus, or within other conventional storage systems.

Step 21—Conveying Content to Third Party (FIG. 12)

The User gathers the content, the transfer letter and the visual reference copies (if applicable), and conveys them to the third party.

The User may choose to store a record of the items within the package and/or proof of shipment and delivery in electronic form (such as in a database) and/or in hard copy form (such as in a file) within the Information Storage System(s) of the Apparatus, or within other conventional storage systems.

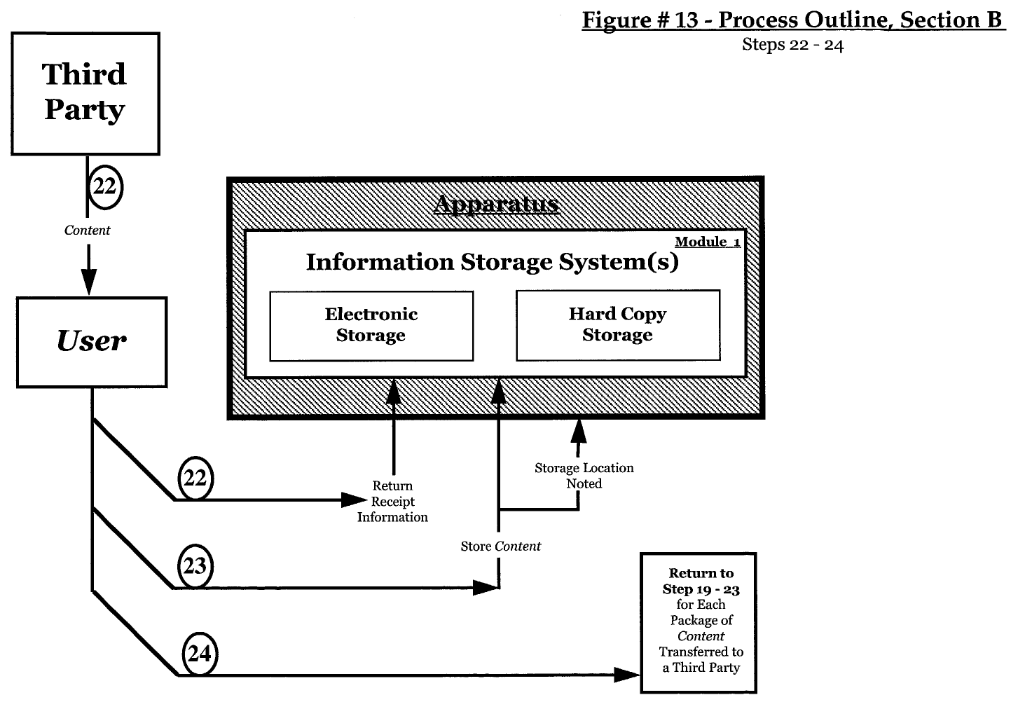

Step 22—Creating a Receipt Record (FIG. 13)

If the third party returns the content to the User, the User has the option of creating a receipt record to document the details of the return. These details might include the date, third party contact information, an item-by-item list of the content, and notes on the physical condition of the content being returned to the User.

The User may choose to store the return receipt records in electronic form (such as in a database) and/or in hard copy form (such as in a file) within the Information Storage System(s) of the Apparatus, or within other conventional storage systems.

Step 23—Storing/Re-Filing Content (FIG. 13)

The User has the option of storing and/or re-filing the content in electronic form (such as in a database) and/or in hard copy form (such as in a file) within the Information Storage System(s) of the Apparatus, or within other conventional storage systems.

The User might also choose to note or update the content's storage location within other Apparatus records.

Step 24—Multiple Transfers of Content (FIG. 13)

The User has the option of repeating steps 19 through 23 for each instance/package of content she transfers to a third party.

**Depending on when and if the User must return content to the Content Vendor, she may proceed to Section C (steps 32-58) before returning to step 25.

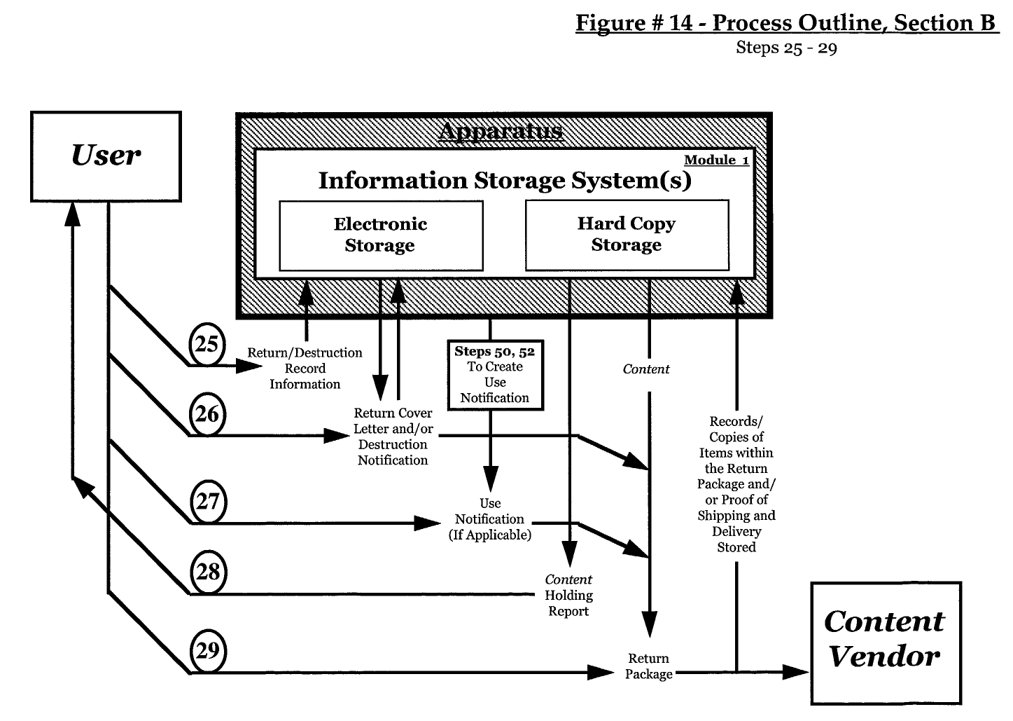

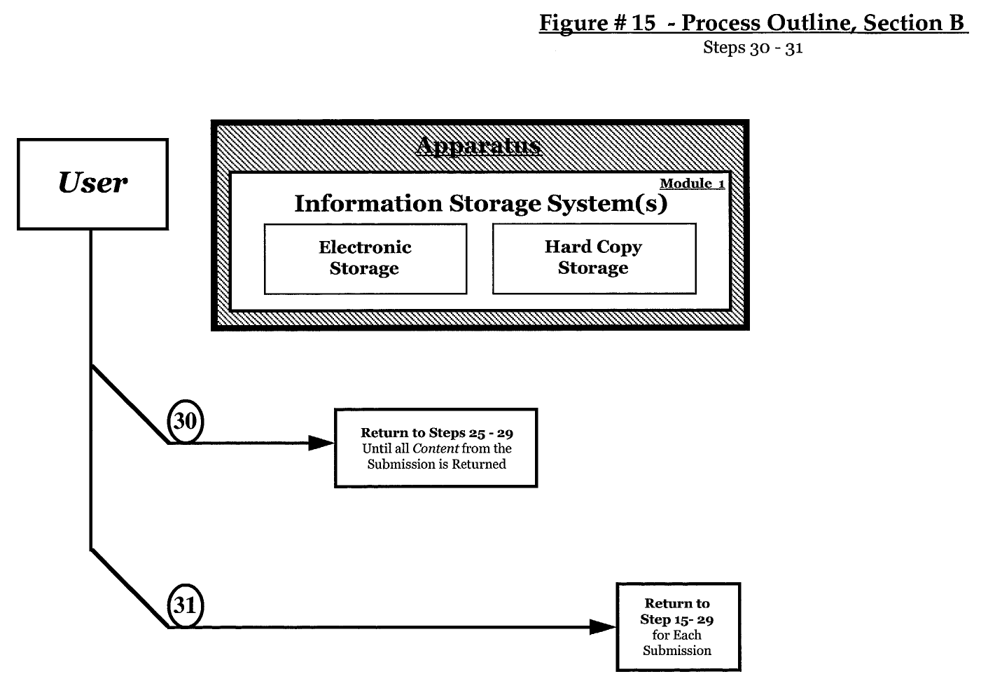

Step 25—Creating a Content Return or Destruction Record (FIG. 14)

When the User is ready to return content to its Content Vendor, the User has the option of documenting the return, including an item-by-item list of the content being returned, the date, and the shipping method used to convey the content back to the Content Vendor.

Alternately, the Content Vendor might wish the User to destroy the content according to the Content Vendor's instructions. If the Content Vendor requests the destruction of its content, the User might record the date of the destruction in the destruction record.

The User may choose to store the return/destruction record in electronic form (such as in a database) and/or in hard copy form (such as in a file) within the Information Storage System(s) of the Apparatus, or within other conventional storage systems.

Step 26—Creating Return Cover Letter/Destruction Notification (FIG. 14)

The User has the option of creating a cover letter to accompany the return of content or to notify the Content Vendor of the destruction of the content. The User may create a template within the Apparatus to generate these letters using data previously entered (such as submission information, date of return or destruction, and an item-by-item list of the materials being returned and/or destroyed). Or, the User might employ other means and processes to create a return cover letter or a destruction notification.

The User may choose to store the return letter/destruction notification in electronic form (such as in a database) and/or in hard copy form (such as in a file) within the Information Storage System(s) of the Apparatus, or within other conventional storage systems.

Step 27—Including Use Notifications with the Return (FIG. 14)

The User may include a use notification with the content being returned to the Content Vendor or with the destruction notification. (Section D, steps 50, 52 explain the creation of a use notification.)

Step 28—Generating Content Holding Reports (FIG. 14)

The User may choose to create a report which lists the location of all of the content submitted to her by comparing information in the submission records with information in the transfer, receipt, and return records. The User may create a template within the Apparatus to generate this report using data previously entered. Or, the User might employ other means and processes to create a content holding report.

The User may choose to store the content holding report in electronic form (such as in a database) and/or in hard copy form (such as in a file) within the Information Storage System(s) of the Apparatus, or within other conventional storage systems. The User may also choose to store the command(s) and script(s) that created the content holding report from data within the Apparatus.

Step 29—Returning Content/Conveying Destruction Notification (FIG. 14)

The User gathers the content (if applicable), the return cover letter (if applicable), the destruction notification (if applicable), and/or the use notification (if applicable) and conveys them to the Content Vendor in a return package.

The User may choose to store a record of the items within the return package and/or proof of shipment and delivery in electronic form (such as in a database) and/or in hard copy form (such as in a file) within the Information Storage System(s) of the Apparatus, or within other conventional storage systems.

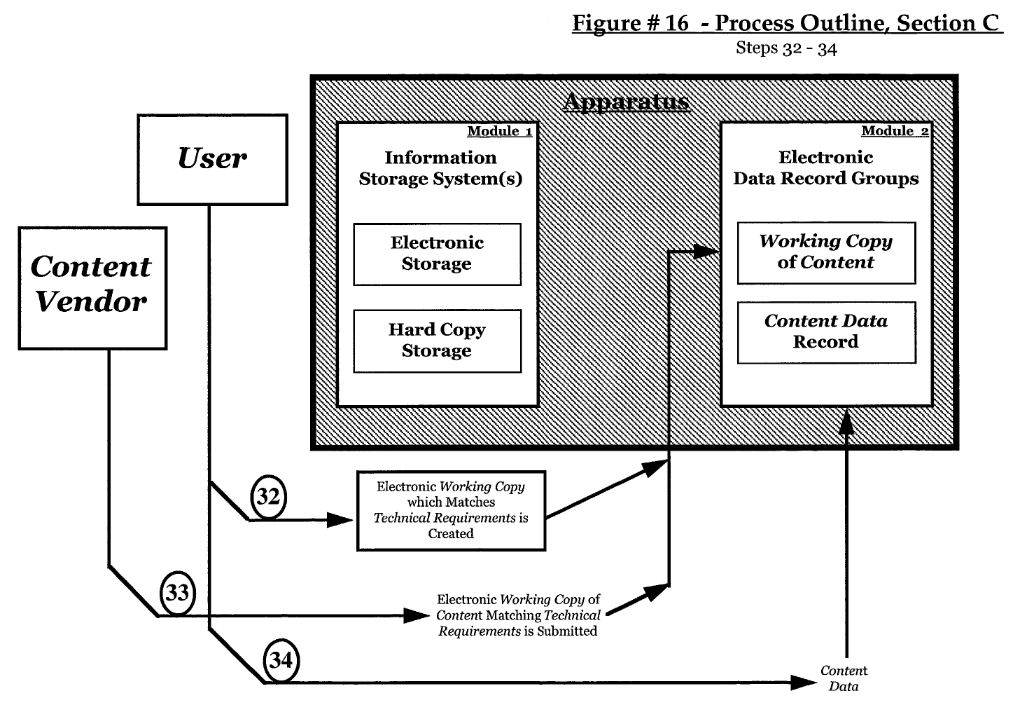

Step 30—Multiple Returns (FIG. 15)

The User has the option of repeating steps 25 through 29 until all content from a submission has been returned to its Content Vendor.

Step 31—Multiple Content Submissions (FIG. 15)

The User has the option of repeating steps 15 through 29 for each submission of content she receives.

Section C—Designing/Editing Content, Determining Associations between Manipulated Content, Licensing Terms, and Technical Requirements

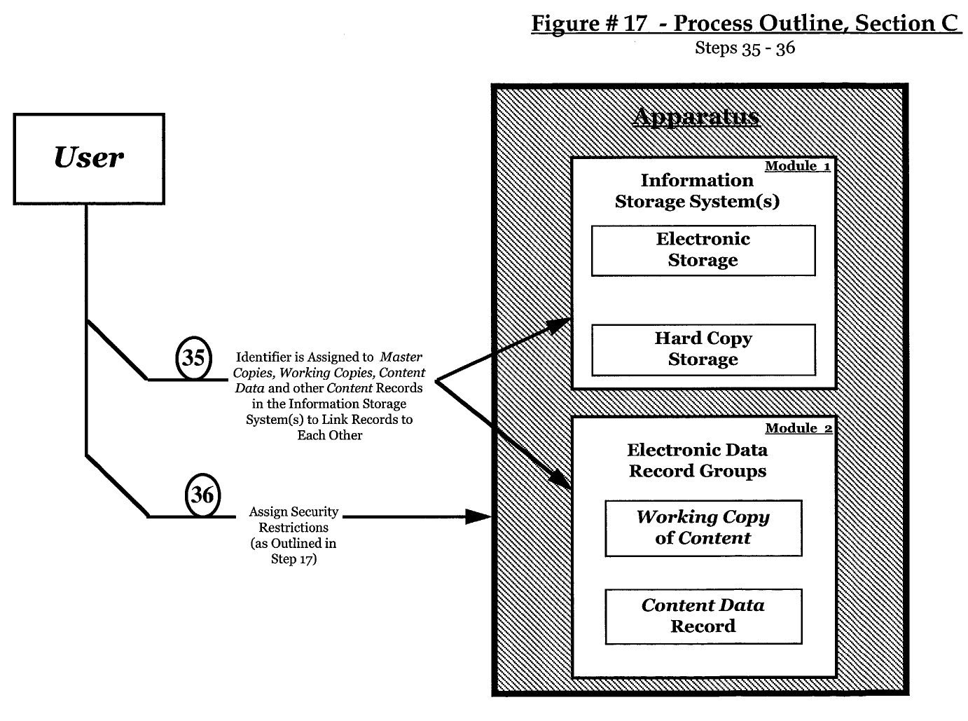

Step 32—Creating Working Copies of Content (FIG. 16)

If the Content Vendor has not conveyed an electronic working copy of the content, the User creates an electronic working copy of the content (which conforms to the working copy technical requirements) using any conventional means.

The User then enters the electronic working copy of the content in the Electronic Data Record Groups (Module 2 of the Apparatus).

Step 33—Entering Working Copies (Conveyed by Content Vendor) (FIG. 16)

If the Content Vendor has conveyed an electronic working copy of the content which will match the User's working copy technical requirements, the User enters it into the Electronic Data Record Groups.

Step 34—Entering Content Data (FIG. 16)

The User enters the working copy's content data into the Electronic Data Record Groups.

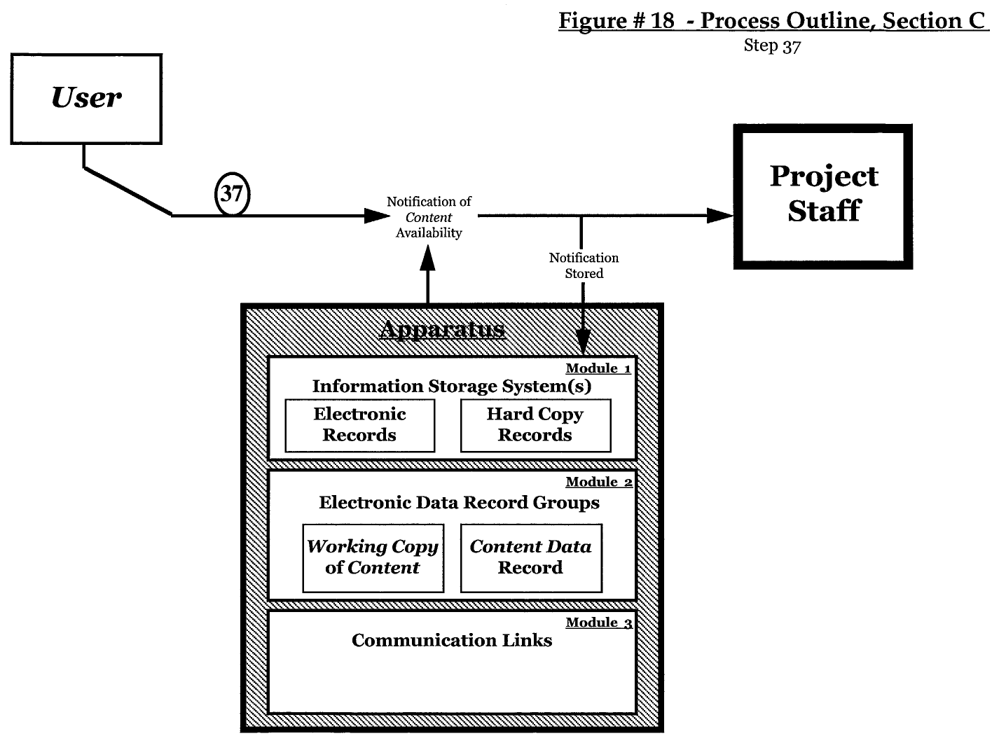

Step 35—Linking Working Copies and Content Data (FIG. 17)

The User then links the master copies, working copies, and their content data (if this step has not already been done by the Content Vendor) using any conventional means.

The User may also choose to link the Electronic Data Records for each piece of content with pertinent information held in the Information Storage System(s), such as contract identification numbers and licensing terms.

Step 36—Assigning Security to Content (FIG. 17)

If not already completed, the User may wish to limit access to information and/or content within the Apparatus using any conventional security system (as outlined in step 17).

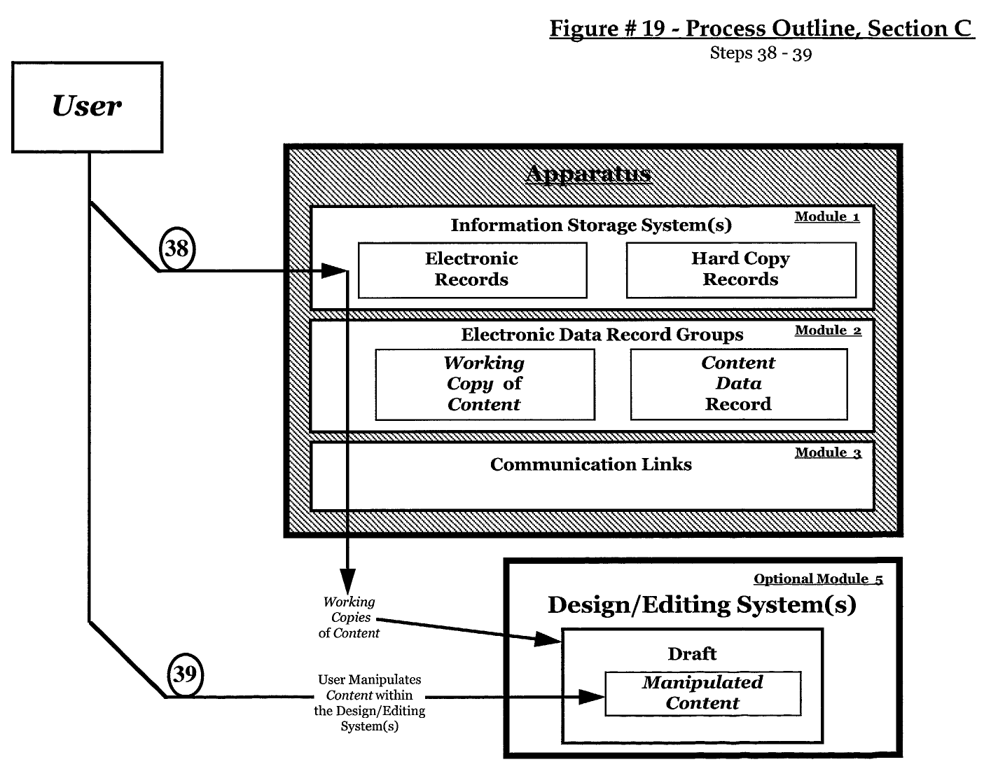

Step 37—Notification of Content Availability (FIG. 18)

The User may notify other project staff that content is available for design and/or editing by using any conventional means of communication. The notification of availability may include storage location and security information (if applicable) for the content.

The User may employ the Apparatus to create the notifications of content availability by creating a template which would access and organize the pertinent information (such as project information, storage location, and security information). The User could then convey the availability notifications to other project staff.

The User may choose to store the notification of content availability in electronic form (such as in a database) and/or in hard copy form (such as in a file) within the Information Storage System(s) of the Apparatus, or within other conventional storage systems.

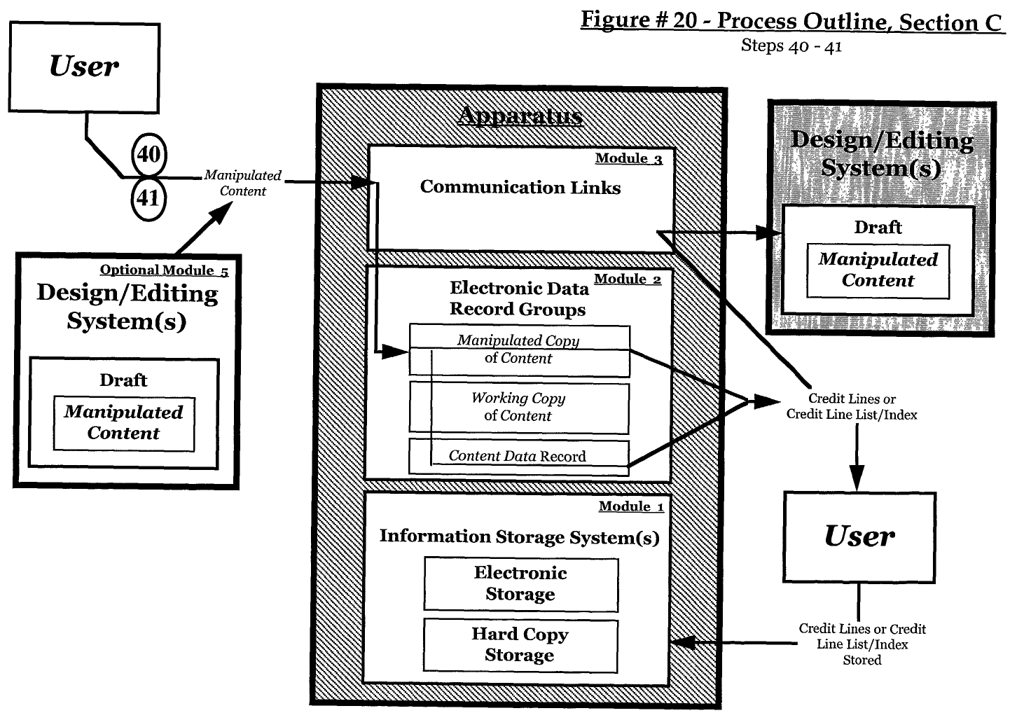

Step 38—Accessing Working Copies of Content (FIG. 19)

The User may access working copies of the content through the Apparatus. If appropriate, they may convey working copies into a design/editing system.

Step 39—Working with Content (FIG. 19)

The User may manipulate the working copy of the content to suit the needs of each draft of the project using their design/editing system. (Working copy refers to content before it is edited into a draft. Manipulated copy refers to content that has been edited to fit a draft design.)

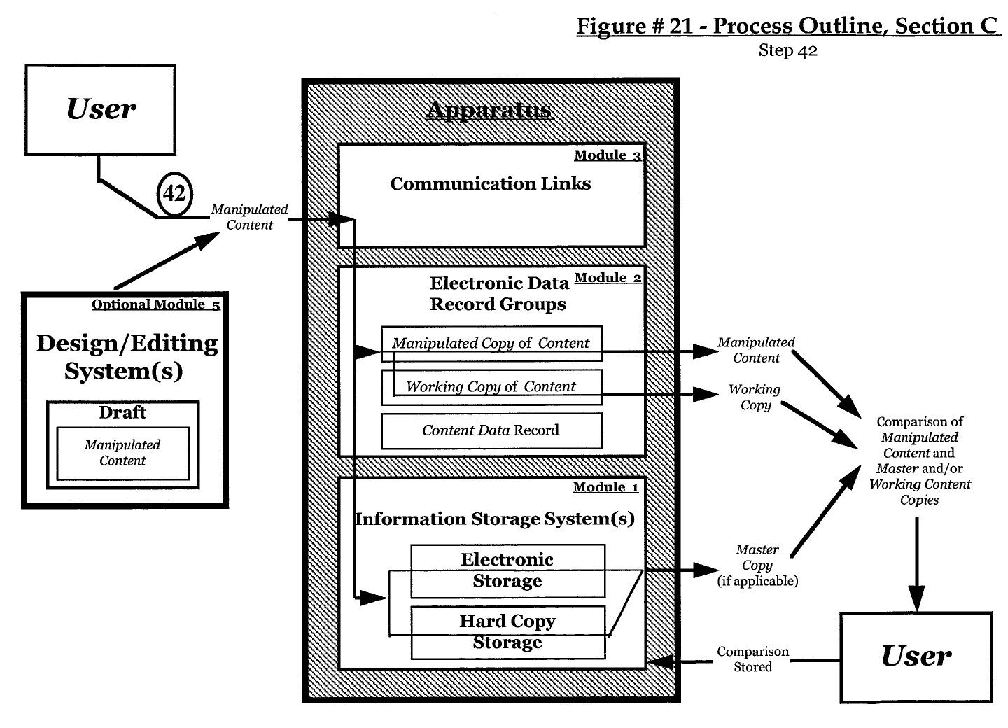

Step 40—Placing Credit Lines in the Draft (FIG. 20)

The User has the option of placing credit lines for the content into a draft of the project.

To do this, the User may employ the Apparatus to interpret the identity of the manipulated content in the draft (using the Communication Links, Module 3 of the Apparatus), match it to the appropriate content data record, and convey the appropriate credit line from the content data record to the draft within the design/editing system. The Apparatus might also allow the User to print out hard copies of the credit lines.

Or, the User might employ other means to determine the content identity, gather credit lines, and convey them into the design/editing system(s) and/or print out a hard copy.

The User may choose to store the credit lines in electronic form (such as in a database) and/or in hard copy form (such as in a file) within the Information Storage System(s) of the Apparatus, or within other conventional storage systems. The User may also choose to store the command(s) and script(s) that created the credit lines from data within the Apparatus.

Step 41—Creating a Credit Lines List/Index (FIG. 20)

The User has the option of creating a list/index of credit lines for all of the content used in a draft.

The User may employ the Apparatus to interpret the identity of the manipulated content in the draft, match it to the appropriate content data record, access the appropriate credit line, and organize the list/index of credit lines for the draft. The User could then convey the credit line list/index to the design/editing system, or print out a hard copy. The User might employ other means and processes to determine the content identity, create a credit line list/index, and enter it into the design/editing system and/or print out a hard copy.

The User may choose to store the credit lines list in electronic form (such as in a database) and/or in hard copy form (such as in a file) within the Information Storage System(s) of the Apparatus, or within other conventional storage systems. The User may also choose to store the command(s) and script(s) that created the credit line list from data within the Apparatus.

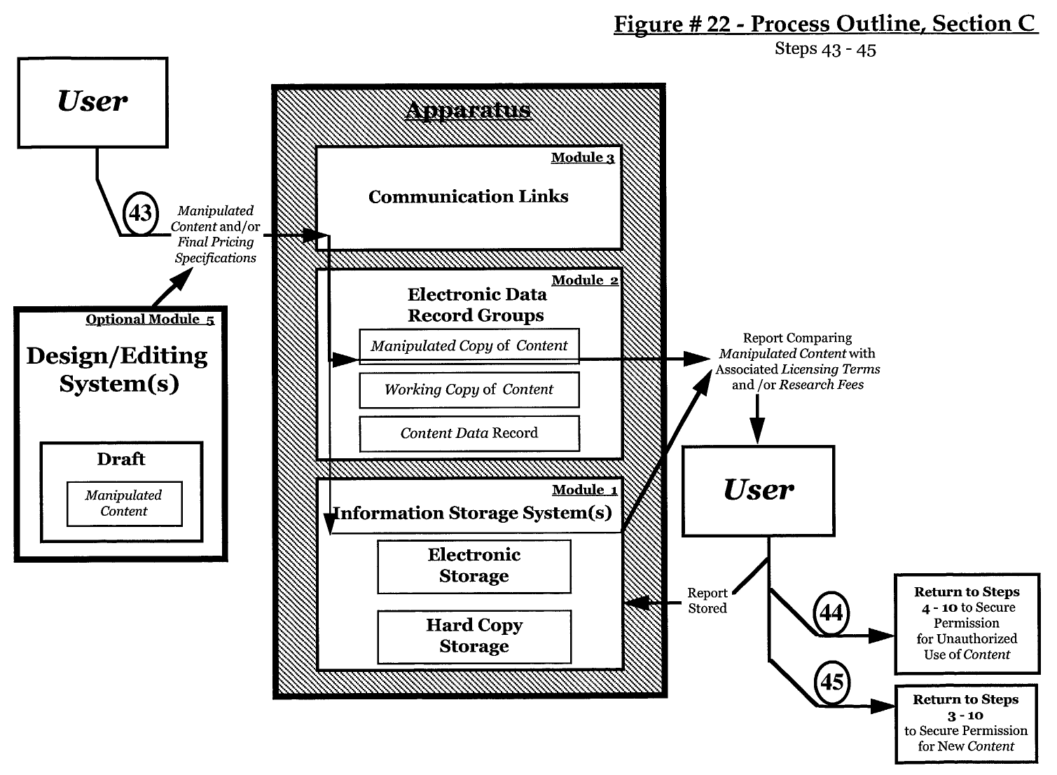

Step 42—Reviewing Edits and Changes to Content (FIG. 21)

The User has the option of comparing the original master and/or working copy of a piece of content with the manipulated copy of the same piece of content to review any changes made to the content during design/editing.

The User may employ the Apparatus to generate this review by entering copies of the manipulated content and comparing it to the original master and/or working copy of the content. The User might also employ other means and processes to compare the manipulated content with the original master and/or working copy of the content.

The User may choose to store the comparison of the manipulated content and the master and/or working copy of the content in electronic form (such as in a database) and/or in hard copy form (such as in a file) within the Information Storage System(s) of the Apparatus, or within other conventional storage systems. The User may also choose to store the command(s) and script(s) that created the comparison of master/working copies with manipulated copies from data within the Apparatus.

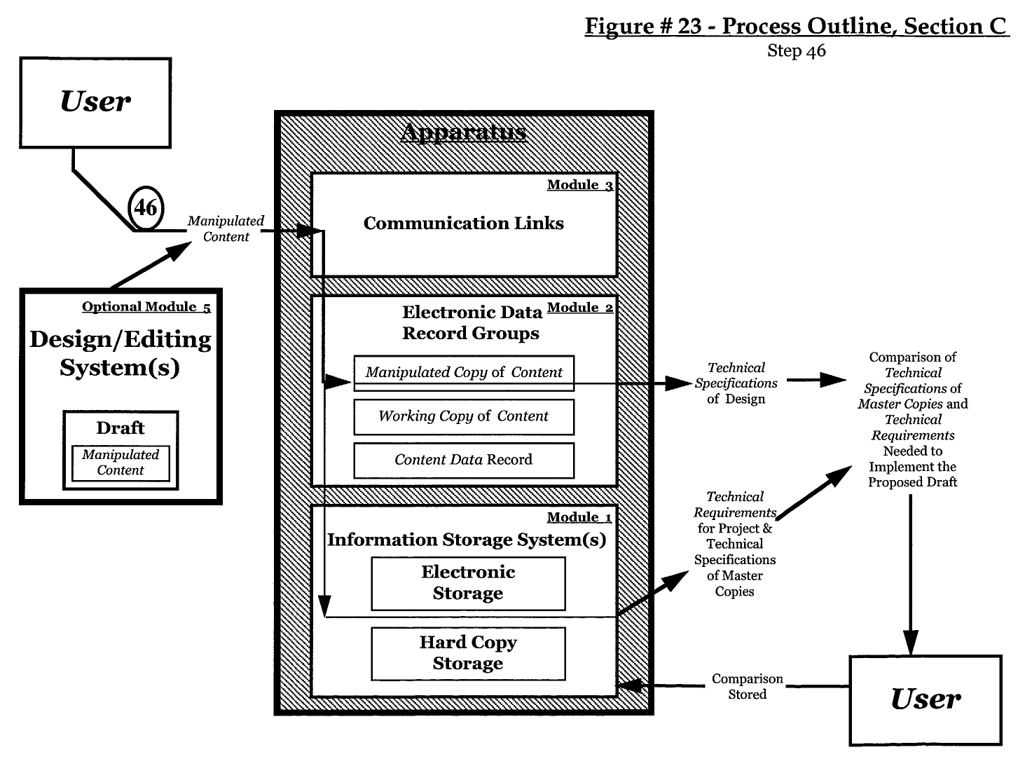

Step 43—Reviewing Licenses for Drafts (FIG. 22)

The User has the option of comparing manipulated content from a draft of the project with its associated licensing terms.

The User may employ the Apparatus to generate this comparison by first entering copies of the manipulated content and/or its final pricing specifications from the design/editing system into the Apparatus. Then she could compare the final pricing specifications for the manipulated content to the matching licensing terms previously entered into the Information Storage System(s) during steps 5 through 7. The User might employ other means and processes to compare the manipulated content with its licensing terms.

The User may choose to create a similar report to compare manipulated content and its affect on research fees.

The User may choose to store the licensing terms reviews for each draft in electronic form (such as in a database) and/or in hard copy form (such as in a file) within the Information Storage System(s) of the Apparatus, or within other conventional storage systems. The User may also choose to store the command(s) and script(s) that created the comparison of manipulated content with its associated licensing terms from data within the Apparatus.

Step 44—Securing Permissions for an Unauthorized Uses (FIG. 22)

If during steps 42 and 43 the User discovers that she has failed to secure permission for a particular use of a piece of content, (such as flopping the image or using a quote on the cover of a book rather than in the interior) she has the option of returning to step 4, and adjusting the information she enters to include the unauthorized use. She may then continue with steps 5 through 10 to update her contract with the Content Vendor. The User could employ other means and processes to secure permission for a particular use of a piece of content.

Step 45—Securing Permission for a New Piece of Content (FIG. 22)

If during steps 42 and 43 the User discovers that she has failed to secure permission for a particular piece of content, she has the option of repeating steps 3 through 10 to negotiate, execute, and document licensing terms for the new piece of content. The User could also employ other means and processes to negotiate, execute, and document licensing terms for a new piece of content.

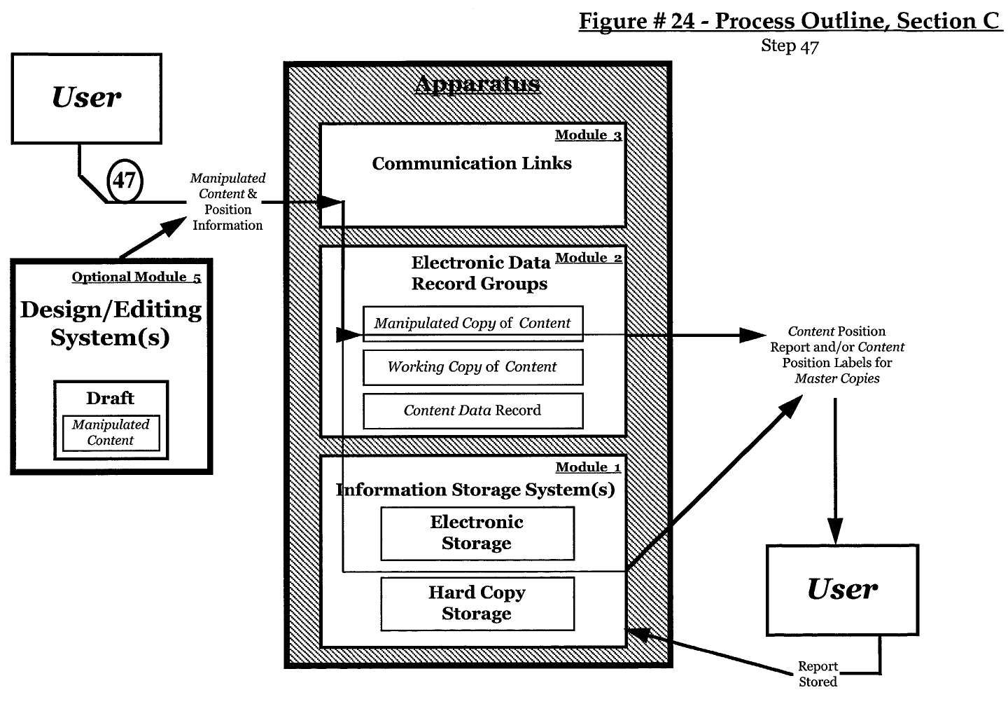

Step 46—Verifying Technical Viability of Drafts (FIG. 23)

The User has the option of generating a report or series of reports verifying that the technical specifications of the master content copies match the technical requirements for the proposed draft to be published, broadcast, or displayed.

The User may employ the Apparatus to generate this comparison by entering the manipulated content, adjusting it to meet the technical requirements of the project (which were previously entered into the Information Storage System(s)), and then comparing it to the technical specifications of the master content copies. The User could also employ other means and processes to verify the technical viability of a draft.

The User may choose to complete this step as part of the license review report in step 43.

The User may choose to store the technical viability report in electronic form (such as in a database) and/or in hard copy form (such as in a file) within the Information Storage System(s) of the Apparatus, or within other conventional storage systems. The User may also choose to store the command(s) and script(s) that created the technical viability report(s) from data within the Apparatus.

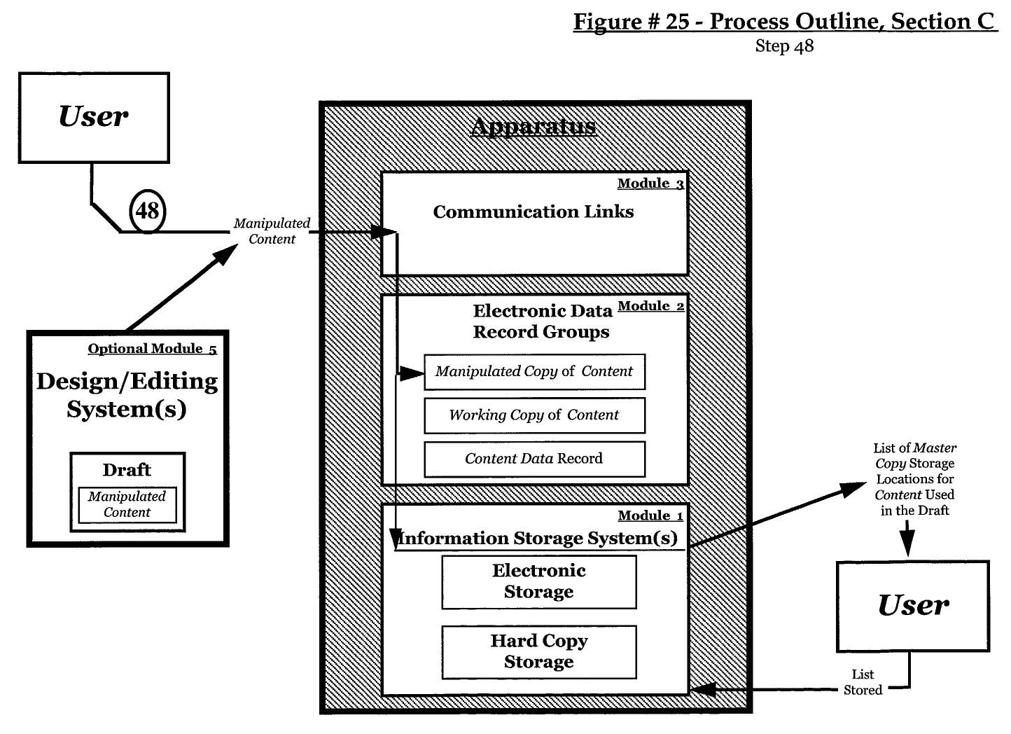

Step 47—Creating Content Position Reports/Labels (FIG. 24)

The User may choose to organize a list of each piece of content's final position within the draft. She may also choose to label the master content copies with the same information.

The User may employ the Apparatus to generate the content position list and labels by entering the manipulated content and its associated position information into the Apparatus, where it and other appropriate information could be gathered and organized into report form. The User may choose to print out hard copies of the list and labels, and affix the labels to the master copies. The User might also employ other means and processes to create the content position list and/or labels.

The User may choose to store the content position list and/or labels in electronic form (such as in a database) and/or in hard copy form (such as in a file) within the Information Storage System(s) of the Apparatus, or within other conventional storage systems. The User may also choose to store the command(s) and script(s) that created the content position list and/or labels from data within the Apparatus.

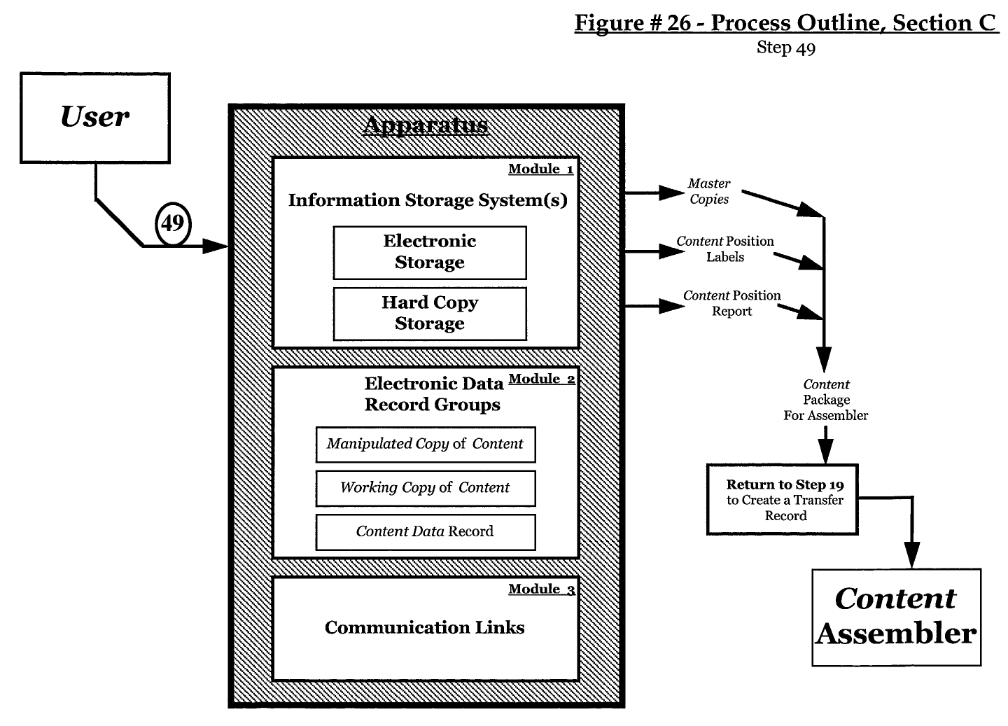

Step 48—Creating Master Copy Storage Location Lists (FIG. 25)

Should the User need to send the master content copies to a professional assembler (such as a printer or a video production house) she might wish to create a list of the master copy storage locations to assist her in gathering the master copies.

The User may employ the Apparatus to generate this list by entering the manipulated copy information, then accessing and organizing the storage records for the master copies of the same pieces of content using the identification link within all of the content copies. The User could also employ other processes and means to assist her in gathering the master copies.

The User may choose to store the master copy location list in electronic form (such as in a database) and/or in hard copy form (such as in a file) within the Information Storage System(s) of the Apparatus, or within other conventional storage systems. The User may also choose to store the command(s) and script(s) that created the master copy location list from data within the Apparatus.

The User could choose to create a master copy storage location list as part of step 47.

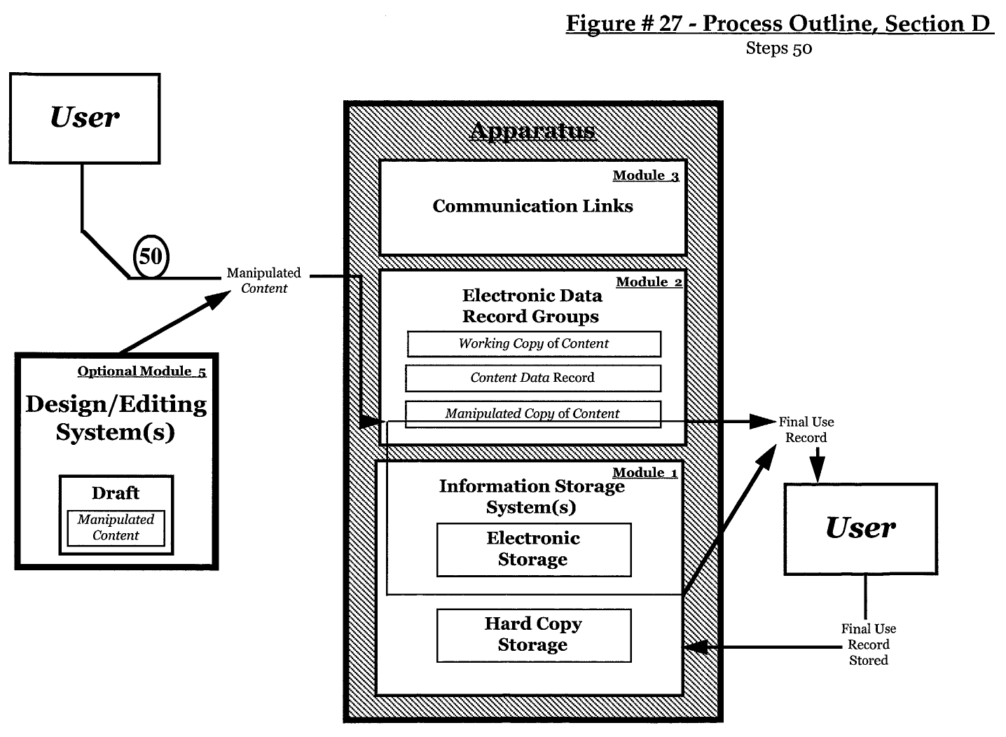

Step 49—Conveying Master (Content) Copies to Assembler (FIG. 26)

Should the User need to convey the master content copies to a professional assembler (such as a printer or a video production house) she will gather all of the master content copies, tagged with content position labels (if applicable), and the content position report (if applicable) and convey them to the Assembler.

The User might choose to employ the transfer procedures outlined in steps 19-24 to track the content conveyed to the Assembler. Or the User might employ other means and processes to convey master content copies to an Assembler.

Section D—Confirming Final Use of Content, Complying with Licensing Terms, and Archiving Records, Accessing and Analyzing Records.

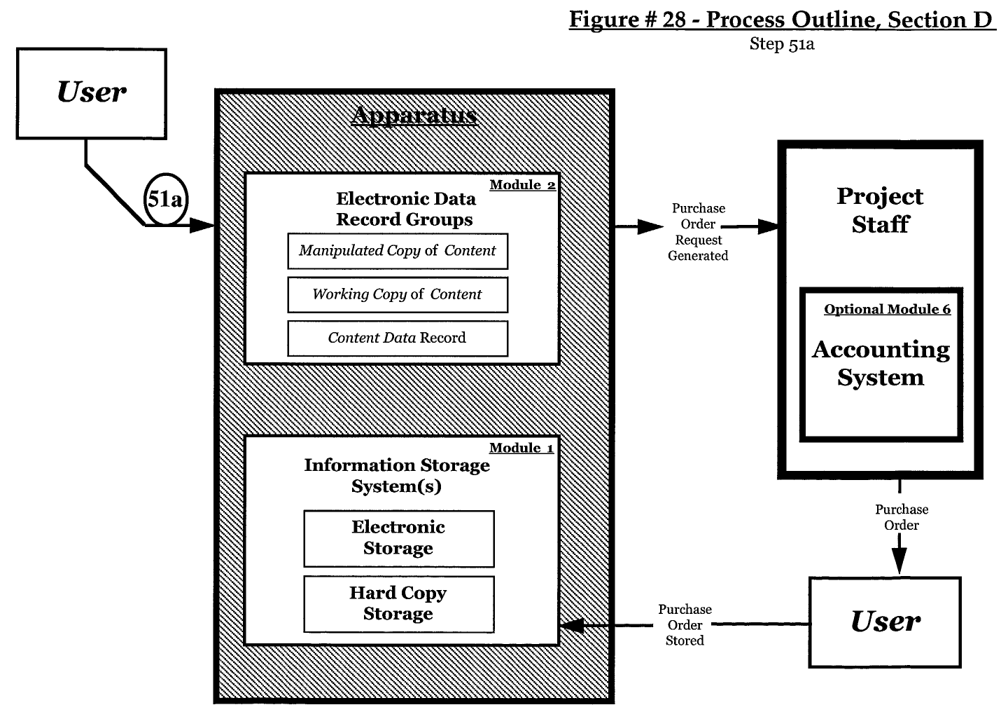

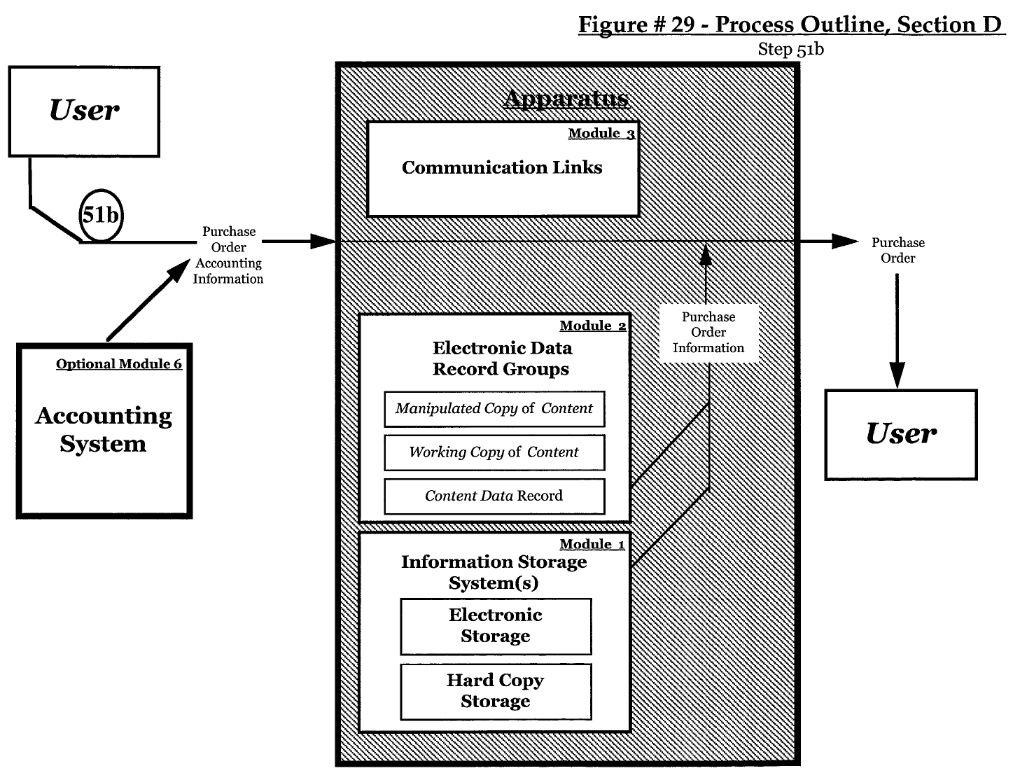

Step 50—Creating Final Use of Content Records (FIG. 27)

The User records the final use of content within the project, noting all of the applicable fixed publishing specifications, final pricing specifications, and content positions. The User may choose to include copies of the project layout with the final use records.

The User might employ the Apparatus to record the final use of content by first having the Apparatus interpret the identity of the manipulated content and its position information from the design/editing system. The Apparatus could then calculate the final pricing specifications that apply to the manipulated content, pull the fixed publishing specifications from the Information Storage System(s), and organize all this information into a final use record within the Apparatus. The User could also employ other means and processes to record final use of content.

The User may choose to store the final use information, including final pricing specifications and copies of the draft (if applicable), in electronic form (such as in a database) and/or in hard copy form (such as in a file) within the Apparatus, or within other conventional storage systems. The User may also choose to store the command(s) and script(s) that created the final use information, including final pricing specifications and copies of the draft (if applicable) from data within the Apparatus.

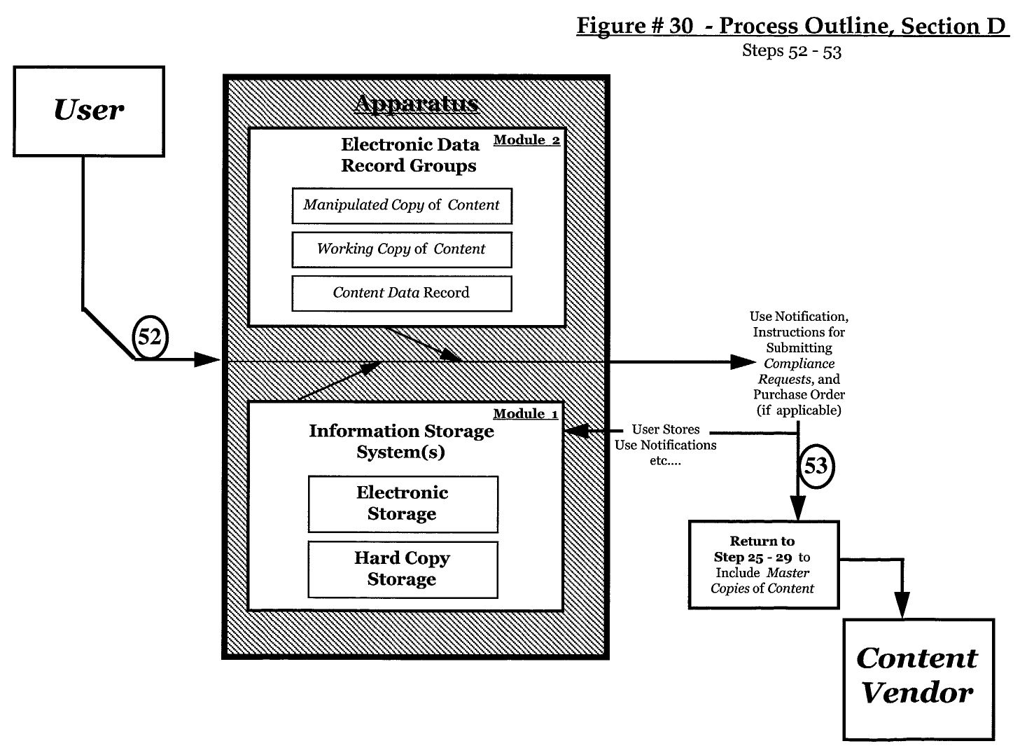

Step 51—Requesting/Creating Purchase Orders (FIGS. 28 & 29)

Should the User wish to use purchase orders when fulfilling her licensing terms with Content Vendors, she could request the purchase order numbers and/or forms from the appropriate project staff member.

The User may choose to store the purchase order request forms and/or the purchase orders in electronic form (such as in a database) and/or in hard copy form (such as in a file) within the Information Storage System(s) of the Apparatus, or within other conventional storage systems. The User may also choose to store the command(s) and script(s) that created the purchase order request forms and/or purchase orders from data within the Apparatus.

Creating Purchase Order Requests (FIG. 28)

51a) If the User is requesting the purchase order numbers/forms from another staff member, the Apparatus could generate the purchase order request forms by accessing information previously entered (such as project information, final use information, contract identification codes, and licensing terns) and organizing it to be conveyed to the appropriate project accounting staff member. The User could also employ other means and processes to create and convey the purchase order requests forms.

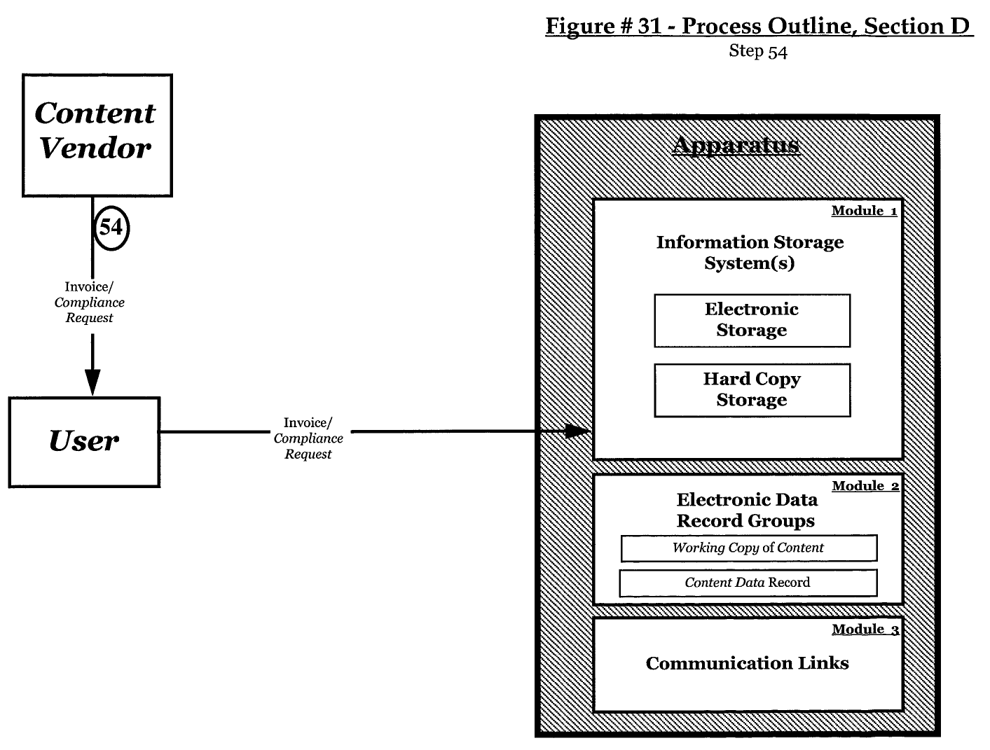

Creating Purchase Orders (FIG. 29)

51b) If the User is responsible for creating the purchase orders herself, she might employ the Apparatus to create the purchase orders by accessing pertinent information from her accounting system (such as purchase order identification numbers), information previously entered into the Apparatus (such as final use information, project information, contract identification codes, and licensing terms), and organizing it to be conveyed to the Content Vendor. The User could also employ other means and processes to create and convey purchase orders.

The User might choose to convey purchase orders with her use notifications (step 52).

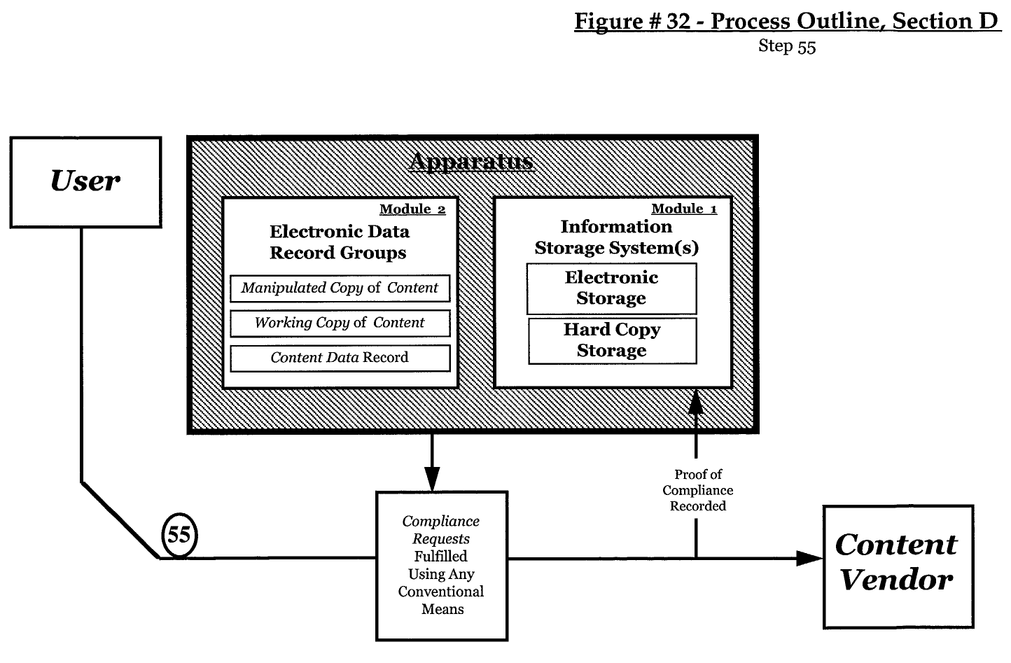

Step 52—Creating and Conveying Use Notifications (FIG. 30)

The User notifies each Content Vendor of the final use of their content within the project (hereafter “Use Notification”). She might wish to include instructions for submitting compliance requests in the use notification.

The User may employ the Apparatus to create the use notification by gathering the final use information, licensing terms, contract identification codes, and other pertinent information and organizing it into a template form to be conveyed to the Content Vendor. The User might also employ other means and processes to create the use notifications.

The User might choose to include purchase orders with the use notifications. (See step 51 for creation of purchase orders.)

The User conveys the use notification and the purchase order (if applicable) to the Content Vendor.

The User may choose to store the use notifications in electronic form (such as in a database) and/or in hard copy form (such as in a file) within the Information Storage System(s) of the Apparatus, or within other conventional storage systems. The User may also choose to store the command(s) and script(s) that created the use notifications from data within the Apparatus.

Step 53—Combining Use Notifications and Returns (FIG. 30)

The User has the option of including a use notification with the content being returned to the Content Vendor in steps 25-29.

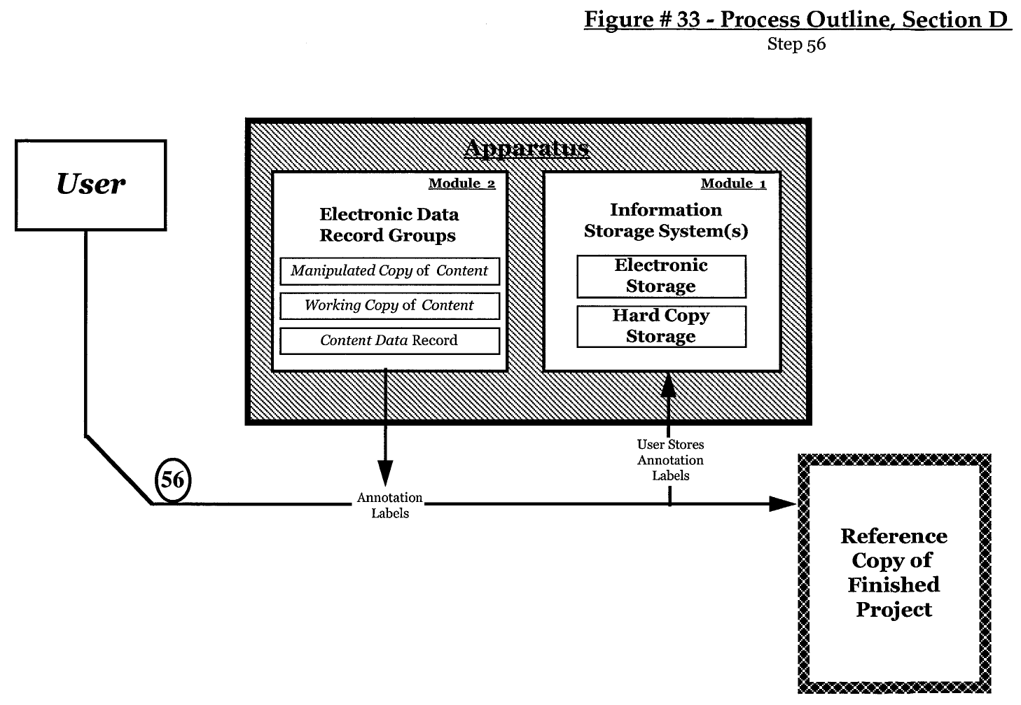

Step 54—Gathering & Storing Invoices/Compliance Request (FIG. 31)

The User gathers the Content Vendors' invoices and/or other compliance requests conveyed to her and stores them in electronic form (such as in a database) and/or in hard copy form (such as in a file) within the Information Storage System(s) of the Apparatus, or within other conventional storage systems.

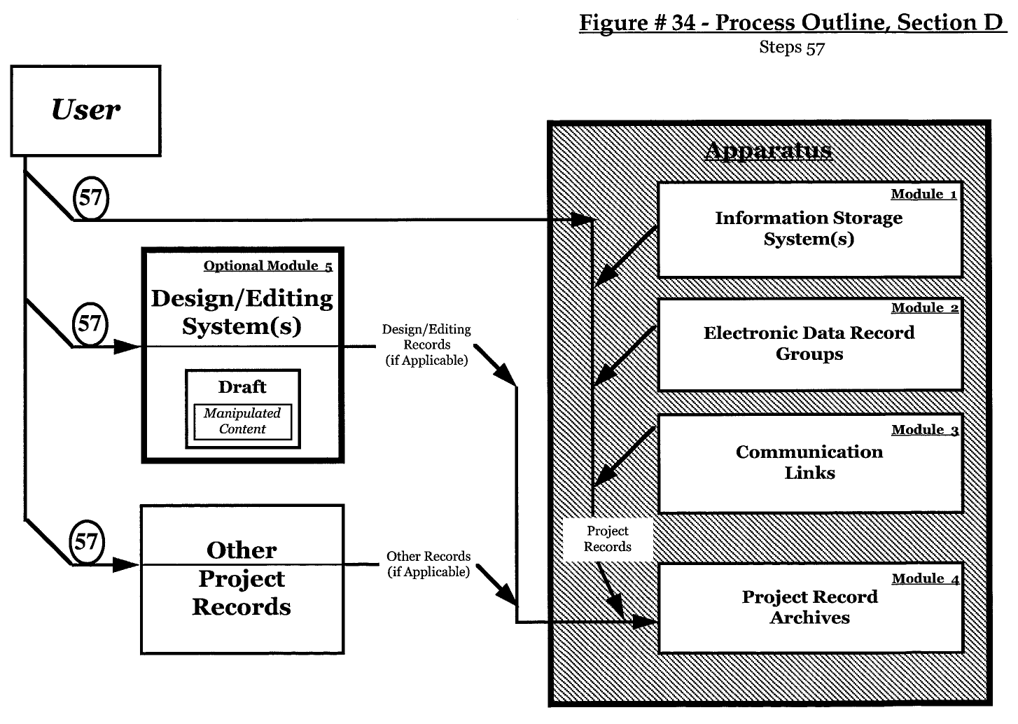

Step 55—Processing Invoices/Compliance Requests (FIG. 32)

The User processes the payments and/or other compliance requests using any conventional means. She has the option of gathering and storing proof of her compliance with the licensing terms of her contract with the Content Vendor (such as check numbers, shipping receipts, etc. . . . ).

The User may choose to record and store this information in electronic form (such as in a database) and/or in hard copy form (such as in a file) within the Information Storage System(s) of the Apparatus, or within other conventional storage systems.

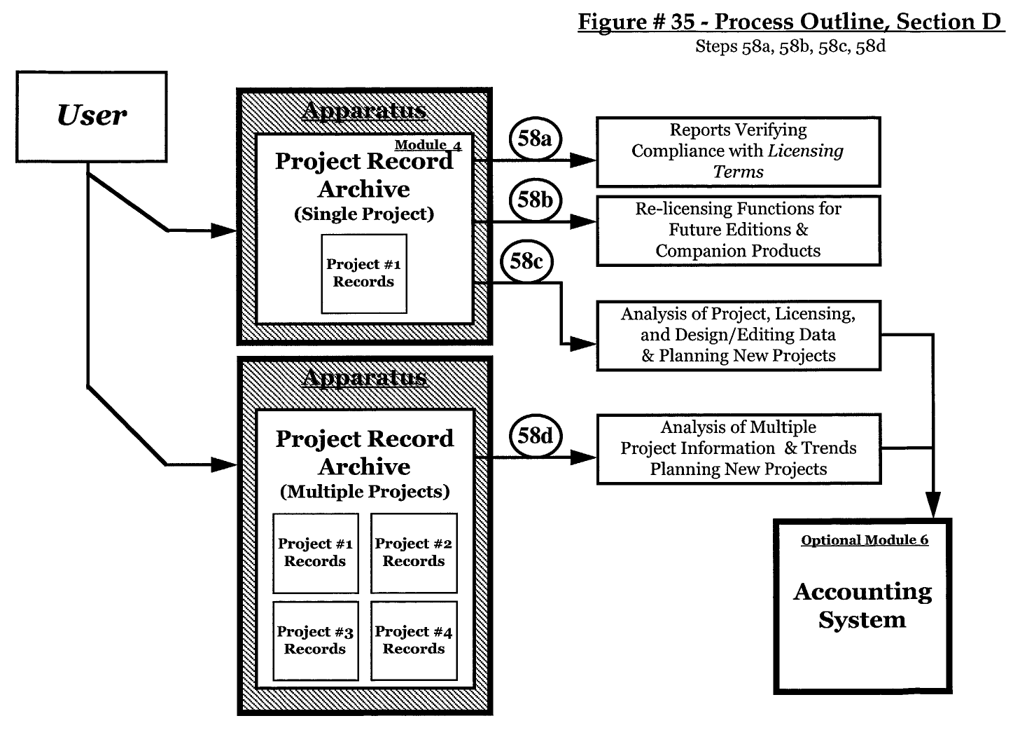

Step 56—Creating Annotation Labels (FIG. 33)

If applicable, the User may choose to create annotation labels listing information about the content, its source, a contract number, and/or other content information, to affix to a reference copy of the final project. The User may choose to employ the Apparatus to create these labels, or use other conventional means to create the labels.

The User may choose to store copies of the annotation labels in electronic form (such as in a database) and/or in hard copy form (such as in a file) within the Information Storage System(s) of the Apparatus, or within other conventional storage systems. The User may also choose to store the command(s) and script(s) that created the annotation labels from data within the Apparatus.

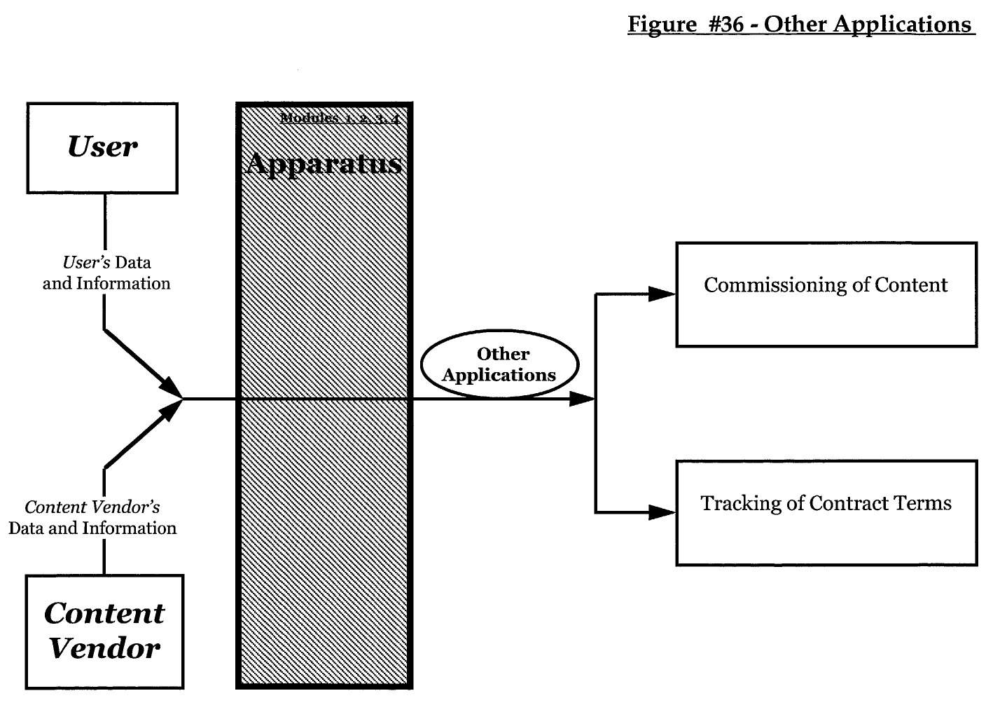

Step 57—Archiving Records (FIGS. 34)

All project records within the Apparatus (including correspondence, notes, faxes, e-mails, electronic transfers, and contracts) are stored for future reference in the Project Record Archives (Module 4 of the Apparatus). The User may wish to include records and/or documents from other parts of the project (such as marketing, printing, broadcast, budget records, design/editing layouts, and/or the annotated reference copy) with the Apparatus records.

The User could employ any conventional storage system to house the final records within the Project Record Archive, including an electronic form (such as in a database) and/or in hard copy form (such as in a file) within the Apparatus. The User may choose to employ other conventional means and processes to archive the project records.

The User may also choose to store all or selected information from multiple projects within the Project Record Archive.

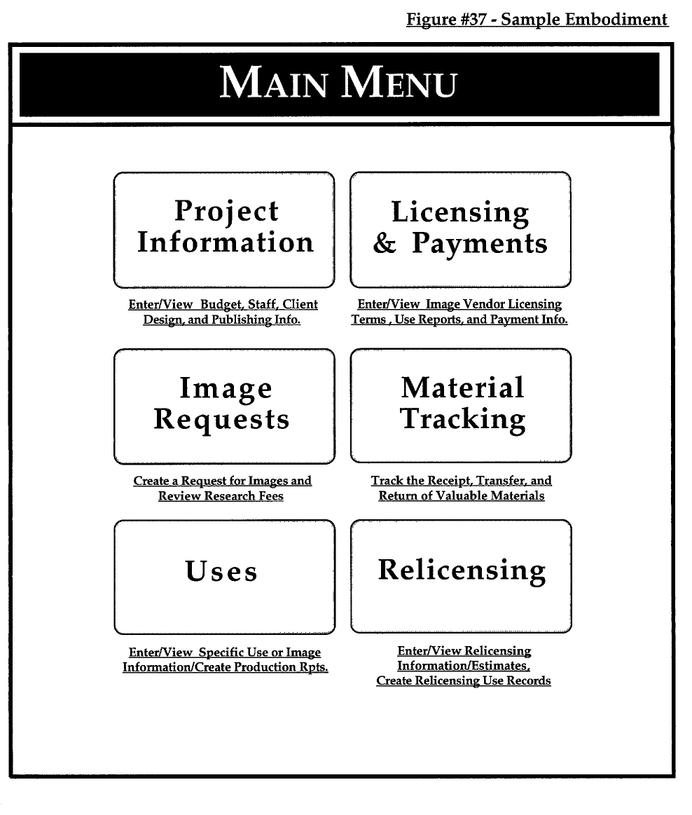

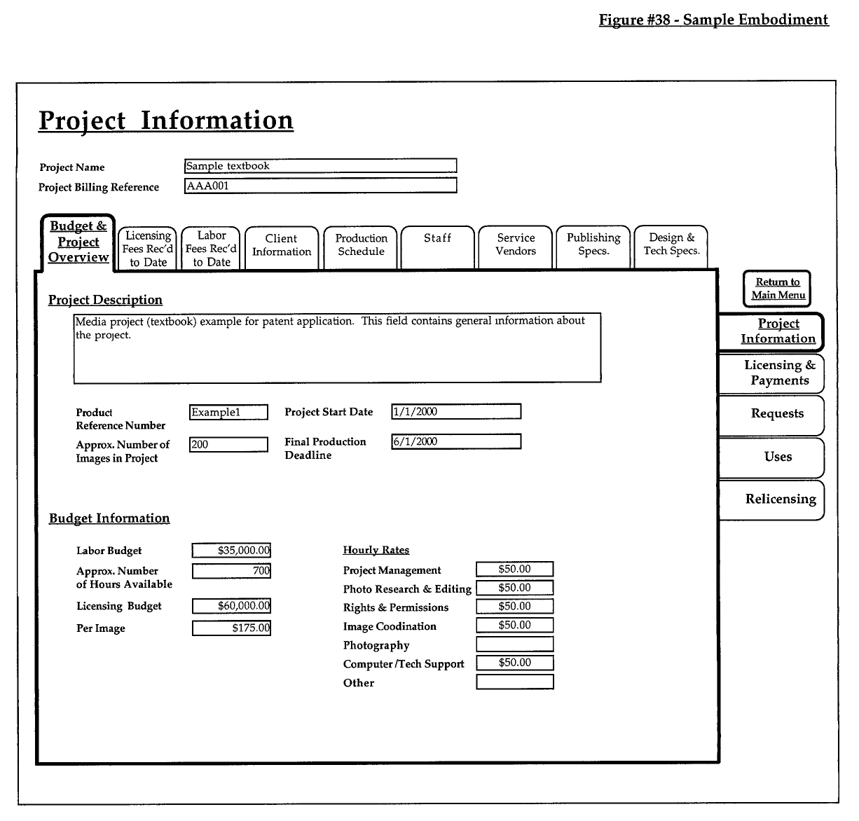

Step 58—Accessing and Analyzing Records (FIG. 35)

The User may access and utilize information within the Project Record Archive for a variety of post-production tasks including verifying compliance with licensing terms, re-licensing of content, budget analysis, and management analysis.

Verifying Compliance with Licensing Terms (FIG. 35)

58a) Should the User ever need to verify her compliance with licensing terms, she may choose to access the proof of compliance information (such as check numbers and shipping dates) in the Apparatus.

To do this, the User may employ the Apparatus to access and organize the proof of compliance information into a report form, which could then be conveyed to the appropriate people/parties.

The User may choose to store copies of the proof of compliance report in electronic form (such as in a database) and/or in hard copy form (such as in a file) within the Project Record Archive of the Apparatus, or within other conventional storage systems. The User may also choose to store the command(s) and script(s) that created the proof of compliance report from data within the Apparatus.

Re-licensing Content (FIG. 35)

58b) Should the User wish to re-license content for subsequent editions (or companion products) of the project, she could implement the process outlined above to assist her in creating the second edition contracts, records, and reports. In addition, the User could access information previously entered into the Apparatus during the original production (such as Content Vendor identification information, licensing terms, final pricing specifications, etc. . . . ) to create the documents, records, and reports necessary to complete the re-licensing. By accessing information previously entered, the User would dramatically reduce the time required to complete the re-licensing.

Analyzing Data (FIG. 35)

58c) The User could employ the data collected from the project to assist her in analyzing her overall performance in managing the project—including her efficacy in meeting budgets, in obtaining advantageous licensing terns, and in creating cost effective designs/edits.

To do this, the User might create a series of reports within the Project Record Archive that would calculate, compare and contrast different project, licensing and design/editing information (such as the average use fee per piece of content, the most efficient final pricing specifications, the licensing terms negotiated with different Content Vendors, etc. . . . ).

Should the User choose, these report could be entered into an accounting system (possibly Optional Apparatus 0-6) where other financial information related to the project, such as sales figures, could also be incorporated into analysis reports.

The User may choose to store copies of any of the analysis reports in electronic form (such as in a database) and/or in hard copy form (such as in a file) within the Information Storage System(s) of the Apparatus, or within other conventional storage systems. The User may also choose to store the command(s) and script(s) that created the analysis reports from data within the Apparatus.

Analyzing Data and Trends within Groups of Projects (FIG. 35)

58d) Should the User store records from multiple projects within the Project Records Archive, she could analyze information within all of the records to determine the efficiency of groups of projects (such as labor needs for particular types of projects), identify trends within her projects (such as a the relative use of various Content Vendors), and identify trends within the industry (such as pricing structures and practices).

Should the User choose, these reports could be entered into an accounting system where other financial information related to the project (such as sales figures) could also be incorporated into analysis reports.

Comparing the micro view of the Project Record Archive analysis, the macro view of the Multiple Project Record Archive, and the financial analysis of other parts of the project (such as sales figures) would enable the User to plan future projects.

The User may choose to store copies of the analysis reports in electronic form (such as in a database) and/or in hard copy form (such as in a file) within the Information Storage System(s) of the Apparatus, or within other conventional storage systems. The User may also choose to store the command(s) and script(s) that created the analysis from data within the Apparatus.

Other Applications

Although this application describes the use of the Process and Apparatus in relation to licensing content for a communications project, it could also apply to the commissioning of content.

The negotiation and tracking of contract terms and action dates could apply to all varieties of contracts—including those in other industries.

Reports

Advantageously, the present invention provides a User interface and/or functionality to generate reports and other information that further assists the licensor and licensee in administering the license, particularly in the area of licensing of, for example, copyright protected content or other data to be licensed. Further, the present invention allows the User to track records within the invention using a multitude of variables, such as billing codes and project names. (These variable, when used in this manner are referred to as “tracking fields”.) Therefore, records of multiple projects can be included in the invention while allowing the User to sort and organize them for specific projects.

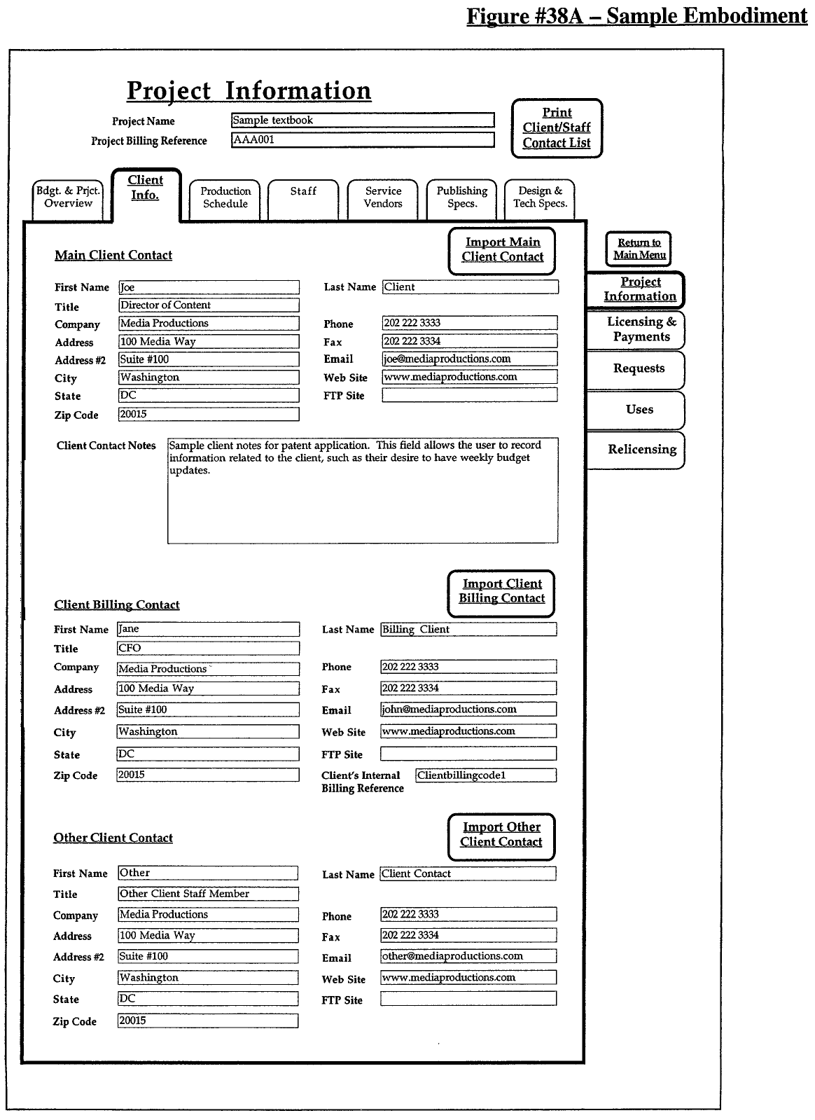

FIG. 37 is an illustration of a main menu in the User interface for the process and system in accordance with the present invention. As illustrated in FIG. 37, the Apparatus provides the User with a directory of information areas, which the User may click on to access records in that area. She may then enter or convey the appropriate information into each record. Paths back to the main menu illustrated in FIG. 37 and links to other areas of the database, as well as the tracking variables listed above, are displayed on most of the other screens within the User interface.

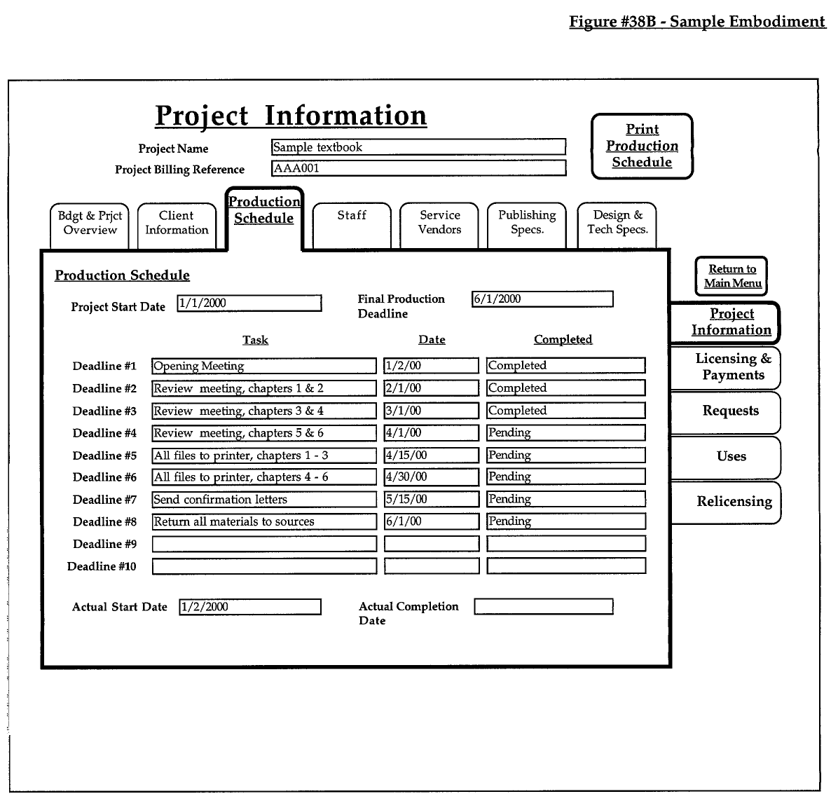

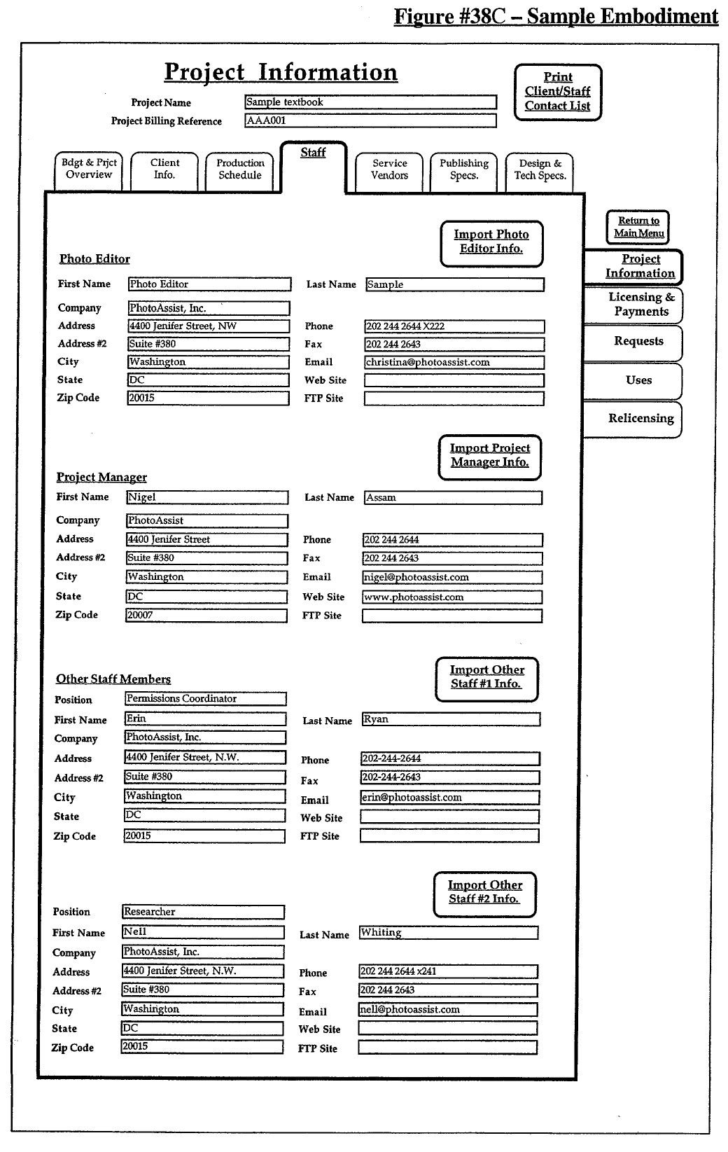

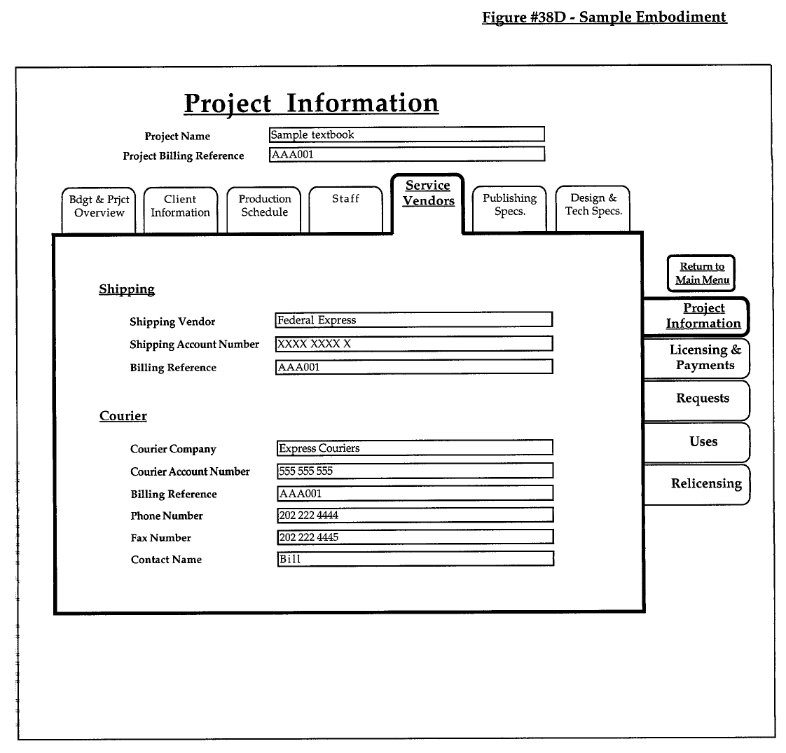

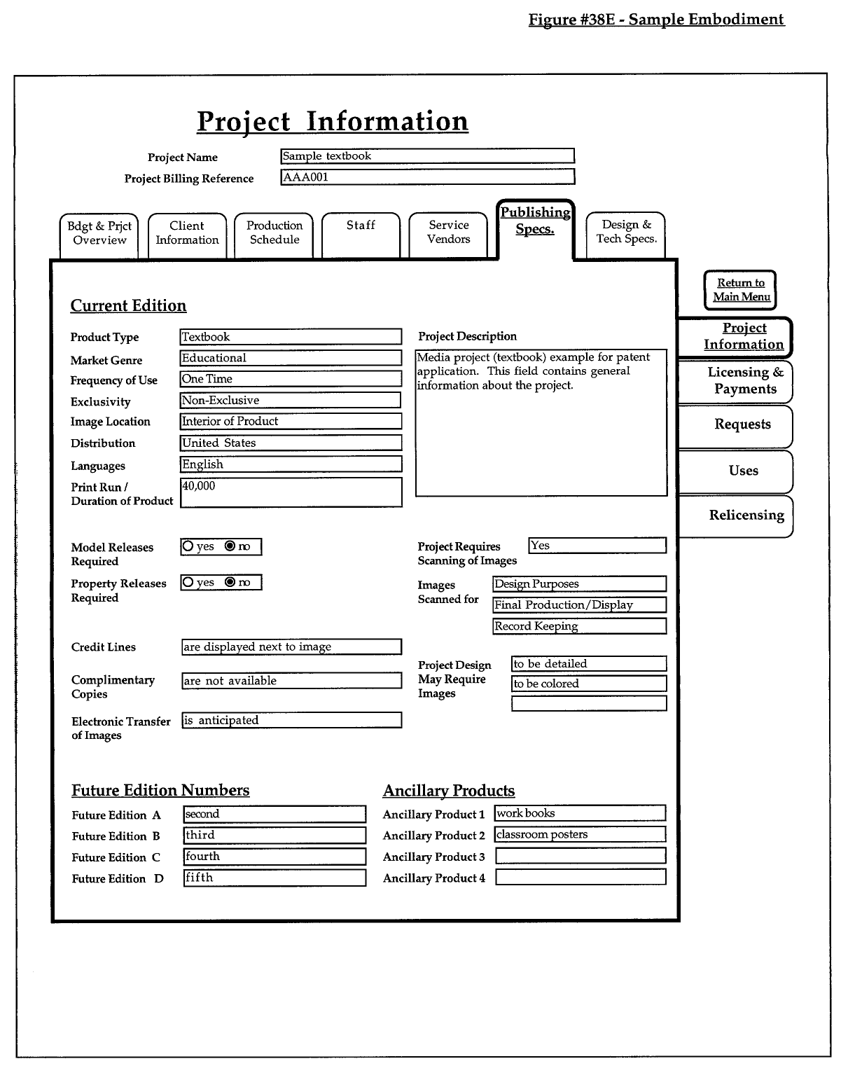

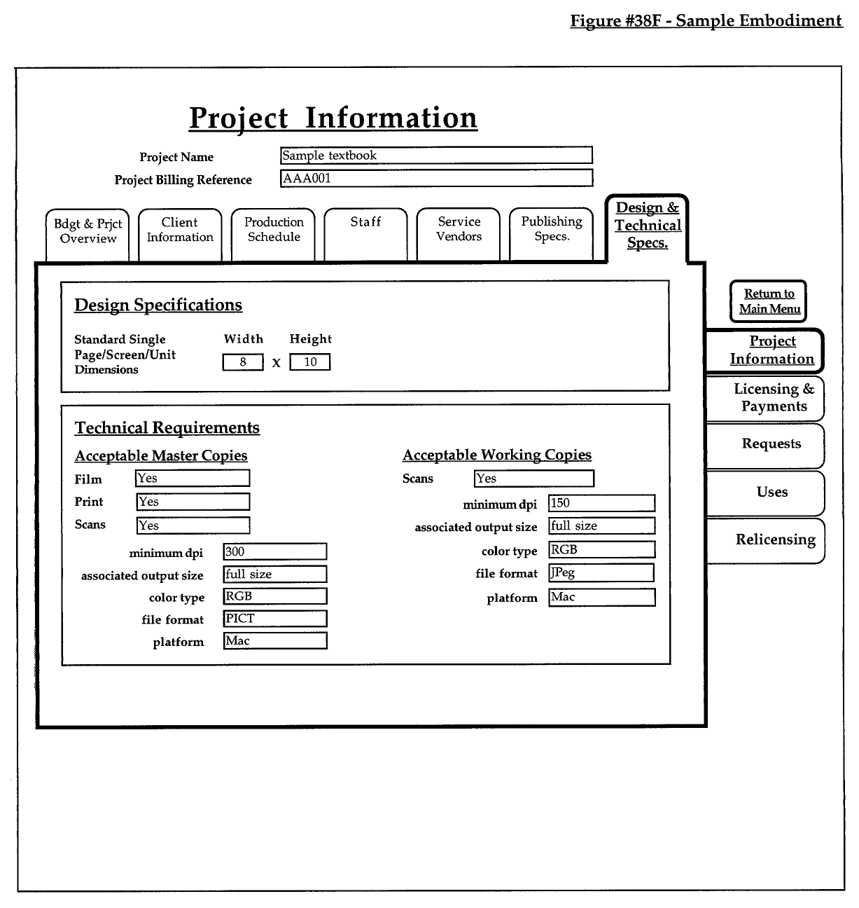

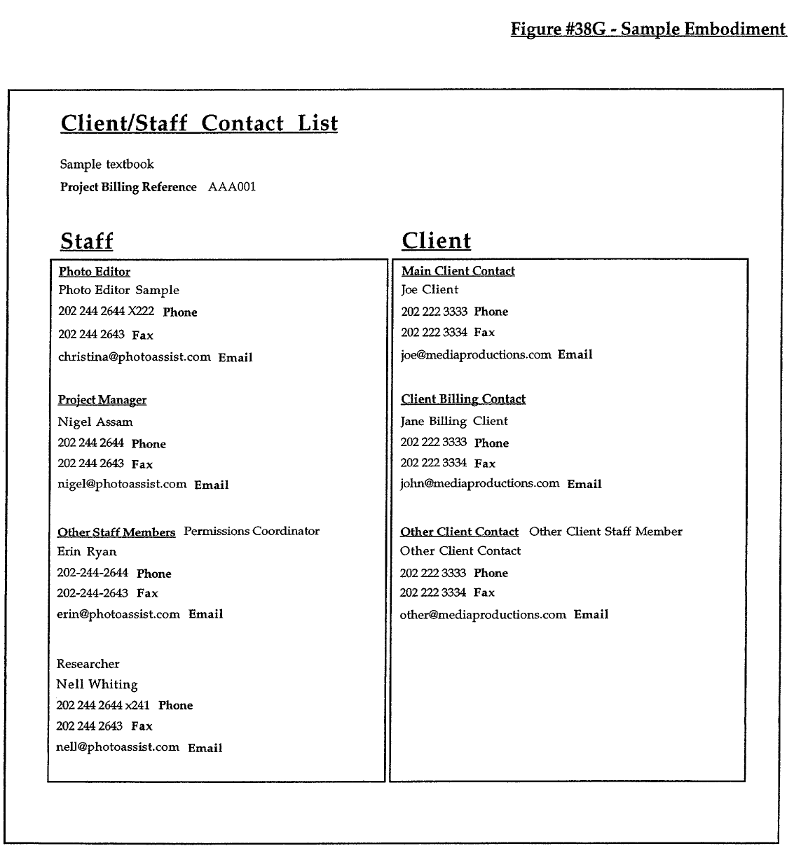

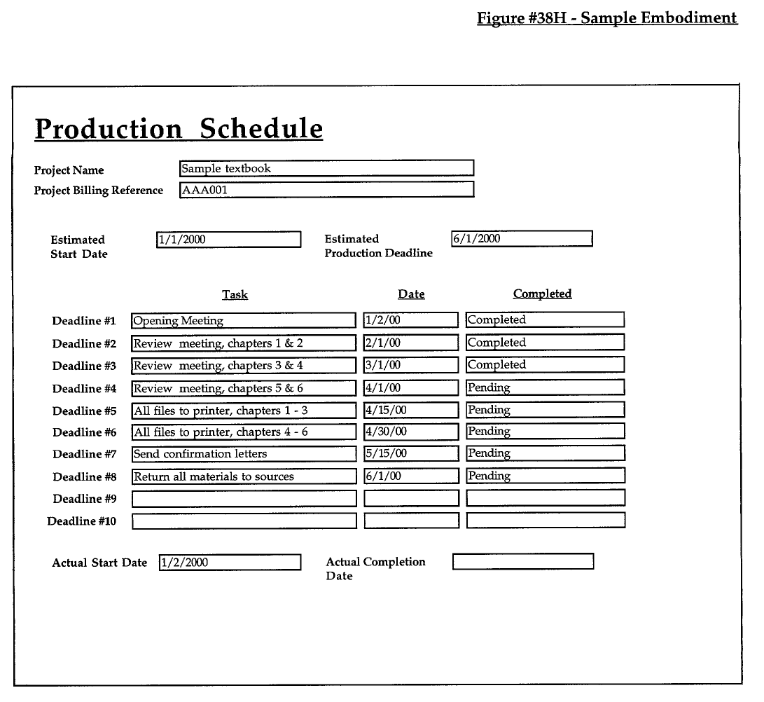

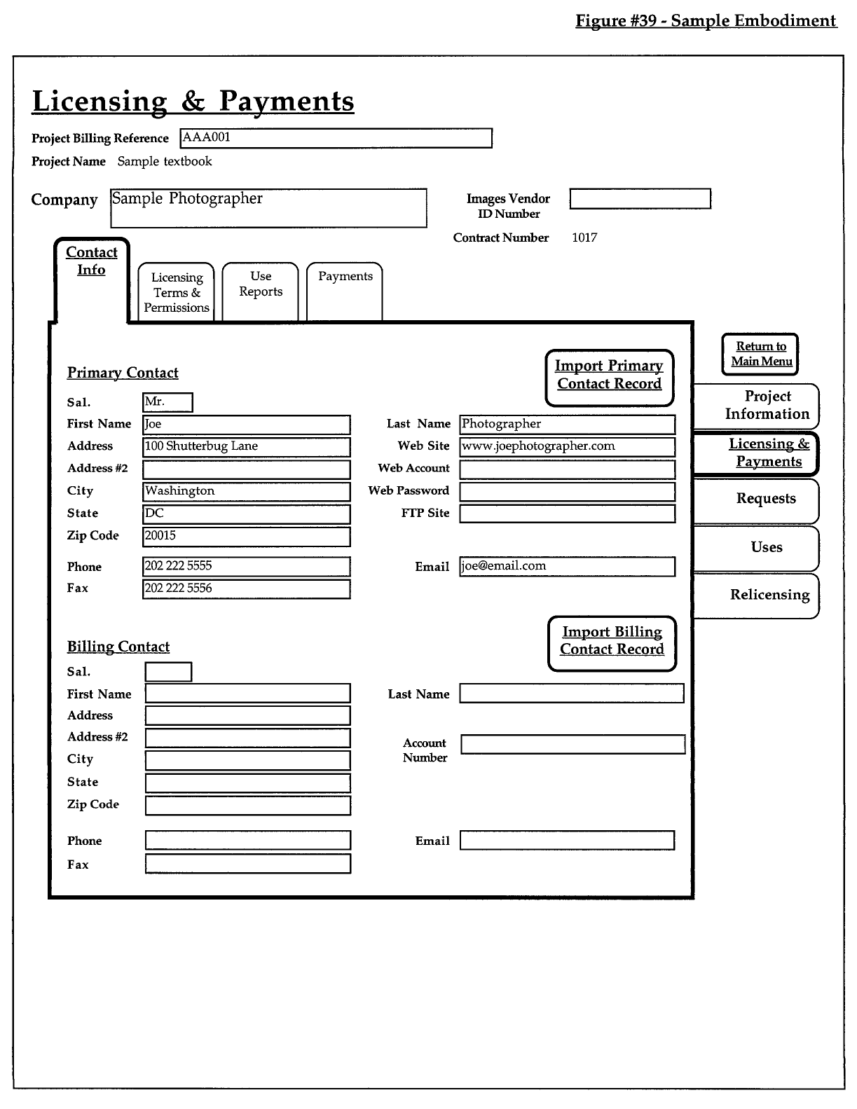

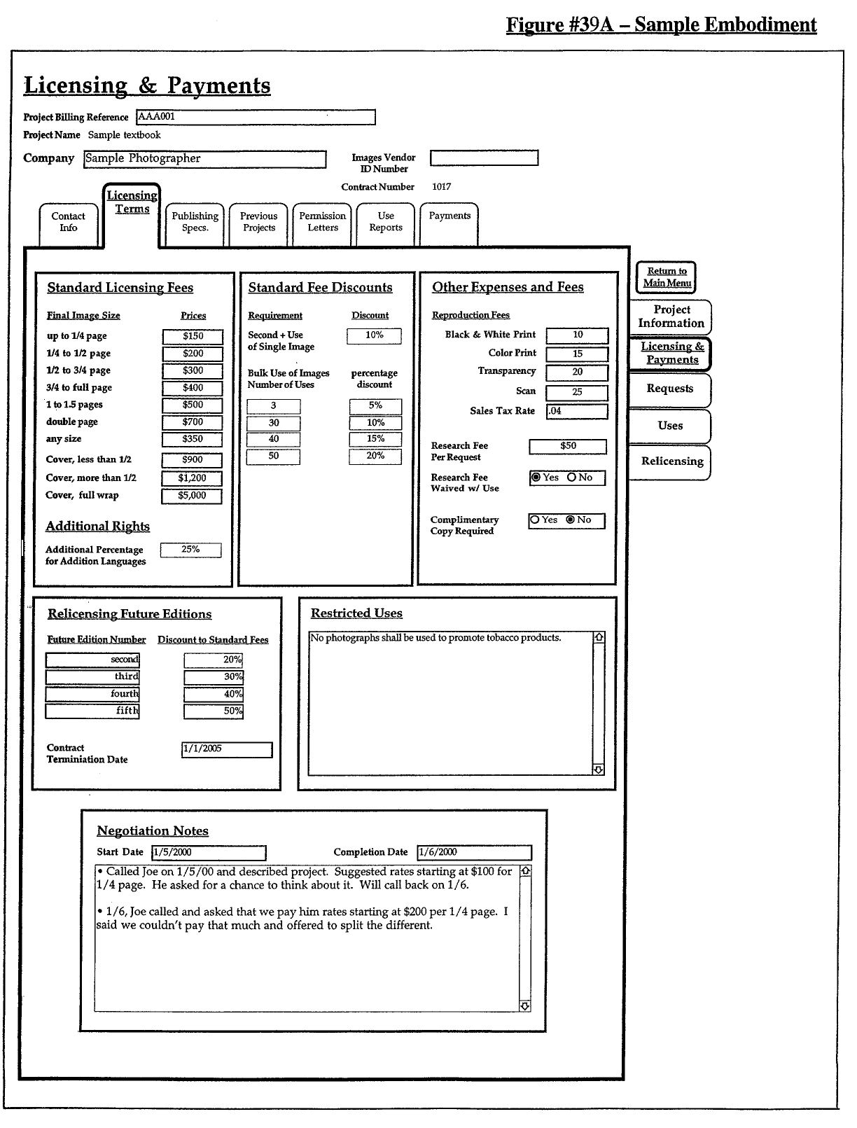

The project information area allows the User to record and track budget, client, production, staff, service vendor, publishing, and design information. Budget information is administered in accordance with FIG. 38. Client related information is administered in accordance with FIG. 38A. Production schedule information is administered as illustrated in FIG. 38B. Staffing related information is administered as illustrated in FIG. 38C. Service vendor related information is administered as illustrated in FIG. 38D.

Publishing specifications are administered as illustrated in FIG. 38E. These include a list of the media outlets where the project will be marketed or broadcasted (including the product type, market genre, distribution, and languages fields), how long it will be marketed (including the print run/duration field), and the manner in which the marketing/broadcast, design, and production process will effect the use of content (including the model/property releases, scanning permission, credit line locations, and design requirements fields). Design and technical specifications are administered as illustrated in FIG. 38F. These fields track the technical requirements for the project as a whole, including those for the working and master copies of content.

An important benefit of the present invention is the use of the project information data to create printable reports and lists to facilitate the licensing process. For example, the Apparatus might organize the project information to create a printable client/staff contact list as illustrated in FIG. 38G, or they may create a printable production schedule as illustrated in FIG. 38H.

Additionally, the project information pertains to the entire project, not just specific vendors or pieces of content. It can be entered once and, advantageously, used multiple times to facilitate the licensing process for multiple vendors and/or for multiple pieces of content. For example, fixed publishing specifications and technical requirements, which typically do not change throughout the course of the project, apply to all of the content and Content Vendors participating in the project. They can therefore be used to optionally communicate, track, and document licenses for all of the Content Vendors and content. Specific examples of this are noted below.

Licensing information, including payments and other compliance requirements, is recorded in the Licensing and Payments area of the Apparatus. It allows the User to record and track licensing information specific to Content Vendors (e.g., “company” in the drawings) whose content may be used in the project. The information tracked may include, for example, contact information, licensing terms, use information, and payment information for the project.

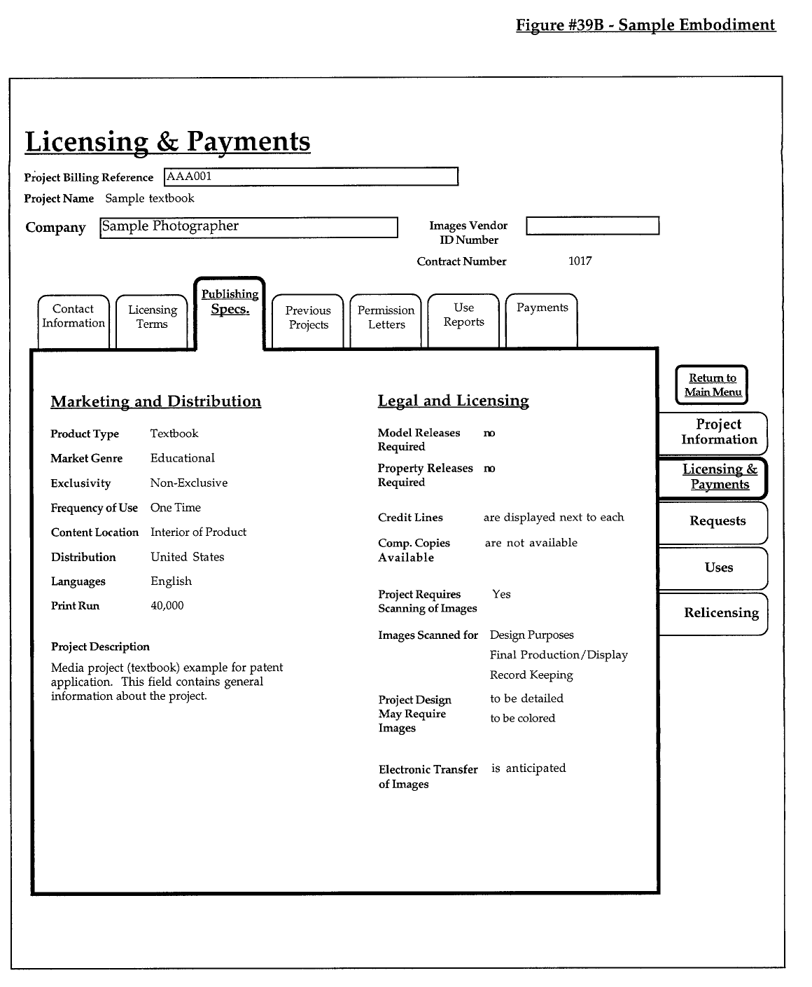

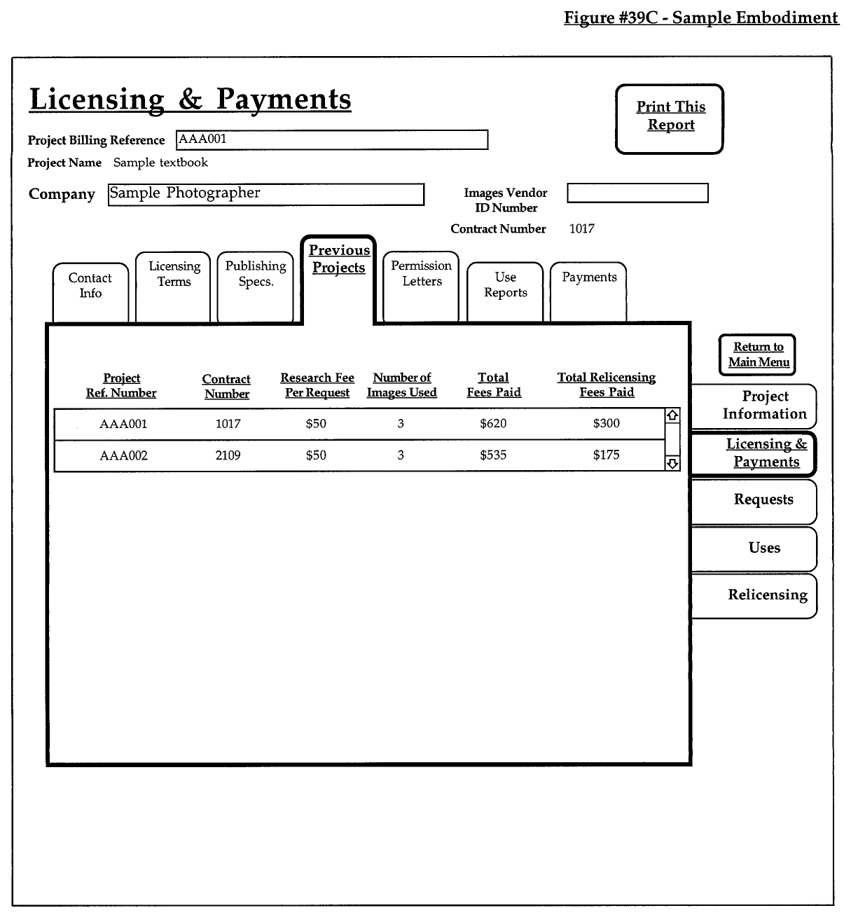

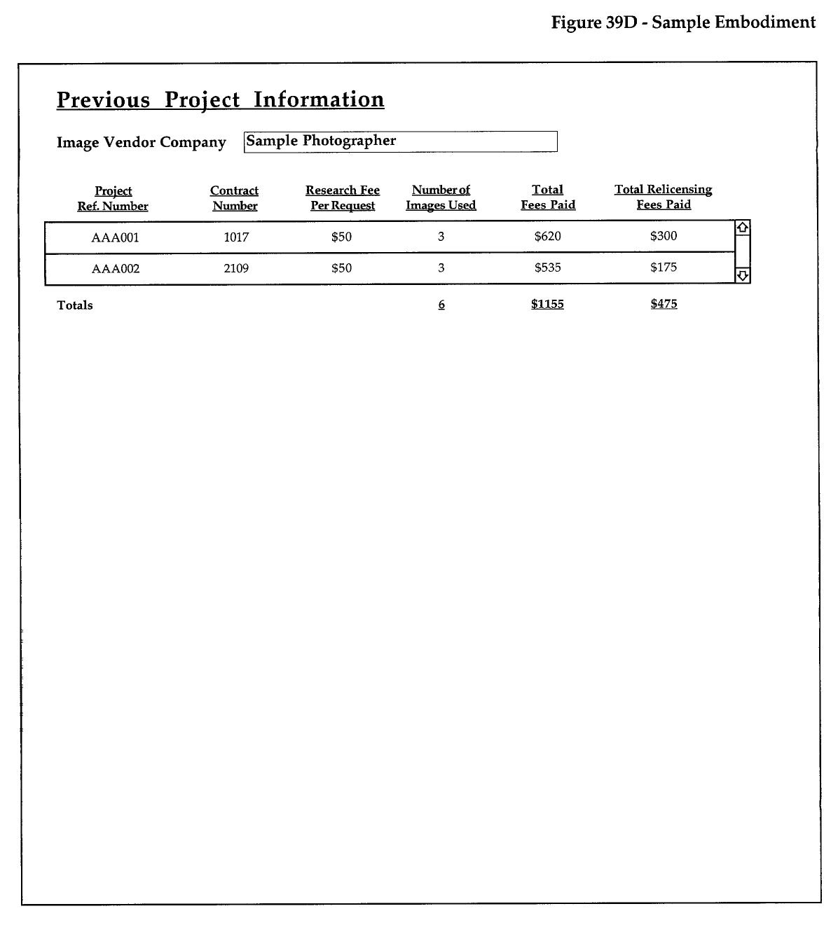

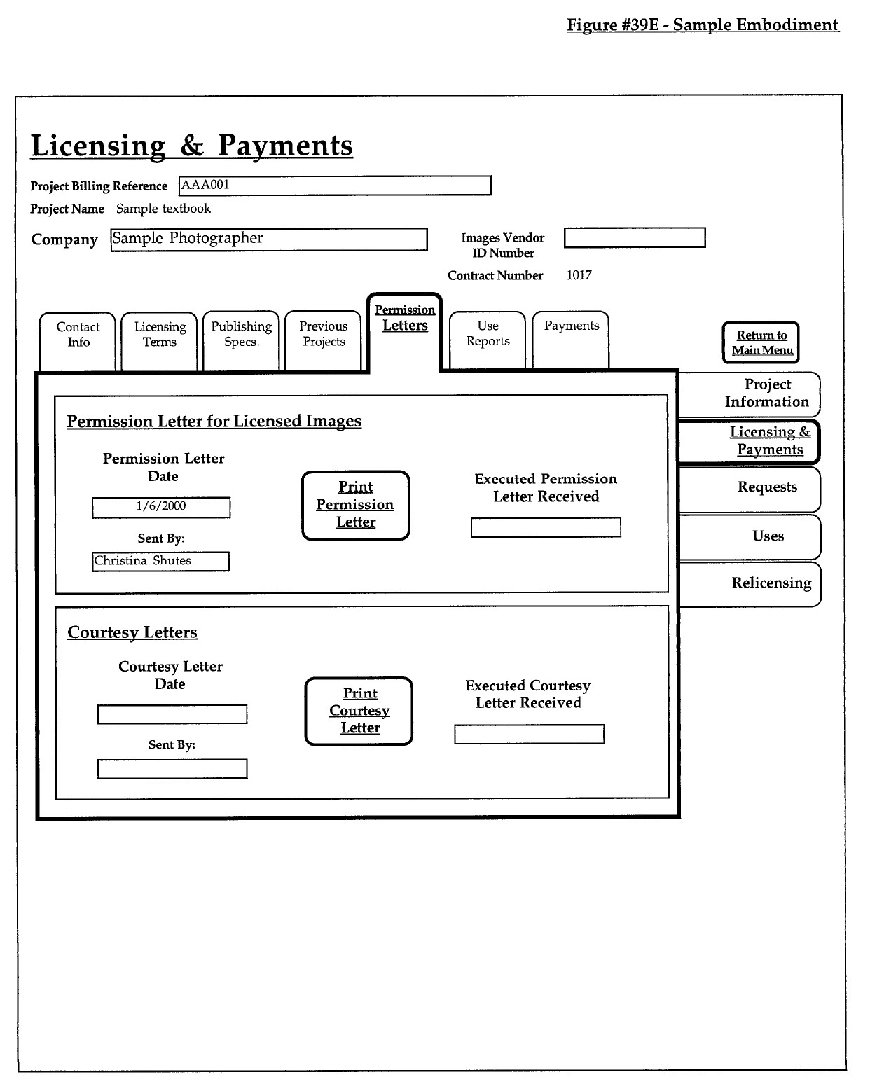

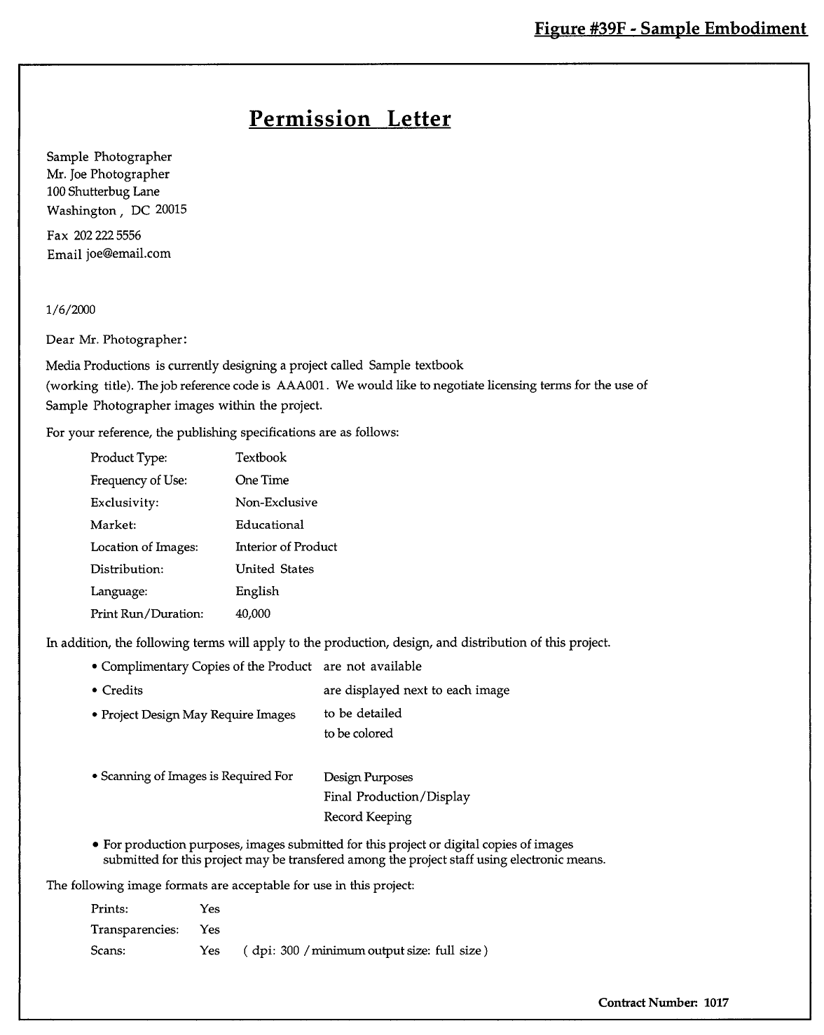

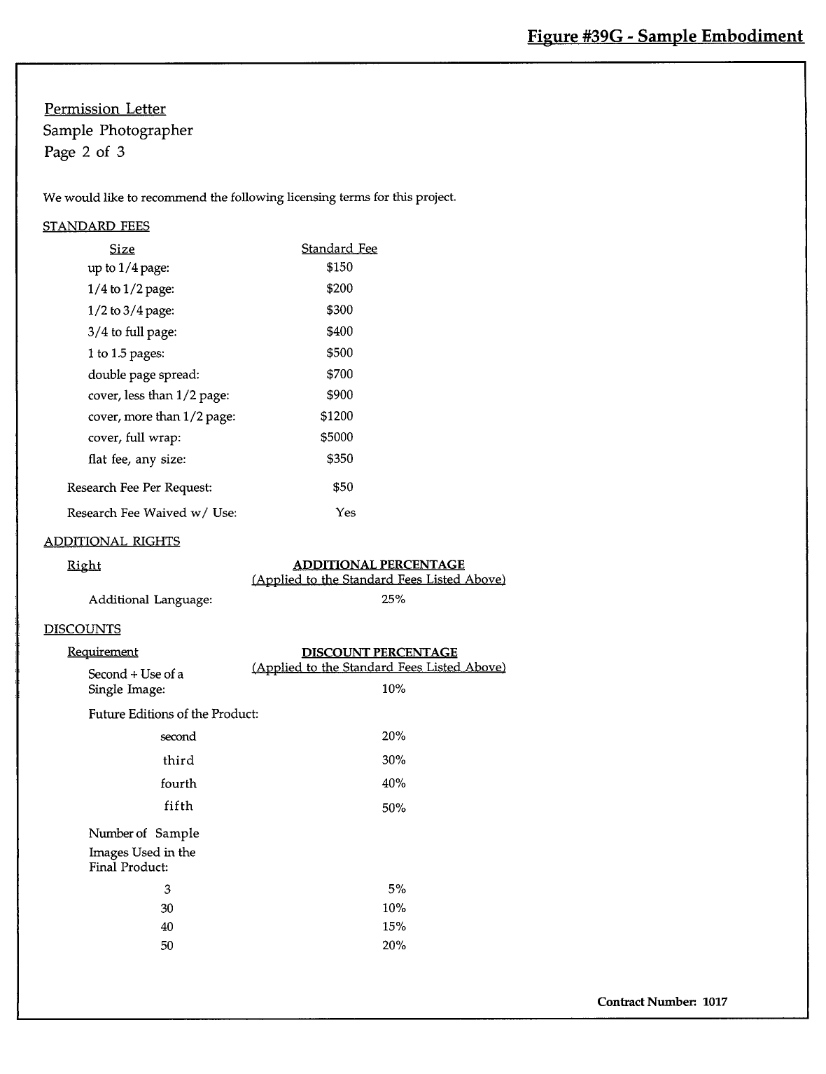

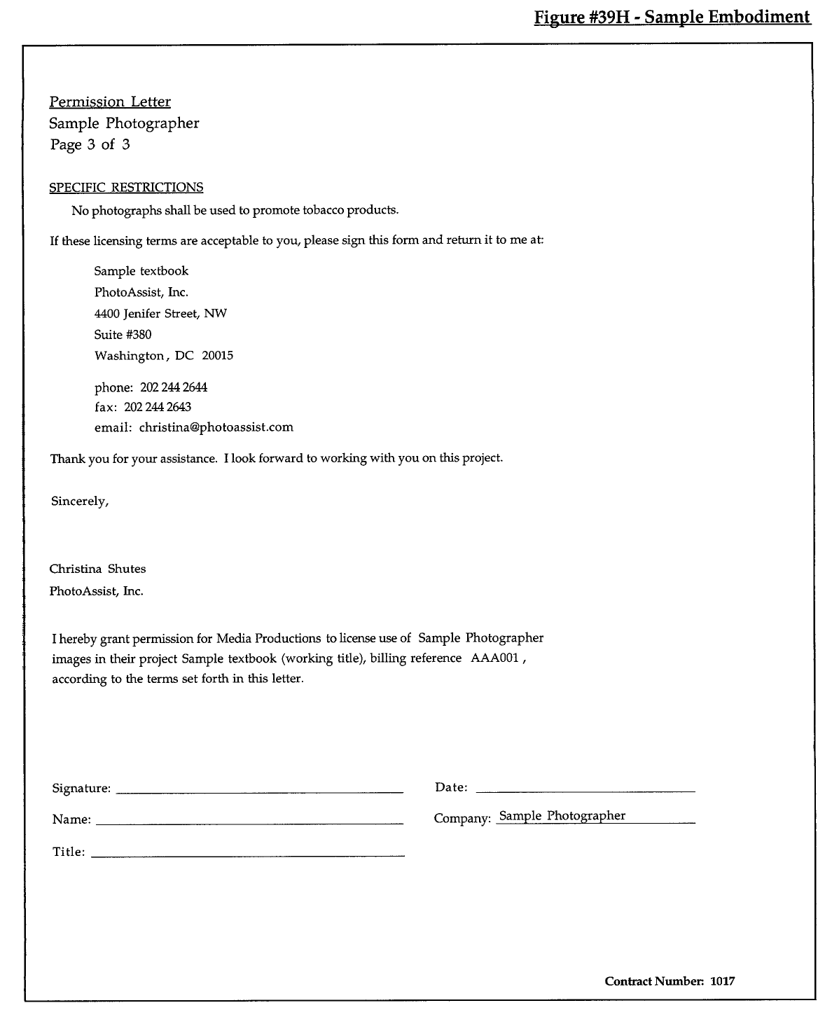

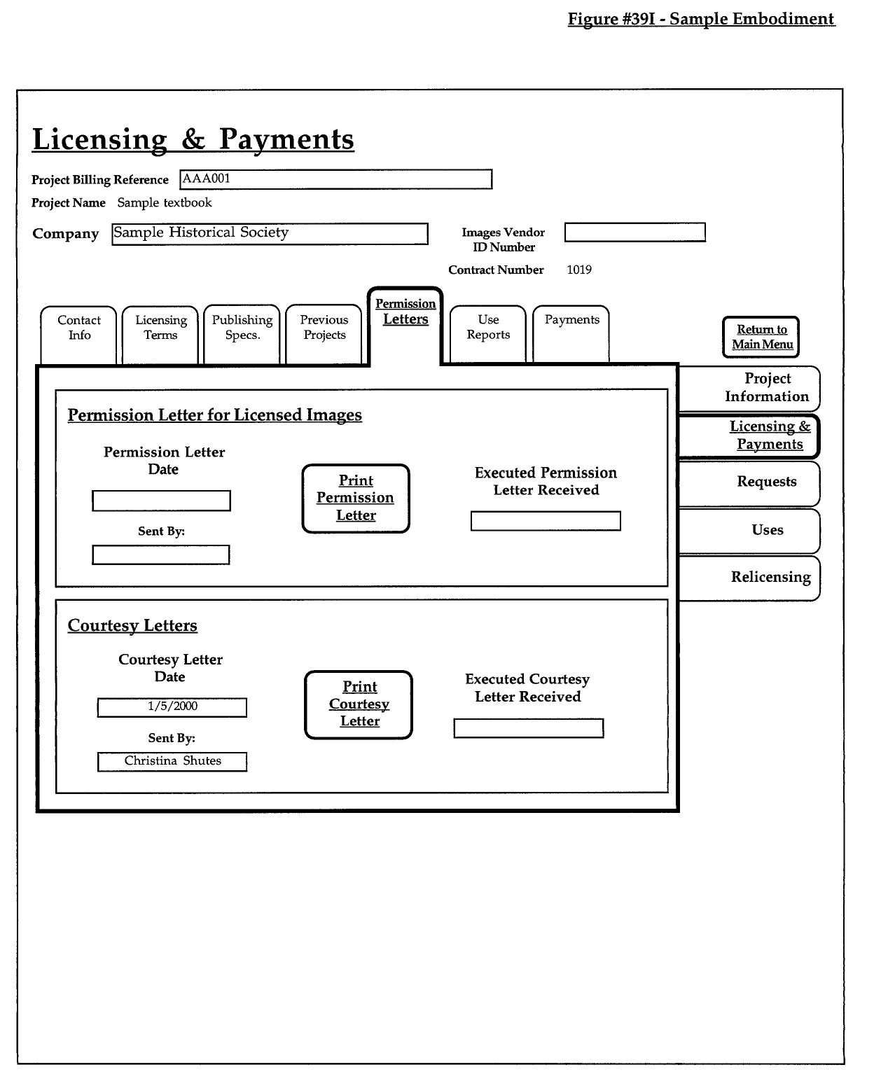

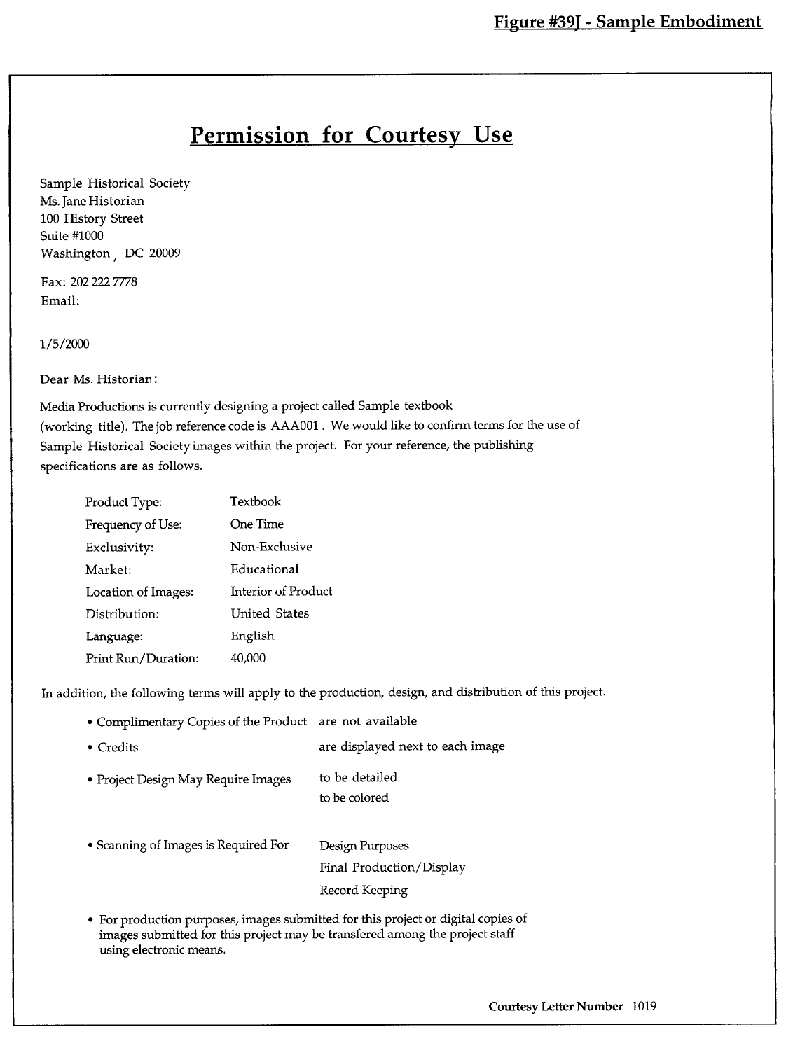

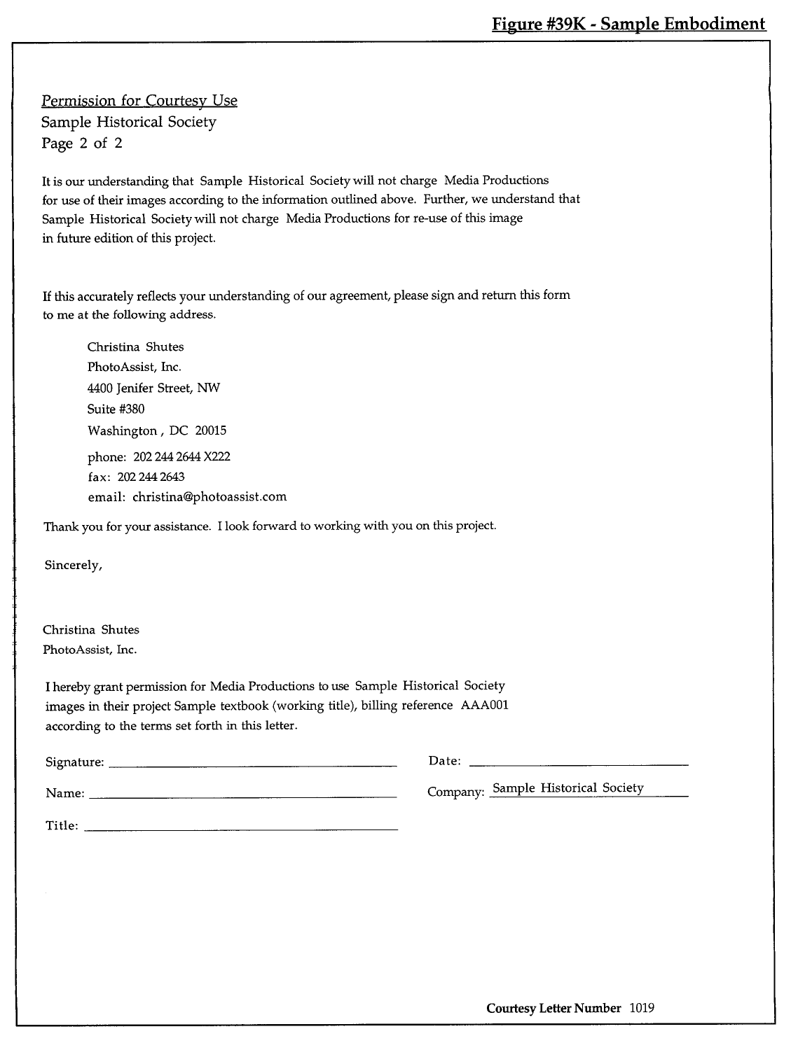

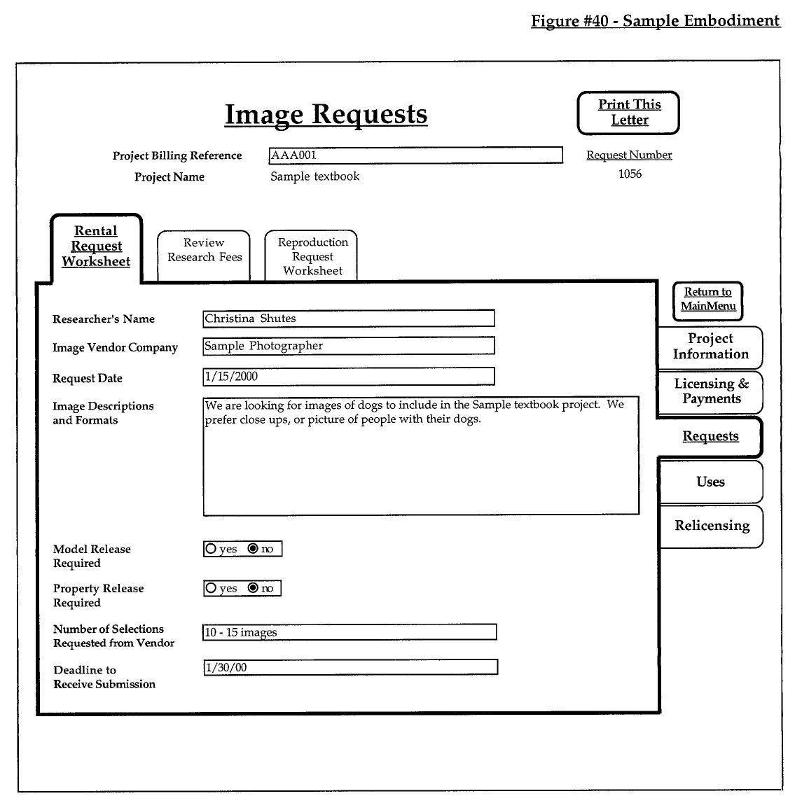

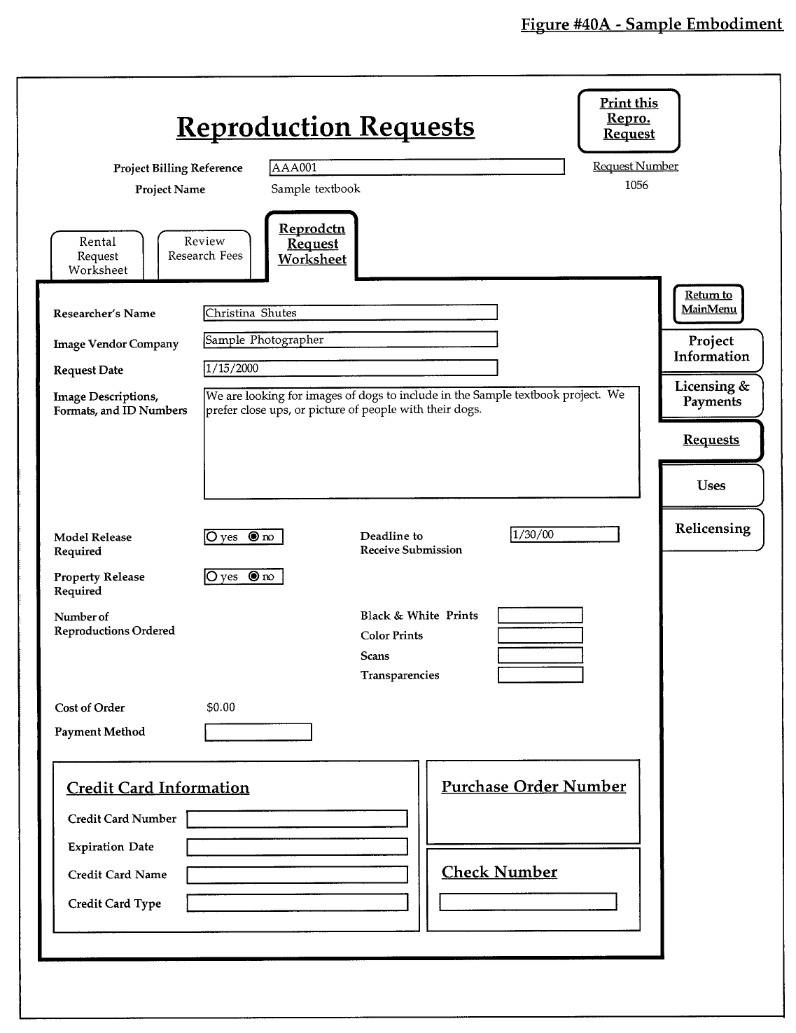

The Content Vendor's contact information is administered as illustrated in FIG. 39.

Variable pricing specifications, including standard licensing fees and associated size variables, standard fee discounts and associated variables, and restricted uses are administered according to FIG. 39A. The present invention further provides the functionality of tracking and providing licensing terms for additional rights and future editions on the same screen. (While not required, licensing terms for future editions can be negotiated at the same time as licensing terns for the current project.) This same screen administers research fees, complimentary copy requirements, and reproduction fees (including applicable sales tax). Finally, the screen provides space for the User to record notes from her licensing negotiations at the bottom of the screen.

Typically, the User will NOT know which of the variable pricing specifications will apply to a piece of content until late in the production process. However, it is advantageous for the User to negotiate the potential pricing specifications for content before the design process begins, so that the User can estimate costs for design drafts as production proceeds. (This process is described in more detail below.) Similarly, the User may not know if, or what, expanded rights or new editions of the project may be forthcoming. However, negotiating them here, as a percentage of standard licensing rates, serves two separate and important purposes. First, it can provide the User with accurate estimates, based on the initial licensing fees, of the costs to expand licensing rights or to re-license content for a new edition. Second, it saves the User considerable time by removing the need to separately negotiate and document new licensing contracts for expanded rights and/or future editions.

As mentioned earlier, the present invention advantageously accesses information entered into the different areas of the invention to efficiently create reports, lists, and documentation of the licensing process. While negotiating licensing terms, the User may quickly review the fixed publishing specifications that she entered into the project information area, by clicking on the “Publishing Specs.” tab near the top of the screen in FIG. 39A. The fixed publishing specification are then displayed for her reference as shown in FIG. 39B.

Likewise, during negotiations the User might wish to review previous payments she has made to that Content Vendor. The User is able to review this information, which has been tracked and organized by the Apparatus, as illustrated in FIG. 39C, by clicking on the “Previous Projects” tab. She may also create a hard copy of this information, as illustrated in FIG. 39D.

Once the negotiations are completed, the licensing contract (“permission letter” in the drawings) information is administered as illustrated in FIG. 39E. By combining this information with licensing terms and data previously entered into the project information area, the User is able to efficiently create a licensing contract as illustrated in FIGS. 39F-39H without again entering any of the project information or licensing terms. Should the Content Vendor not require payment or other forms of compliance to grant use of their content, the User can similarly create an appropriate licensing contract (“courtesy letter” in the drawings) as illustrated in FIGS. 39I and 39J-39K.

The last two sections of the “Licensing & Payments” area, Use Reports and Payments, are discussed below.

The User may optionally track and document image rental requests, image reproduction requests, and research fees in the Image Requests area of the Apparatus. Image rental requests solicit content from a Content Vendor for review by the User. Reproduction requests solicit the creation of a copy of the content for the User to purchase. The research fee review allows the User to track research fees against their image requests and final uses.

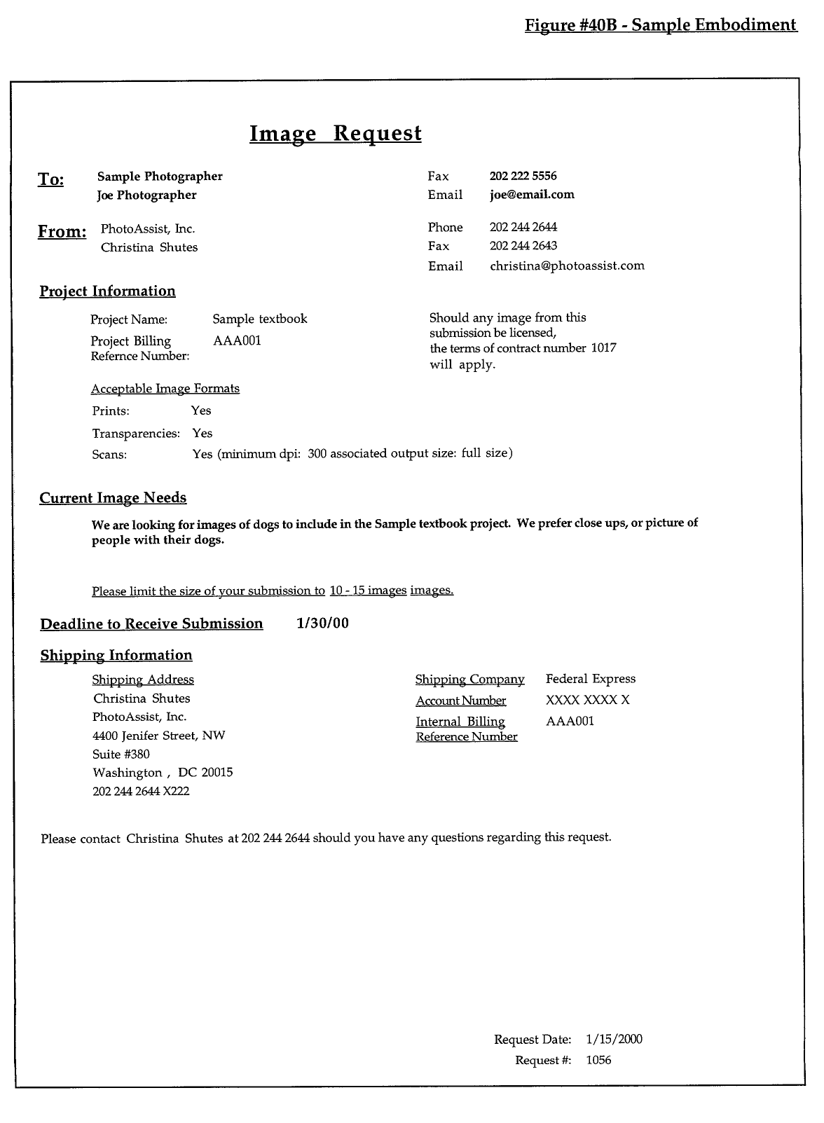

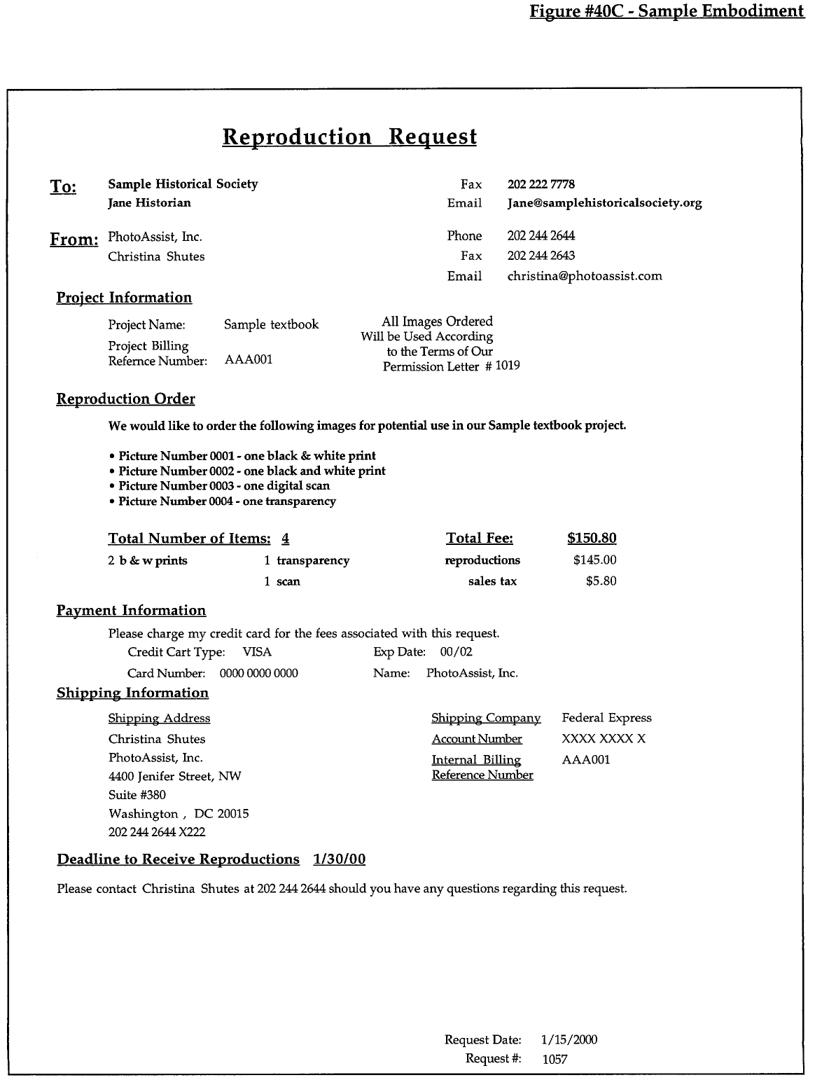

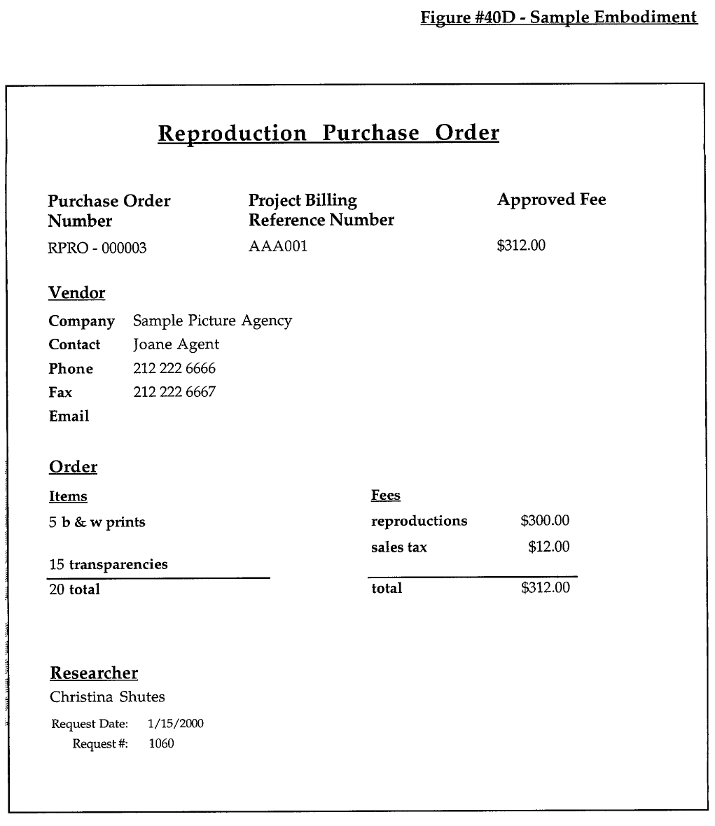

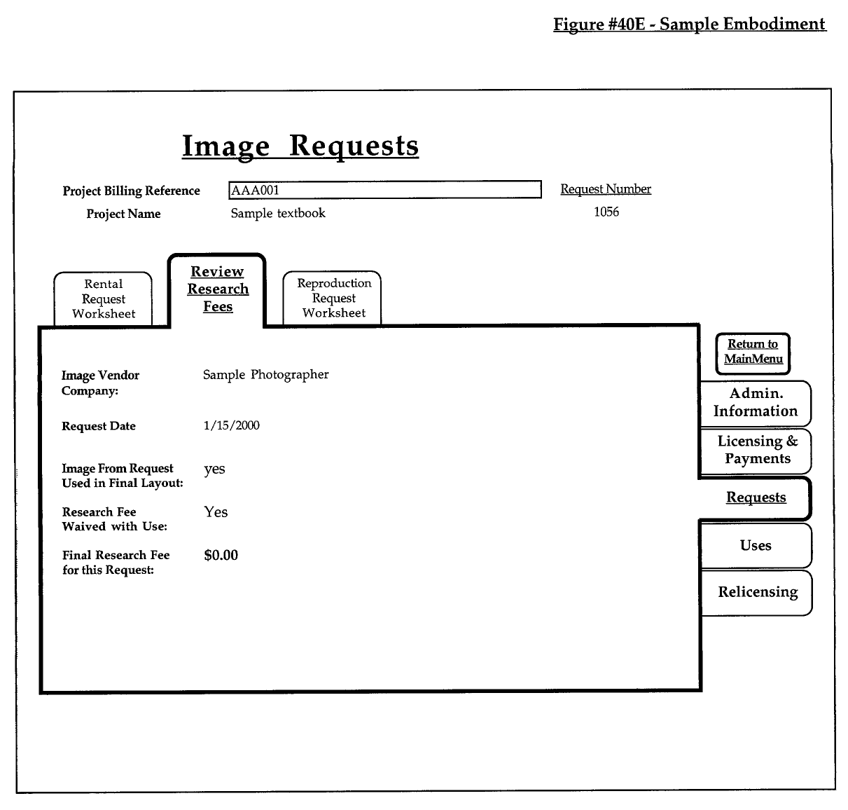

Information related to content rental requests is administered according to FIG. 40, information related to reproduction requests is administered according to FIG. 40A. In both cases, the present invention combines the rental/reproduction request information with previously entered information, such as the Content Vendor contact information, licensing contract numbers, User contact information, and fixed publishing specifications, to create a printable or transmissible image rental/reproduction request (FIGS. 40B and 40C respectively). The image rental/reproduction request advantageously puts the Content Vendor on notice that all images submitted for a project will be licensed according to the terms of the contract just negotiated. The image reproduction requests also provides the User with different payment options for the reproduction fees. The User may optionally choose to charge the fees on a credit card, enclose a check to cover the reproduction costs, or enclose a purchase order number. Should the User choose to use the purchase order option, the Apparatus automatically assigns a unique purchase order number to the reproduction request, and includes it in the print out. The Apparatus also provides the User with a copy of the purchase order, as illustrated in FIG. 40D.

Because many Content Vendors will waive their research fees should an image from the request be licensed, the present invention advantageously organizes information related to each image rental/reproduction request, the associated Content Vendors research fee policy (as part of the licensing terms screen), and the use records (FIG. 40E). This screen allows the User to check, at a glance, the status of the research fee for a given rental request, and, at the end of the project, the appropriate research fees to be paid to the vendor.

The system and/or User sends the request to the Content Vendor, who, in return, provides the User with content, either in digital form (such as an electronic scan) or in hard copy form (such as a print or transparency) or other valuable materials. The present invention optionally includes a tracking system, which assists the User to count, log, index, record filing locations, and perform other standard tracking functions for the submitted content. The tracking system of the Apparatus allows the User to efficiently manage the acceptance, storage, transfer, and return of content. It minimizes the chance of damage and/or loss to the content and the chance of incurring any associated penalties or fees.

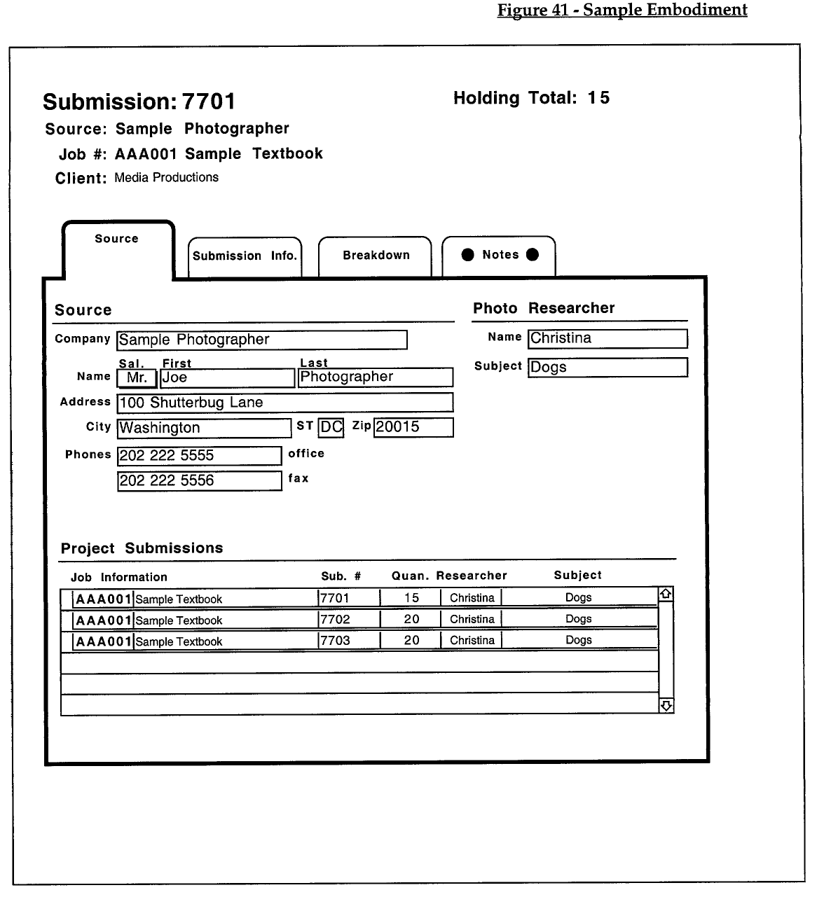

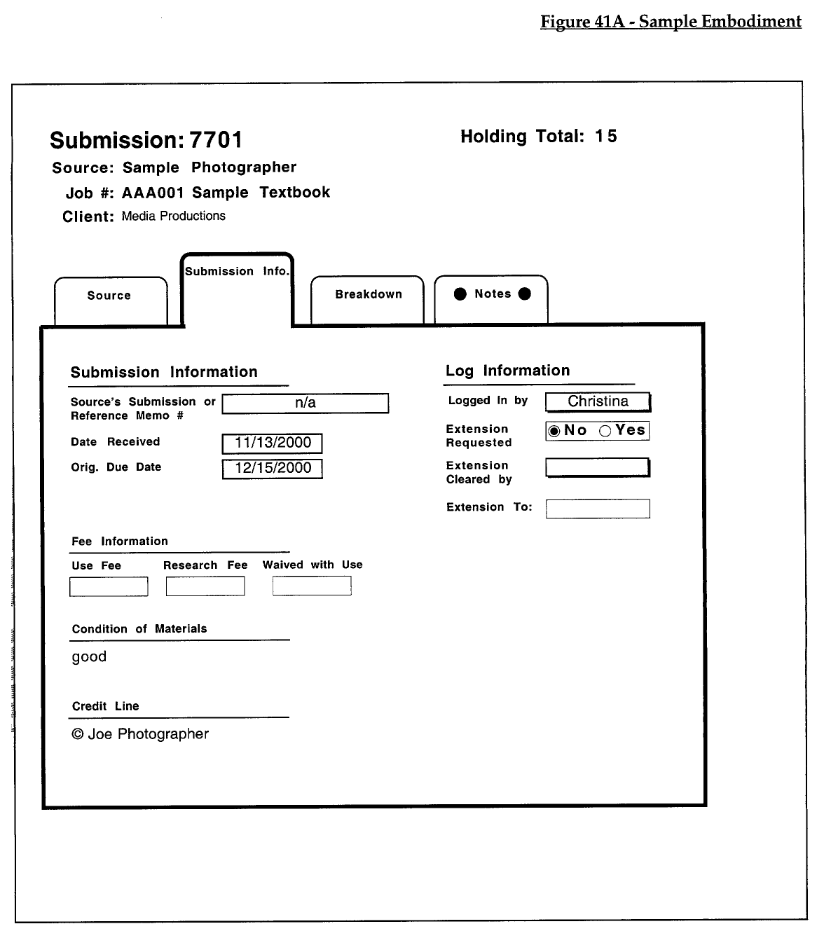

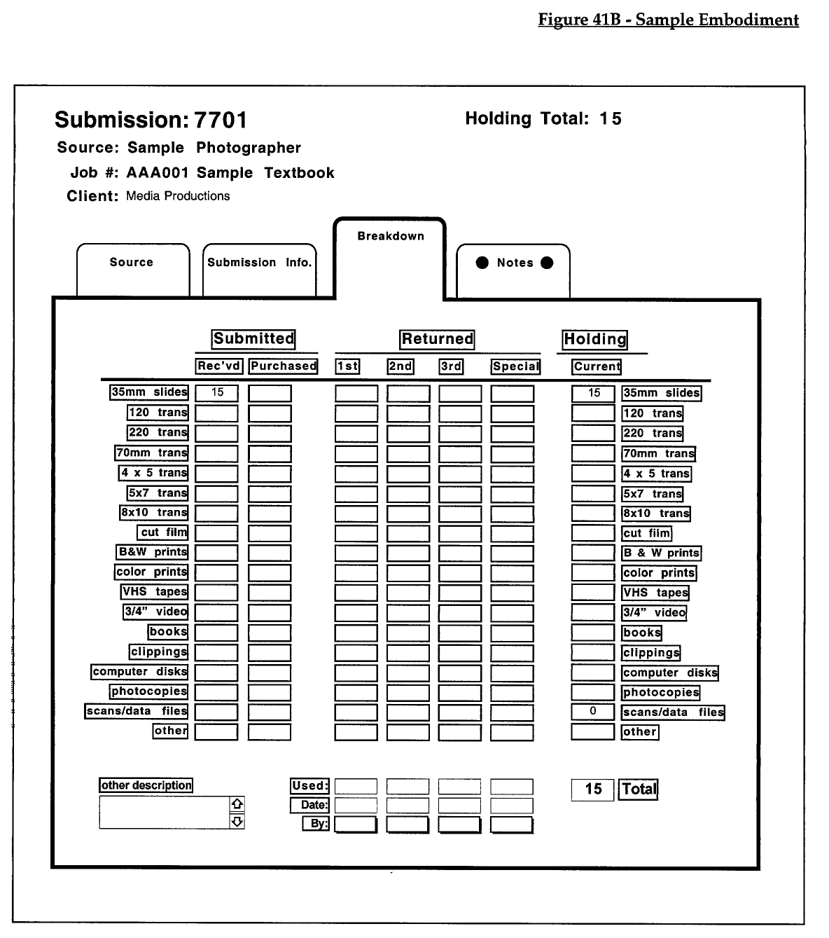

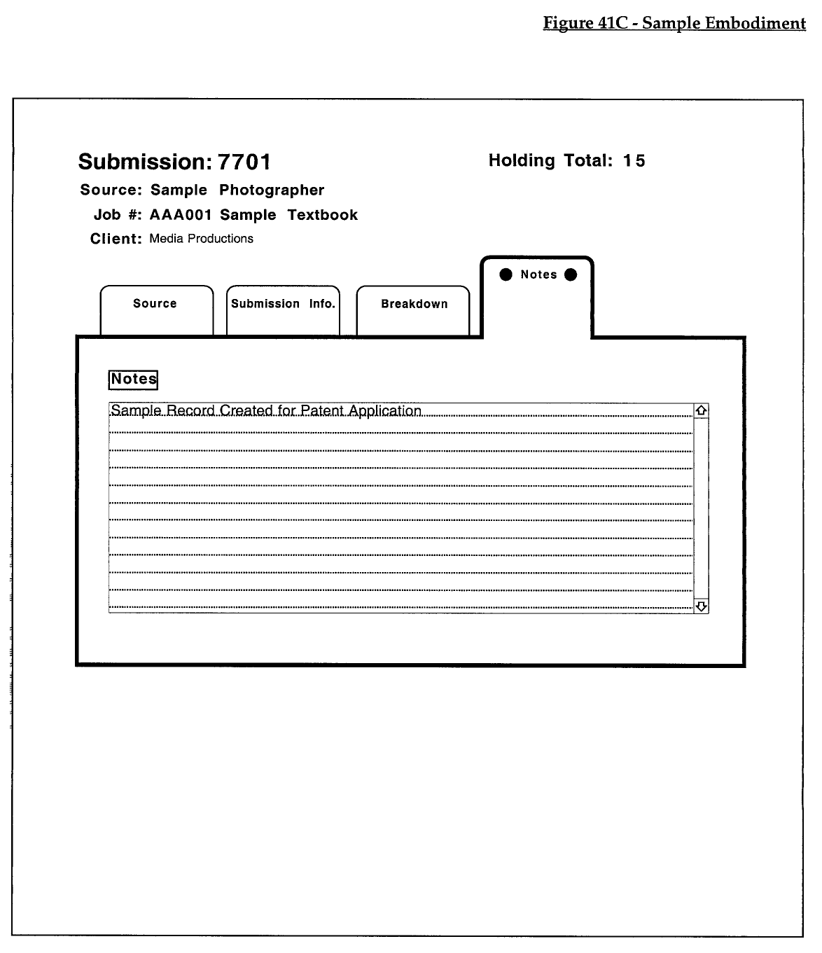

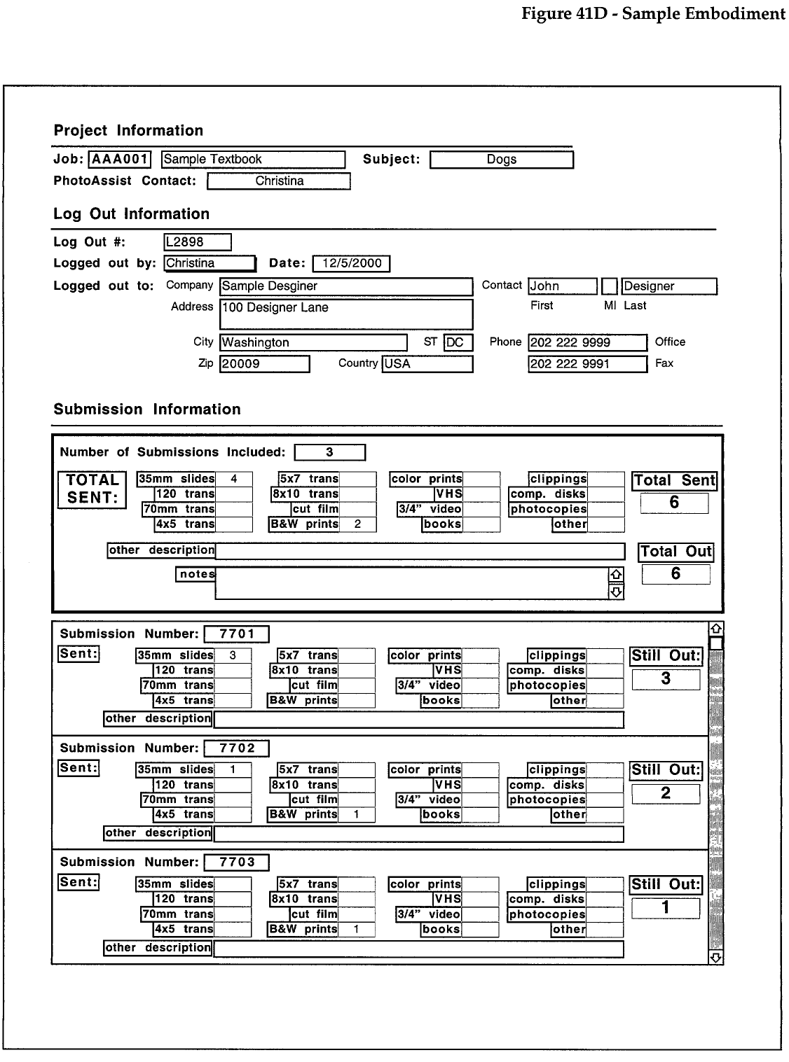

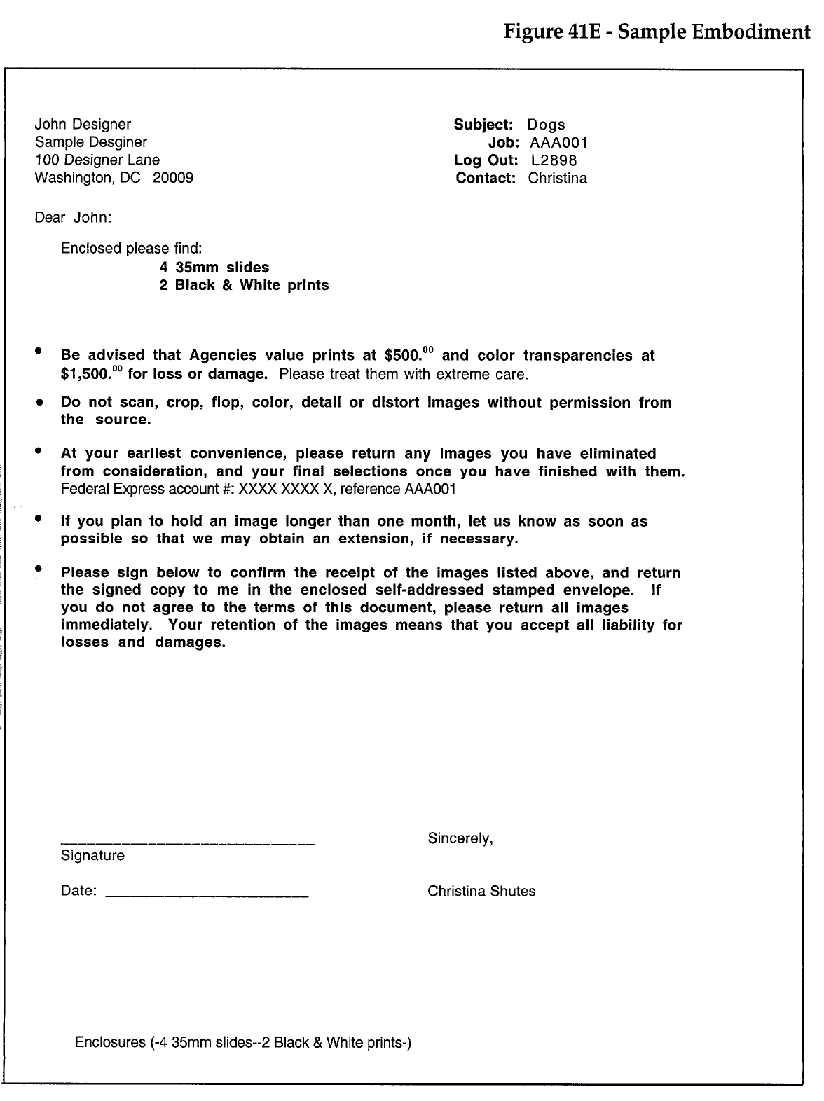

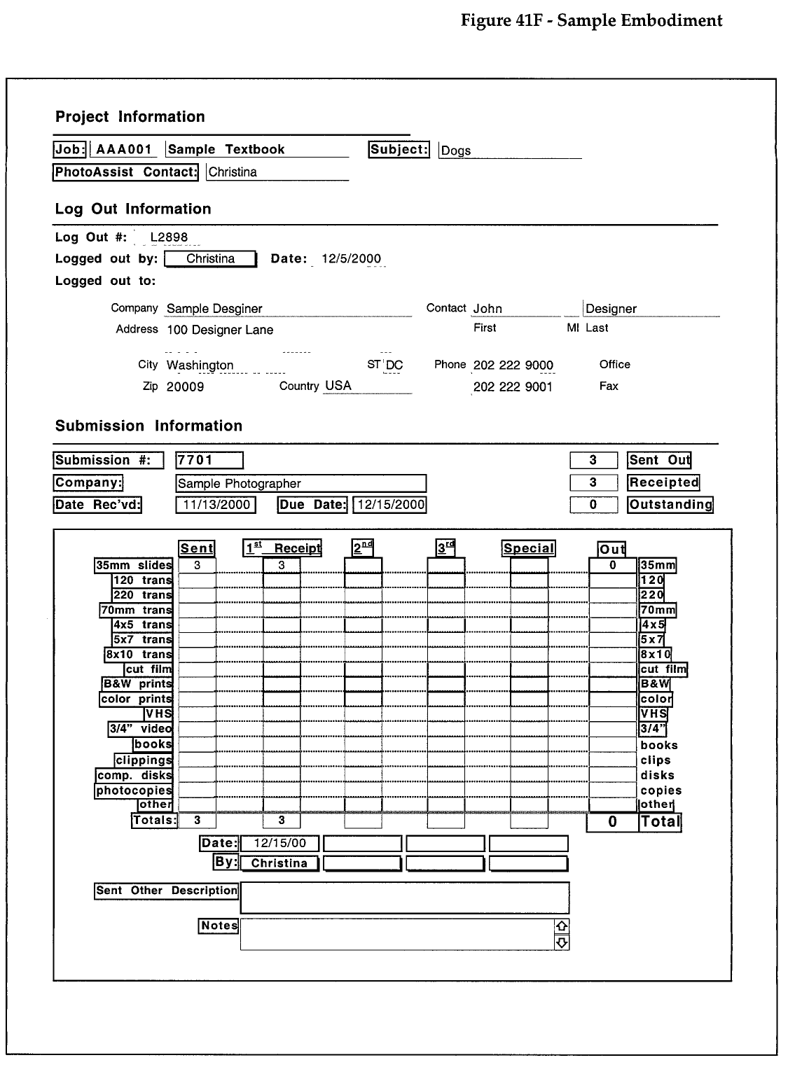

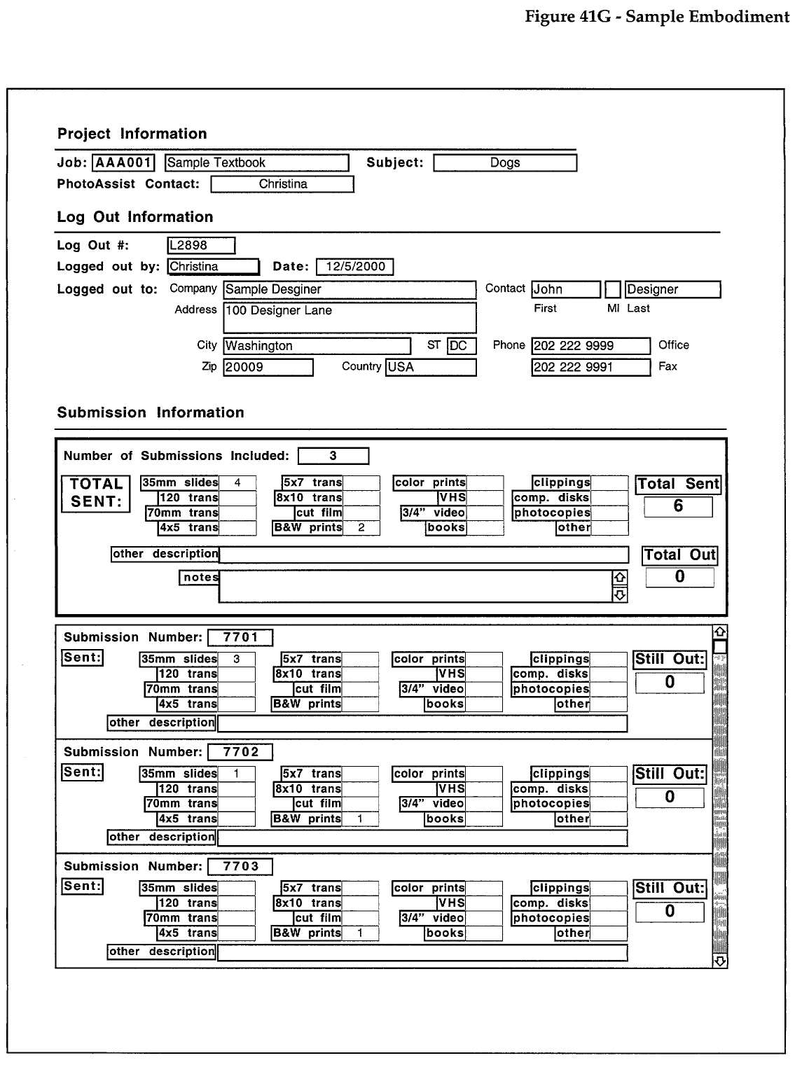

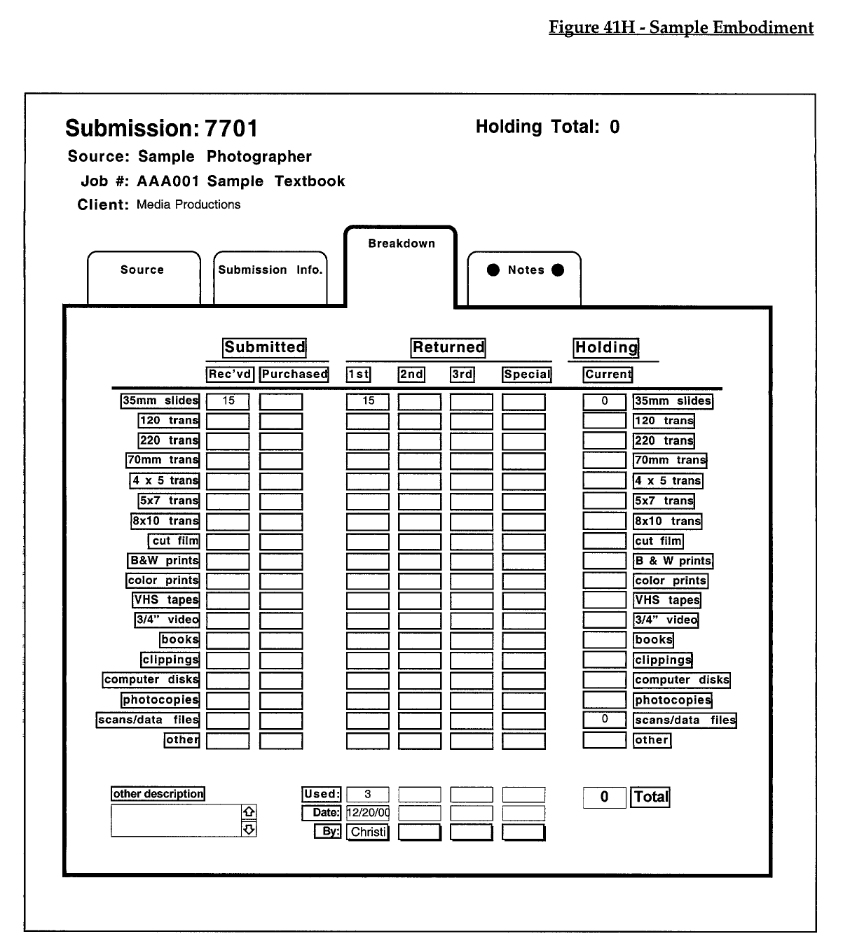

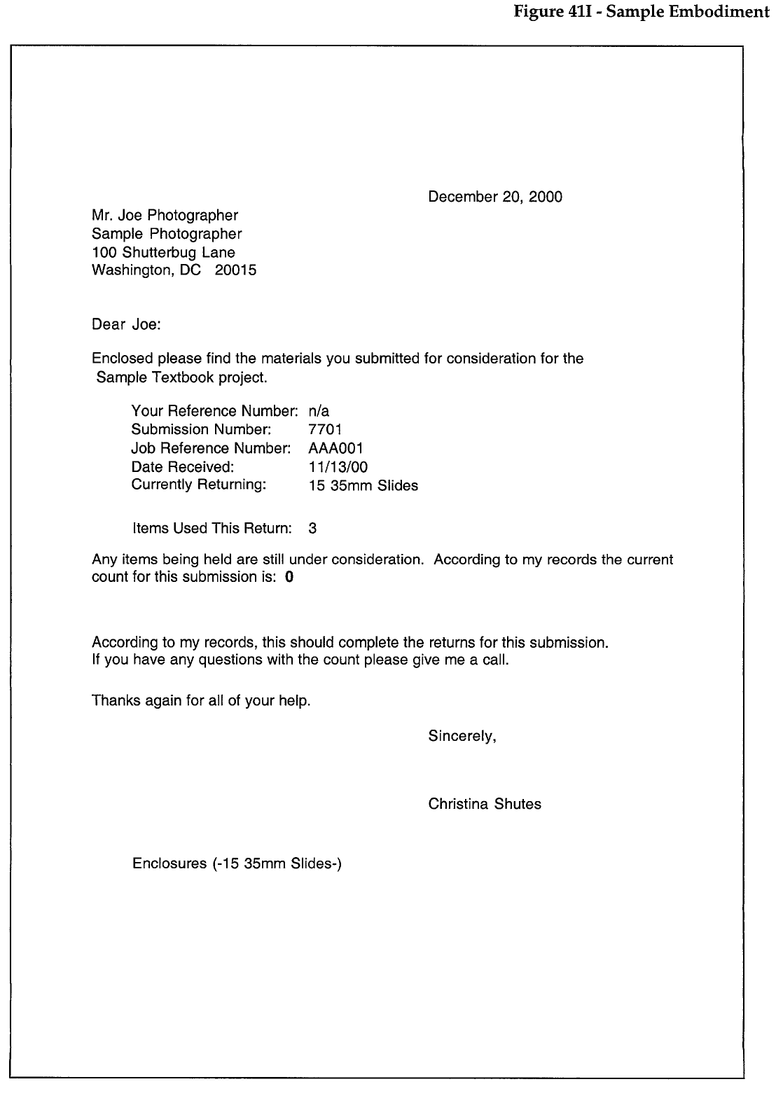

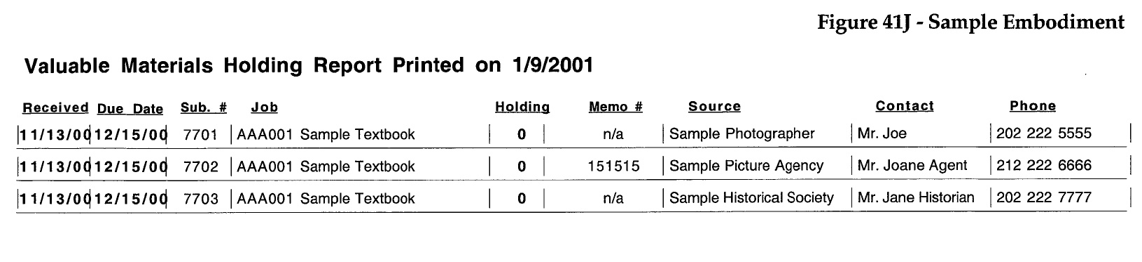

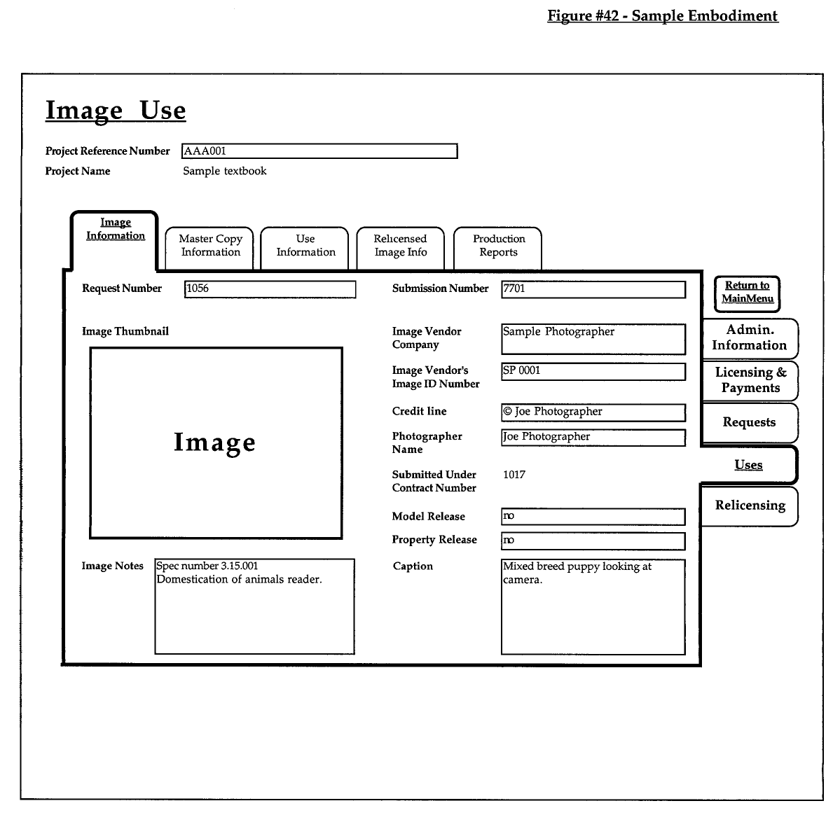

Source information, project identifiers, and a unique submission identification number for each content delivery are administered as illustrated in FIG. 41. Advantageously, the Apparatus displays project and submission information for each submission related to the same project, at the bottom of the screen. This could include project codes, project name, and the researcher who placed the request. The Apparatus also automatically displays important source and submission identification information from this screen, including the job code, project name, source name, and the submission identification number, at the top of all the other tracking system screens.

Information specific to the delivery and deadline for return of the submission is administered as illustrated in FIG. 41A. This information may optionally include the name of the person who recorded the information, the date the submission was received, the source's reference memo number, the due date for the return of the content, any extensions negotiated for the return of the content, the condition of the materials, and a credit line.

Information specific to the types of content included in the submission is administered according to FIG. 41B. The Apparatus provides a list of different content types and corresponding fields to track the number of pieces of that type of content included in the submission. Advantageously, the User can record the content counts in the “Received” column—indicating how many piece of content were sent—and can also record a count in the “Purchased” column—indicating that these materials were purchased from the source and do not need to be returned. The middle columns on the screen relate the return of content, and are filled in during that portion of the process. The final column on the screen is the holding column, and automatically displays the number of pieces of content the User is still in possession of which need to be returned to their source, sorted by content type, and totaled at the bottom of the page. (The Apparatus will automatically subtract the number of purchased images from the holding total.) The Apparatus also displays the holding total at the top of the submission tracking screens along with the project information and submission number, alerting the User of how many items from the current submission remain in her possession.

General notes regarding the submission, its content, transfers, and returns are administered as illustrated in FIG. 41C.

The Apparatus also provides an area for the User to record information relating to the transfer of the content to third parties. The transfer information is administered according to FIG. 41D. It may optionally include a unique identification number for the transfer, the contact information for the third party, the date the content is transferred, the project name and code, the content's submission identification number, the number of pieces and type of content being transferred, and a total of the number of pieces of content transferred. Because a User may wish to include content from various submission in the transfer, the transfer record allows the User the option of recording information from multiple submissions, which the Apparatus will total at the top of the section. This portion of the Apparatus will also allow the User to organize the transfer information and previously entered project information, using a template, to efficiently create a transfer cover letter, as illustrated in FIG. 41E.

The User may record data related to the return of content from a third party (hereafter referred to as the “receipt” information). The receipt information, which optionally includes the transfer identification number, the date of the return, project information, the original submission numbers, and the number of pieces and types of content returned, is administered as illustrated in FIG. 41F. Advantageously, the Apparatus combines the receipt information with previously entered information to calculate and display holding counts for the third party and for the User, as illustrated in FIG. 41G, under the Submission Information section of the screen.

When the User is ready to return the content to its source, she would administer the return information in the center columns of FIG. 41H. The Apparatus would automatically update the holding total throughout the screens of the material tracking area. Should the User wish to return the content from a submission in stages, the Apparatus advantageously allows the User to record up to four separate returns. The data for each return will be included in the calculation of holding totals. The User may also record the number of pieces of content she used, and will ultimately license, at the bottom of the screen. The Apparatus can then automatically create a return cover letter, as illustrated in FIG. 41I.

Should the User wish to review the status of groups of submissions, she may access general information related to each submission record by creating different reports within the Apparatus. For example, if a User wanted to review all of the submissions for a particular project, she could employ the Apparatus to find those records, and then sort, organize, and display them for her review, as shown in FIG. 41J. The User could also employ the Apparatus to create a similar list for all submissions with a particular deadline or from a particular Content Vendor.

Accessing the “Uses” area of the user interface, the User may optionally track detailed information specific to a single image, typically for any of the content selected for use in the design process. This may include identification information (such as background, source, content, and licensing information) specific to an image. It may also include master copy specifications, use information, and/or original use information (in the case of a re-licensed image).

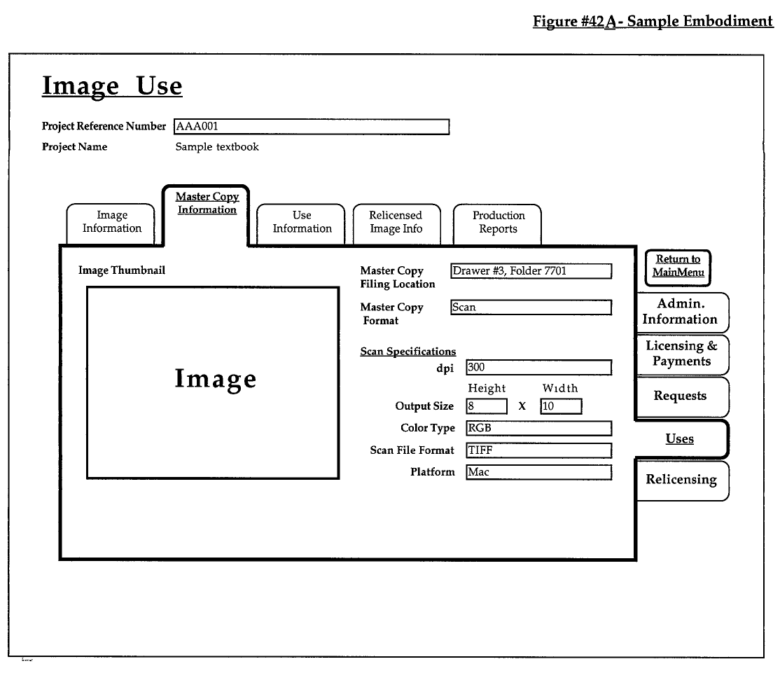

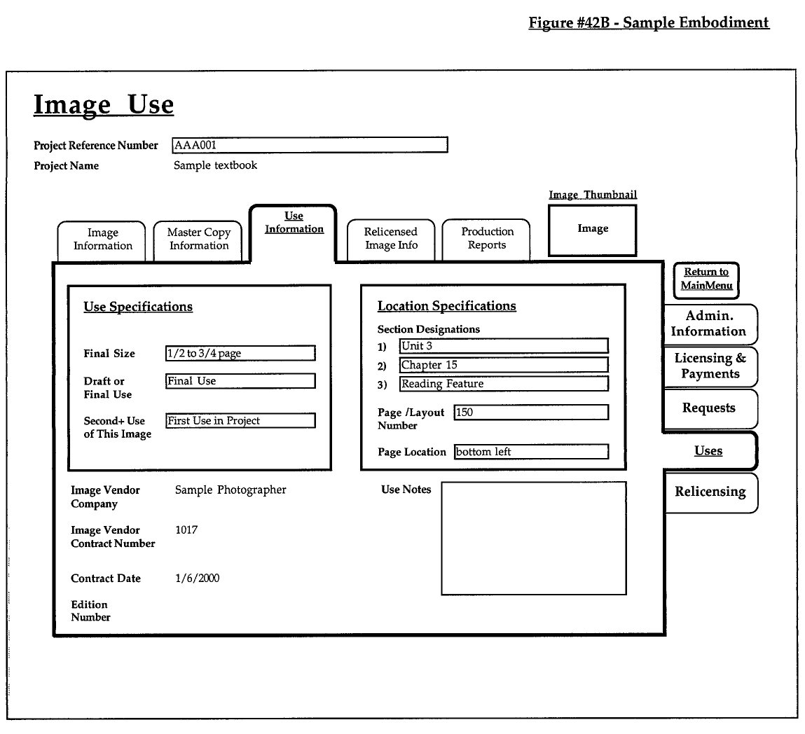

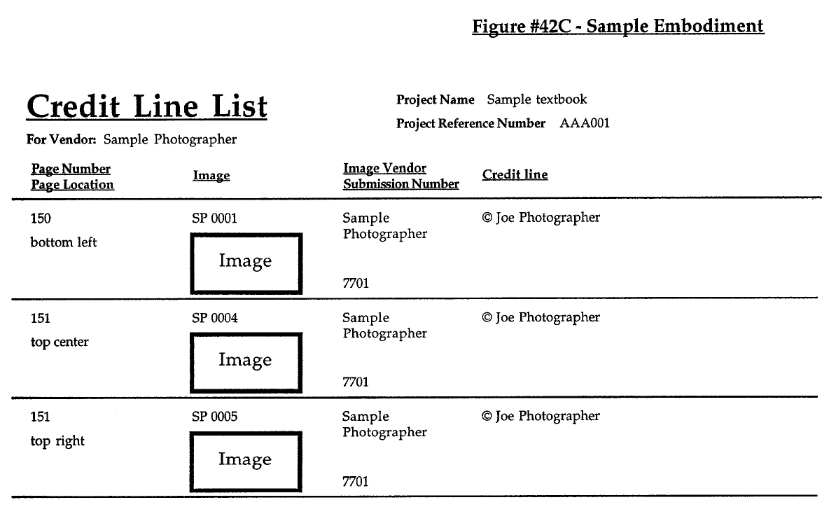

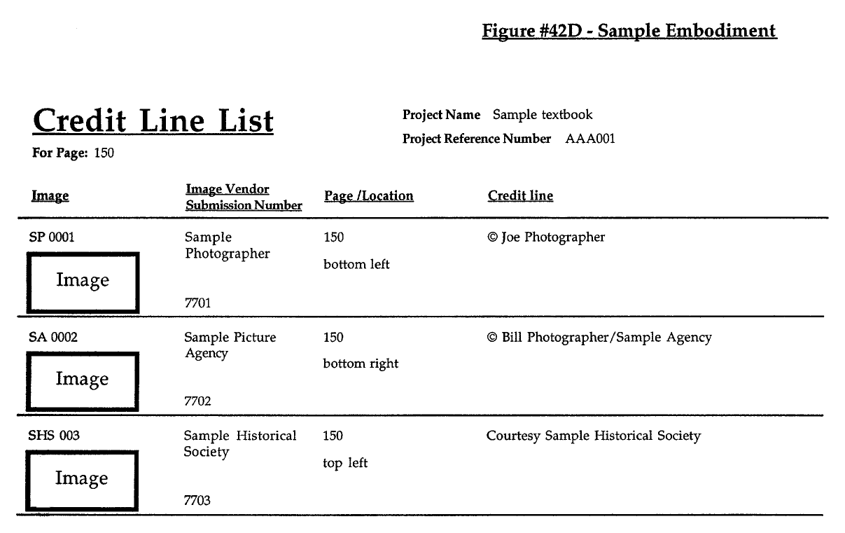

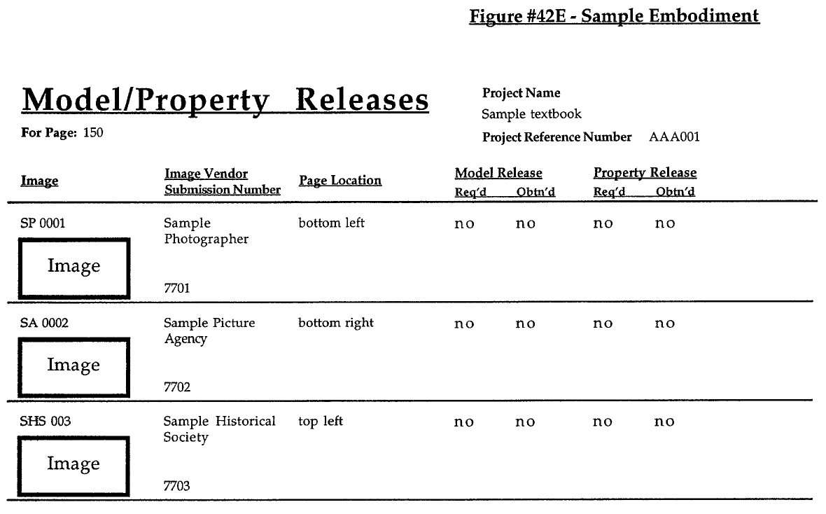

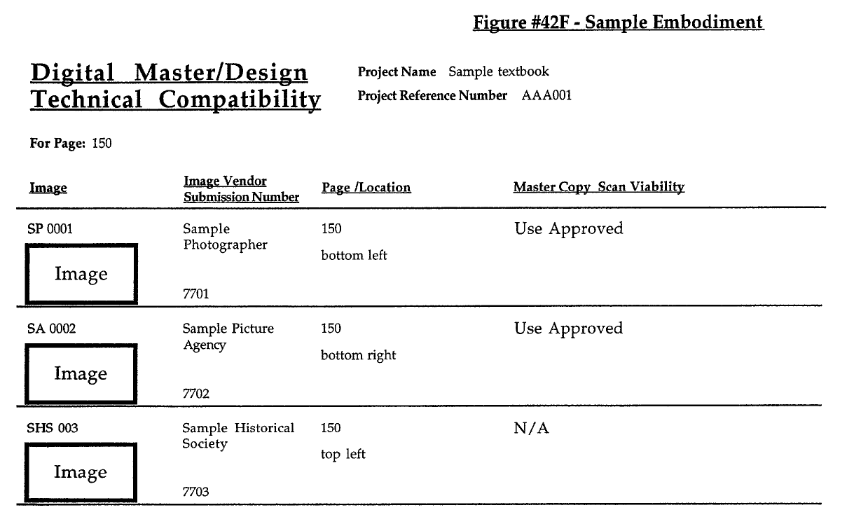

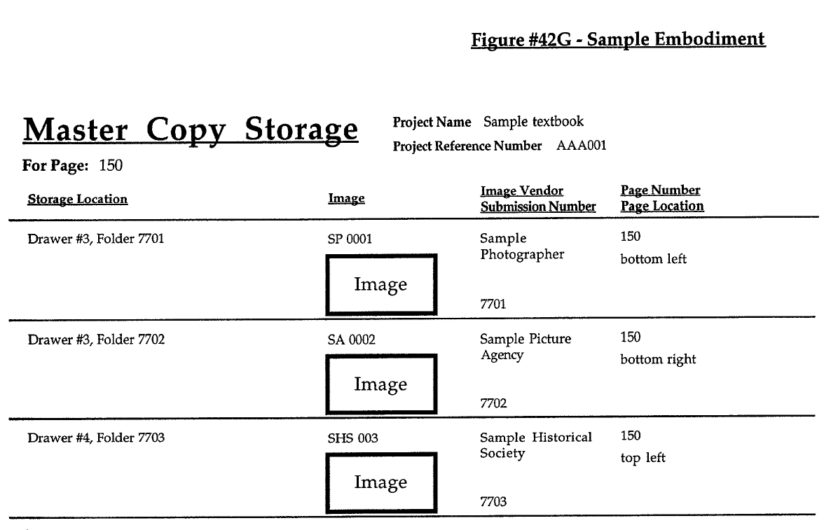

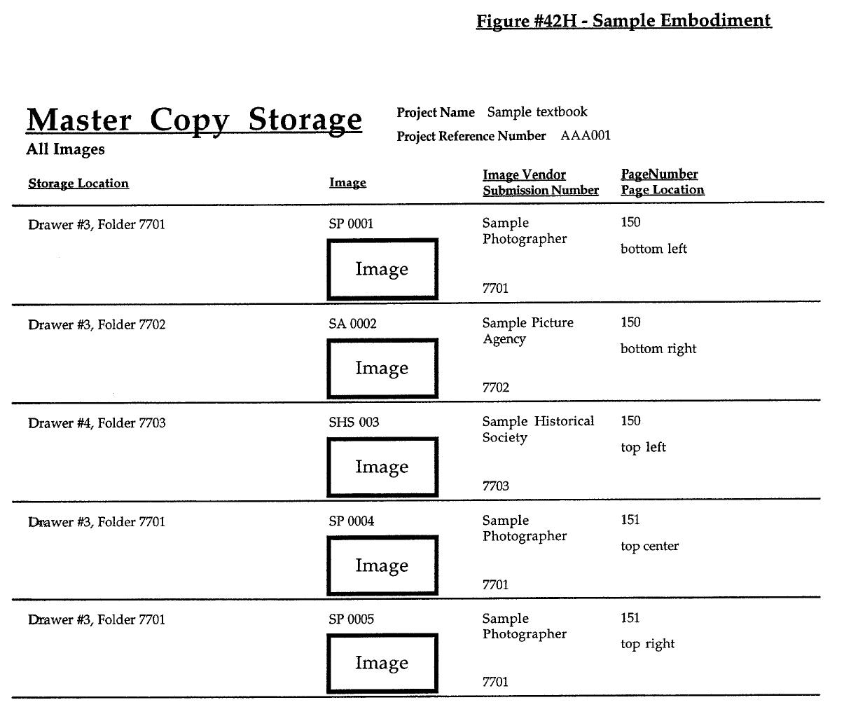

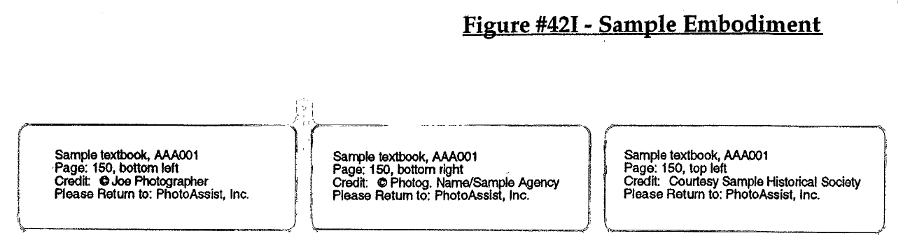

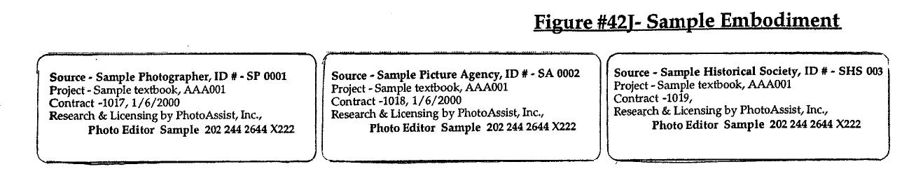

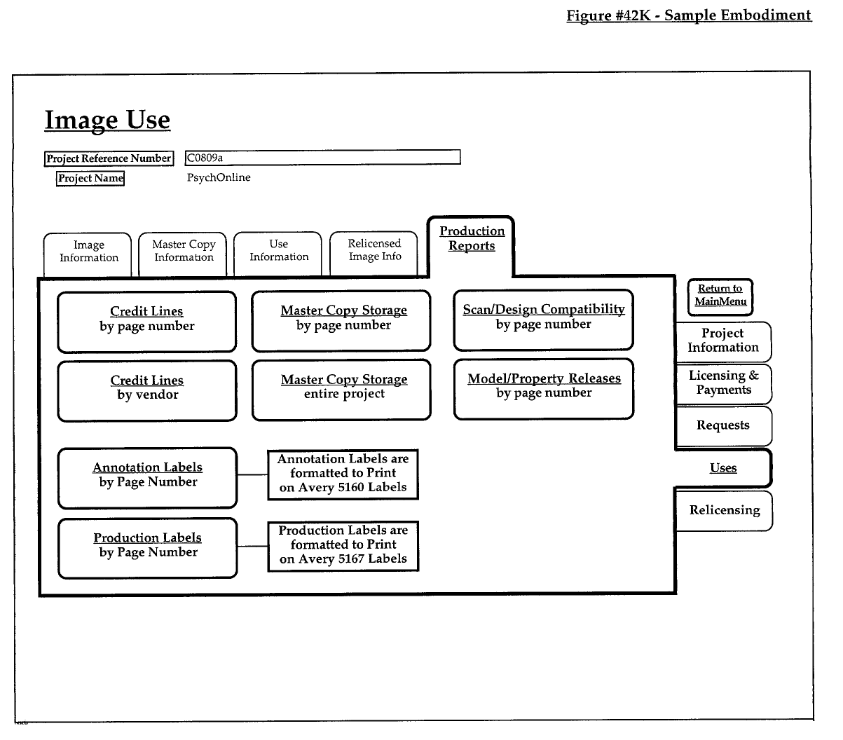

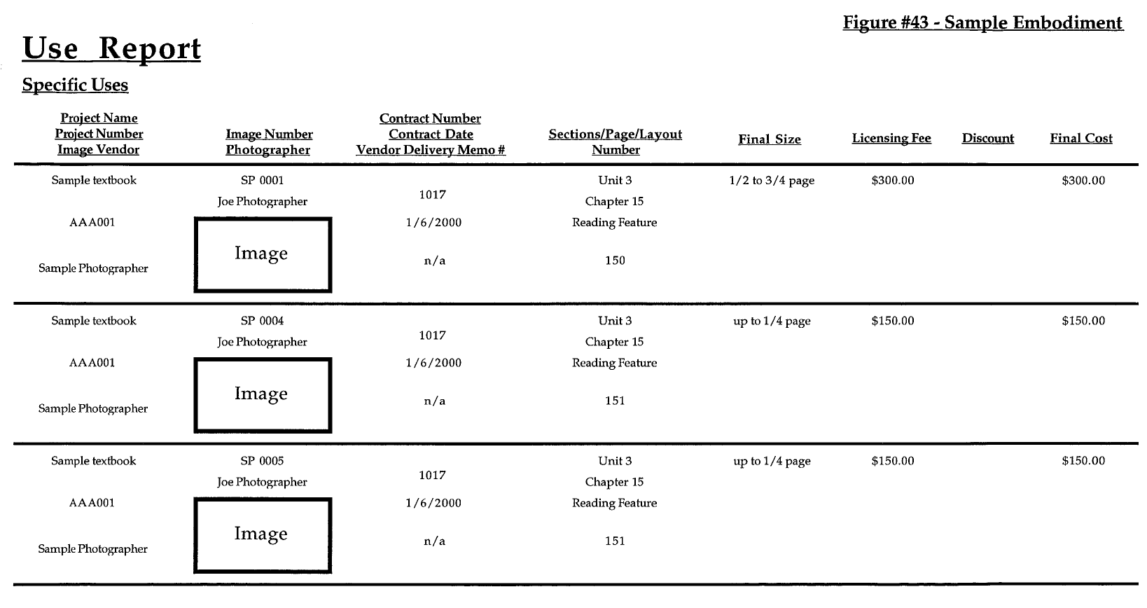

Image information, including one or more of a low resolution copy of the image/data, submission number, rental or reproduction request number, Content Vendor company, vendor identification numbers, credit lines, photographer, licensing contract number, releases, captions, and/or notes related to the image, are administered as illustrated in FIG. 42. The image copy included in the record is a low resolution copy intended for record keeping only. By storing a low resolution image file, the User minimizes the storage requirements for the file, as well as limits the potential for inappropriate use of the image. In some cases, some or all of the image information could be supplied by the Content Vendor in electronic format, so that it could simply be imported into the Apparatus.

Master copy information, including storage location, format, and technical specifications are administered according to FIG. 42A. Again, some or all of this information could be supplied by the Content Vendor in electronic format, so that it could simply be imported into the Apparatus.

The design team is then given access to the images/data. The design team creates a layout, using the software tool, Quark for example, manipulating the content as necessary. As a design is finalized, the User may import the “use information” (from a design tool, such a Quark) or record the “use information” that applies to the manipulated content in the Apparatus.

Use information is administered as illustrated in FIG. 42B. This information includes the size of the manipulated content, whether the design is a Final or Draft version, and the number of times the same piece of content has been used. Location information, such as the location of the image on the page/screen, and layout/page numbers within the design are also recorded on this screen. Advantageously, the Apparatus has three different section designations to allow the User greater flexibility in further classifying the location of the content. Information related to the contract that the image/data is to be licensed under and the Content Vendor is automatically displayed at the bottom of the screen for the User's reference. The screen also provides the User with space to record notes related to the use of the image.

At the User's option, the use information recorded in the uses area can then be organized and sorted to create various production reports. Should the User choose to create them, these reports will assist her in communicating information regarding the project's content to other members of the production team and/or a professional assembler (such as a printer or video production house). The production reports might include a list of credit lines (FIGS. 42C and 42D), to assist the User in matching the credit lines with layouts and/or images, or in creating a credit line index for the entire project.

The production reports optionally include a model/property release report (FIG. 42E), to assist the User in verifying that she has obtained all of the proper model/property permissions for the images within the project.

The production reports optionally include a digital master copy and design technical compatibility report (FIG. 42F), to assist the User in verifying that digital master copies of selected images contain enough information to print or broadcast correctly at the final use size.

The production reports optionally include a master copy storage location reports to assist the User in gathering master copies from their individual filing locations. A report can include records related to a project and page number (as illustrated in FIG. 42G) or all records within a project (as illustrated in FIG. 42H).

The production reports optionally include a list of production labels (FIG. 42I) to assist the User in labeling master copies with production information, such as an image's layout number, an image's correct credit line, and/or an image's correct project. This information helps ensure that an image is not misplaced or incorrectly used.

The production reports also optionally include a list of annotation labels (FIG. 42J) to assist the User in recording licensing information within a copy of the final product.

The Apparatus allows the User to specify the records she wishes to include in these production reports. For example, the User may wish to create a report specific to a page number or a section designation. Alternately, the User may wish to create a report for a single Content Vendor or for all of the Content Vendors used in the project. Many of these sorting functions are saved within the database as scripts, allowing the User to find and organize records by clicking on a button (FIG. 42K). By automating this process and accessing previously entered information, the User is able to save substantial amounts of time creating production reports.

The use information recorded in the use area is also employed by the Apparatus to generate a series of reports to assist the User with the final steps in the licensing process.

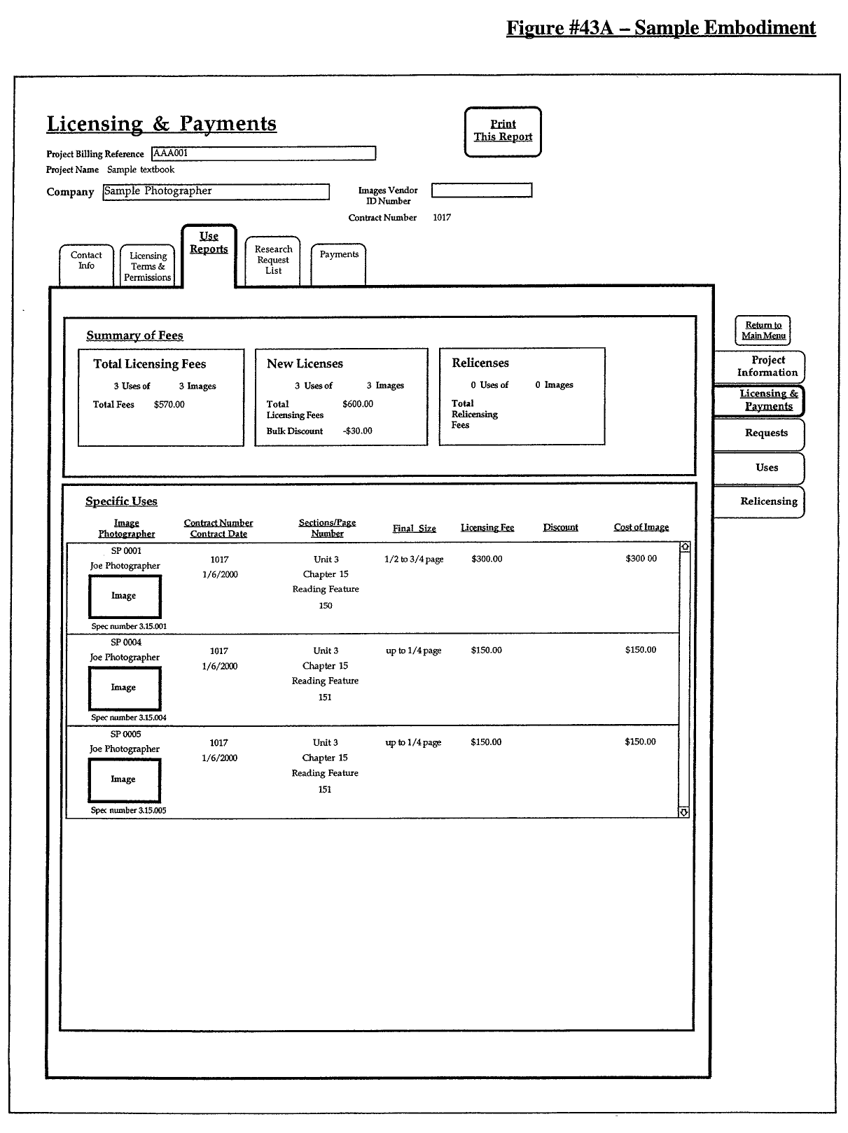

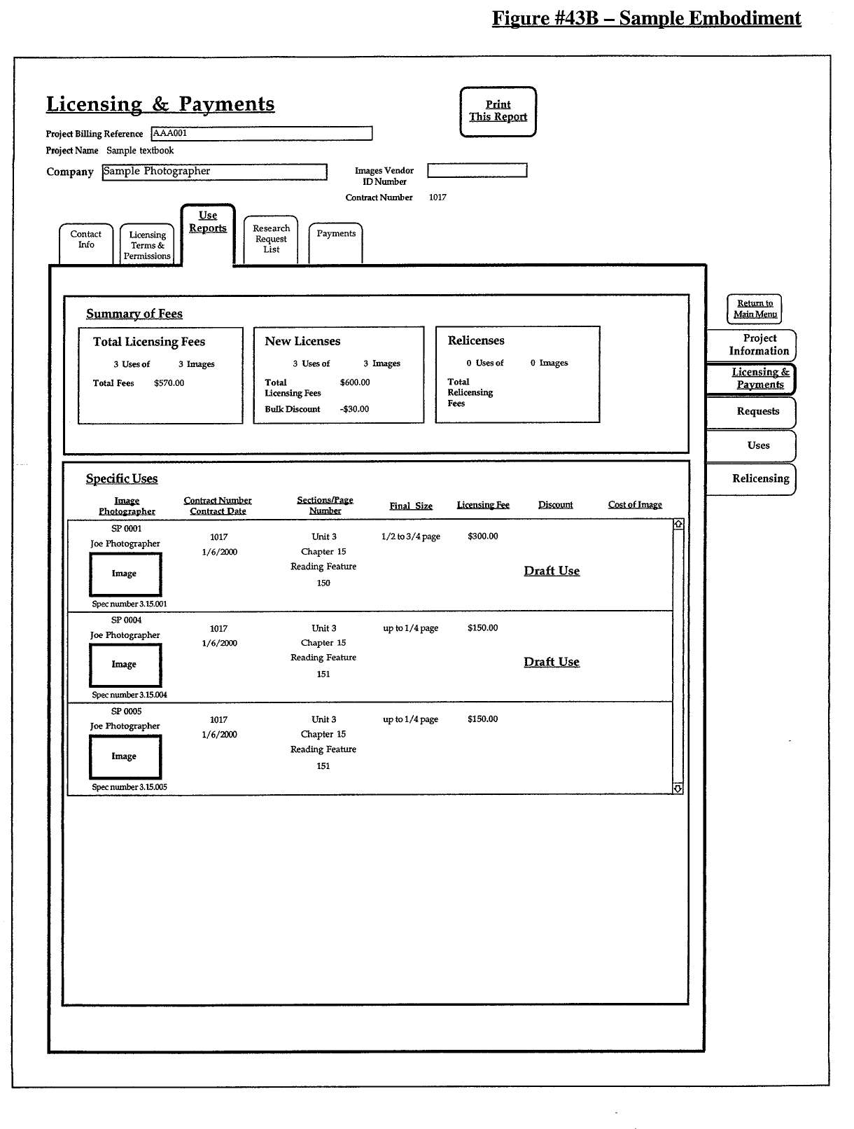

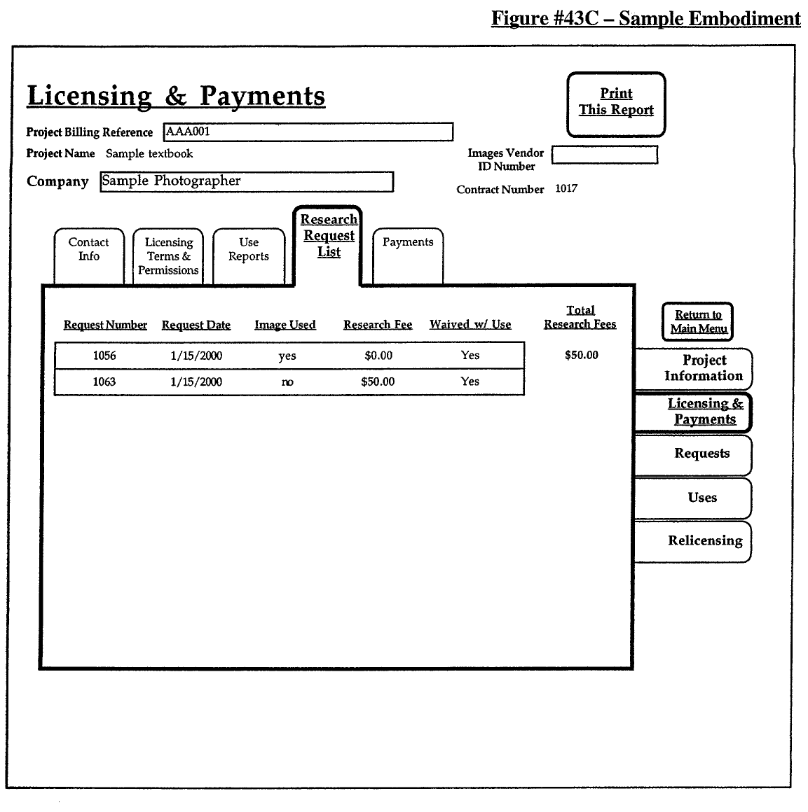

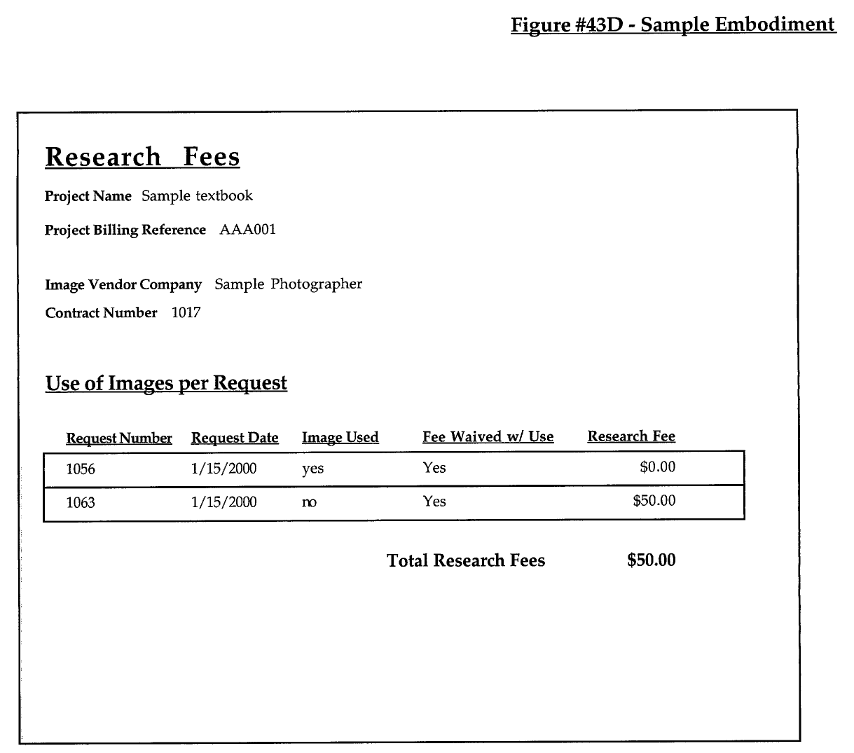

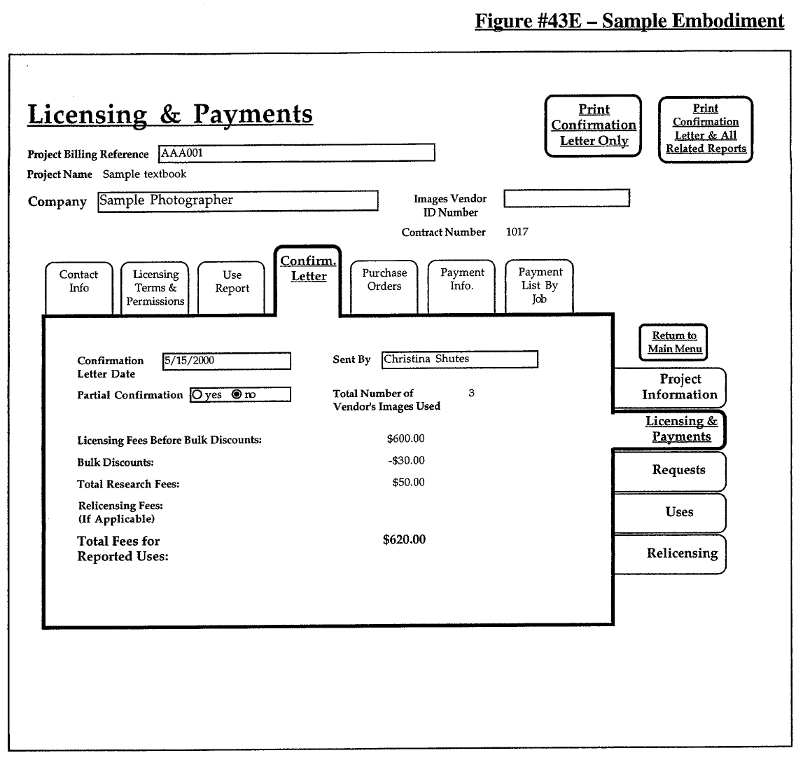

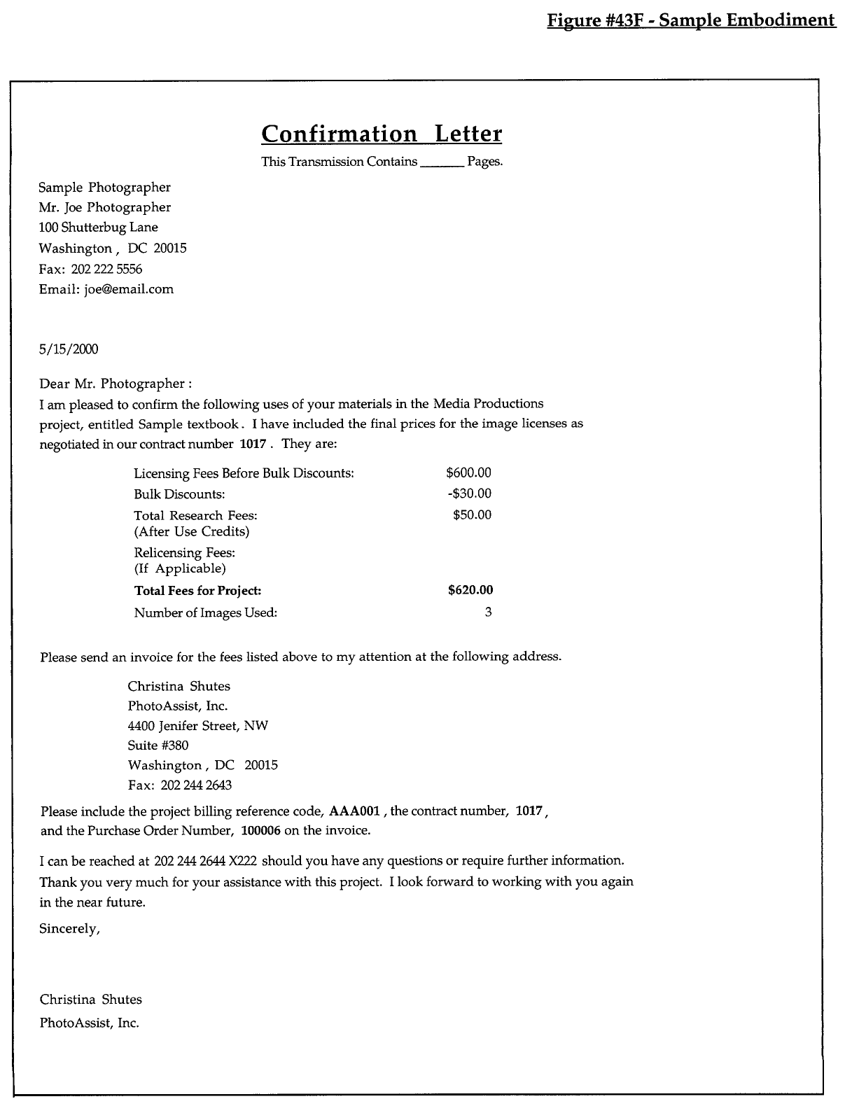

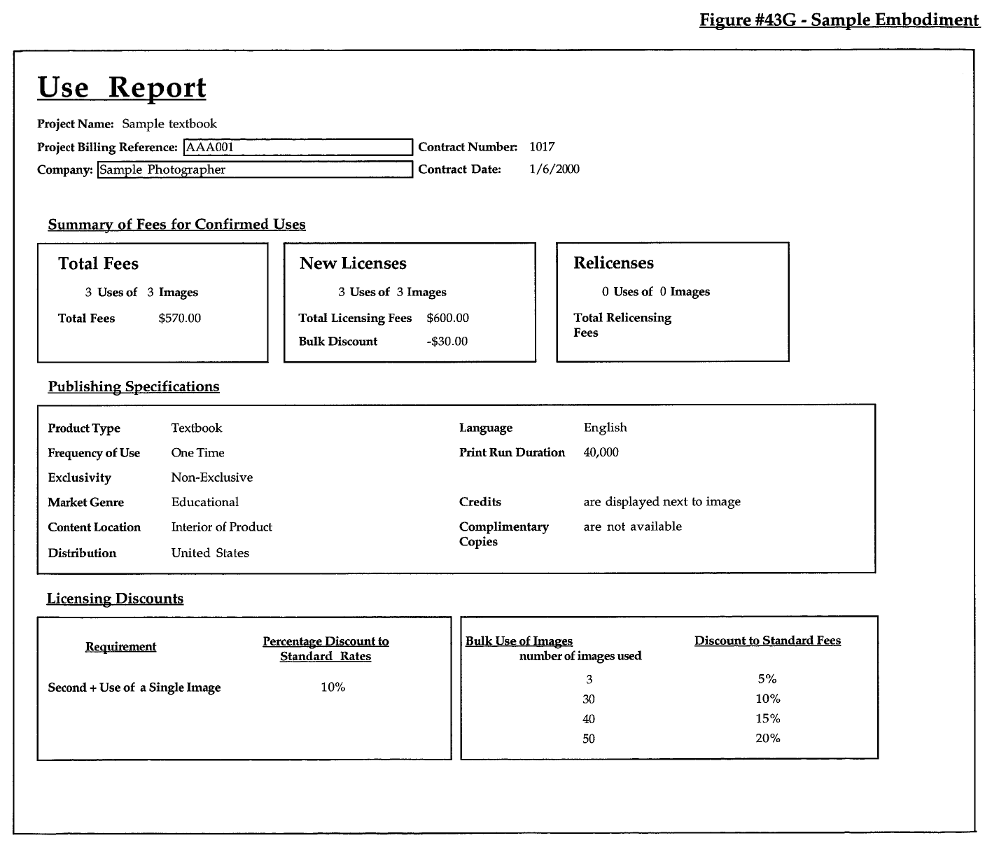

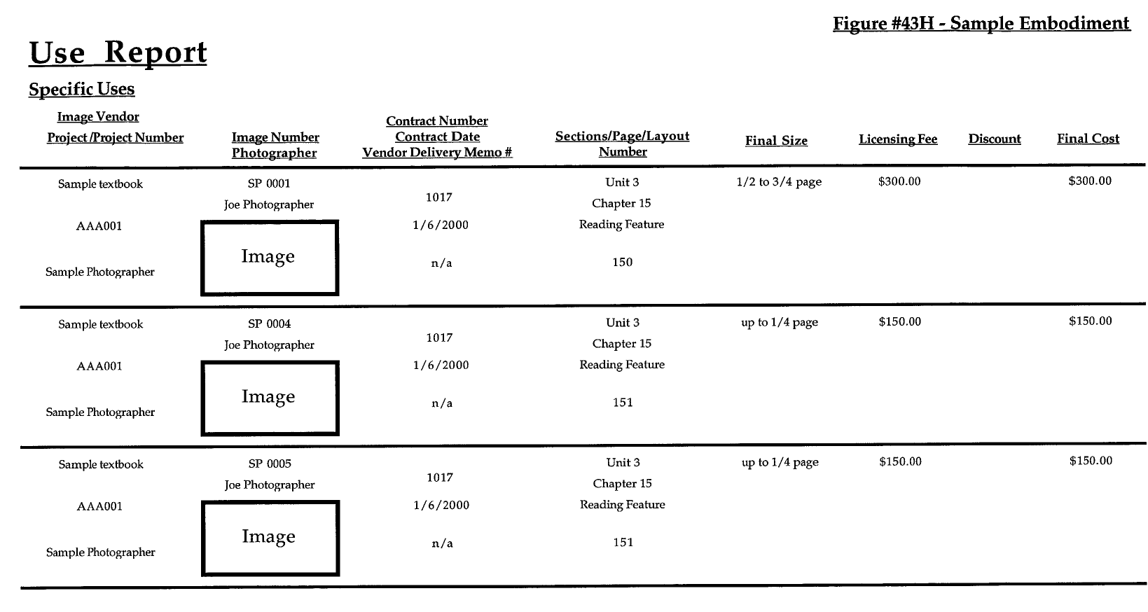

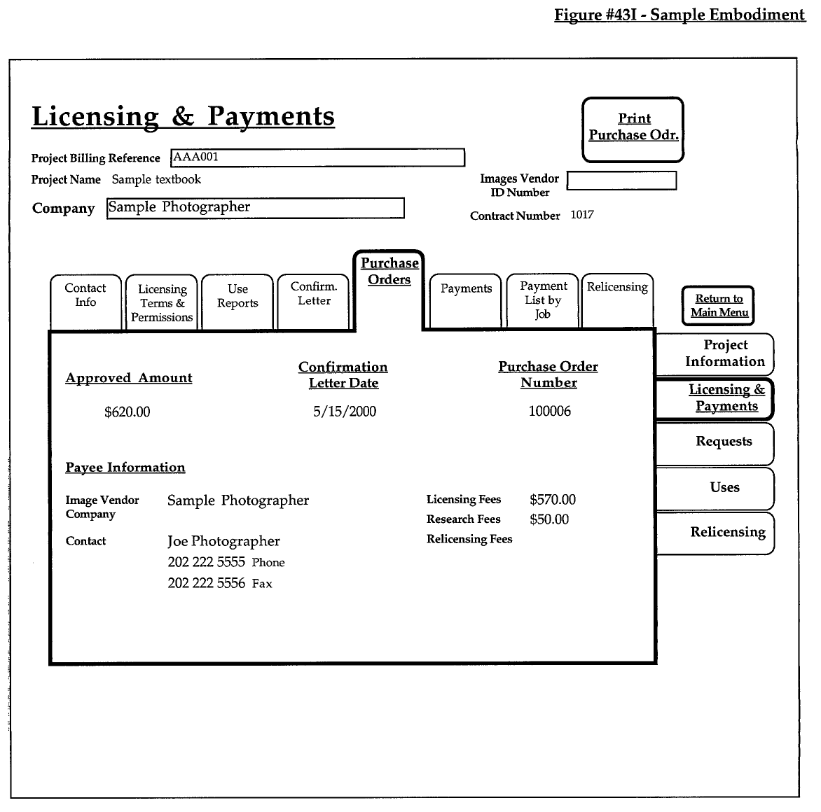

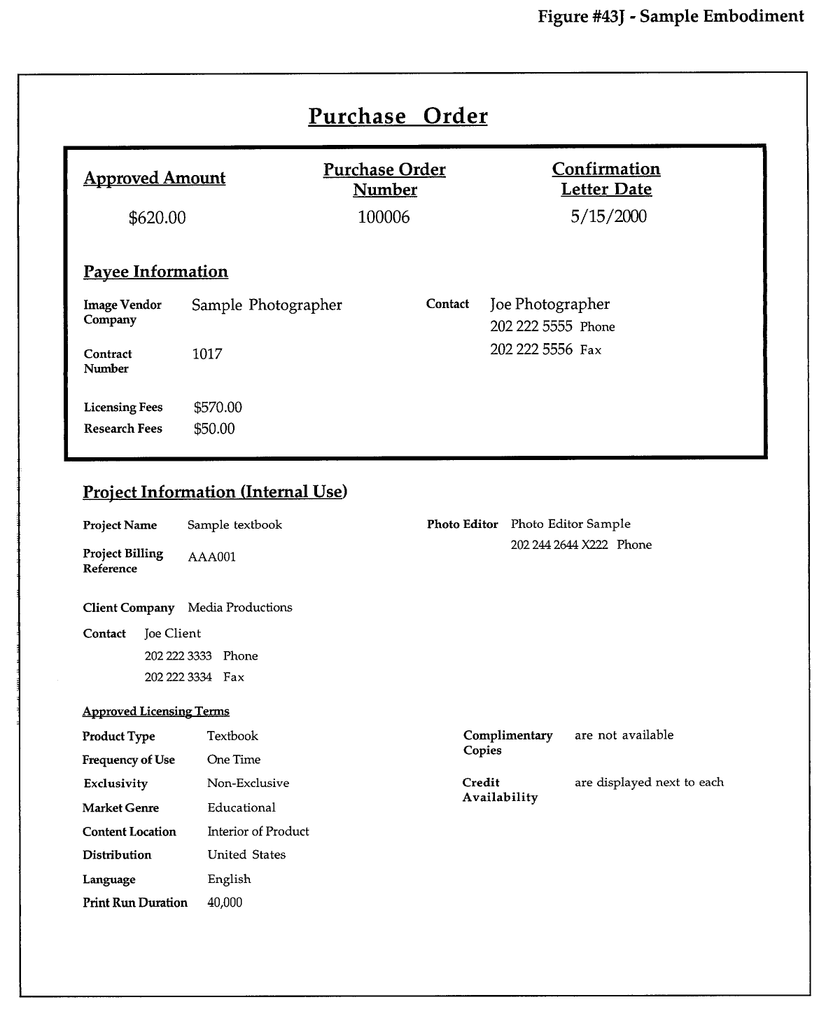

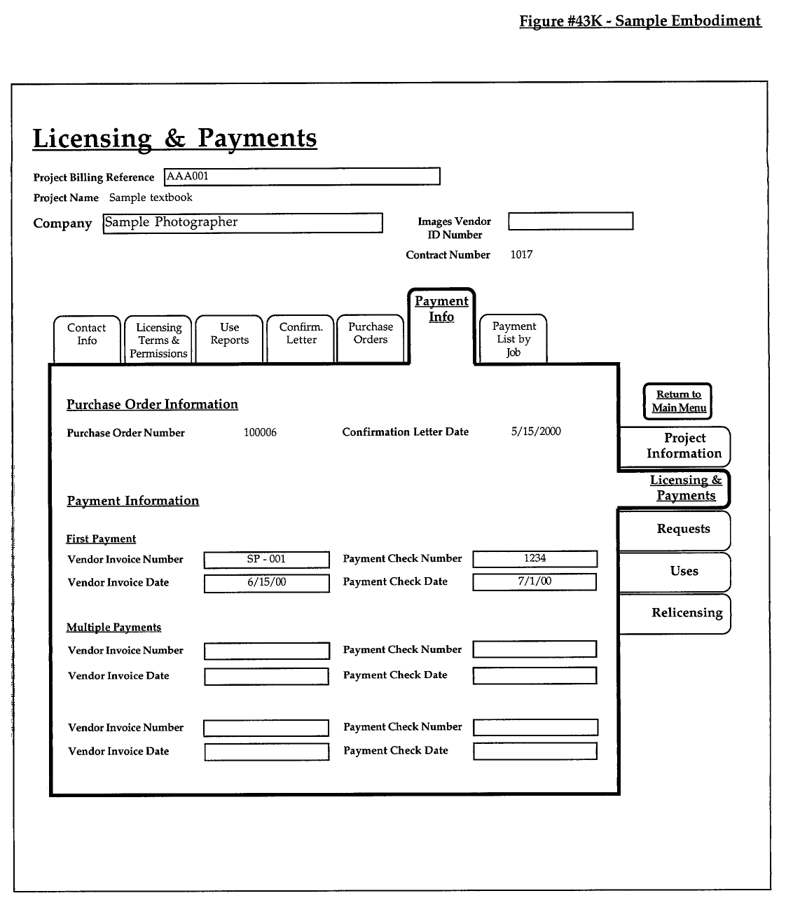

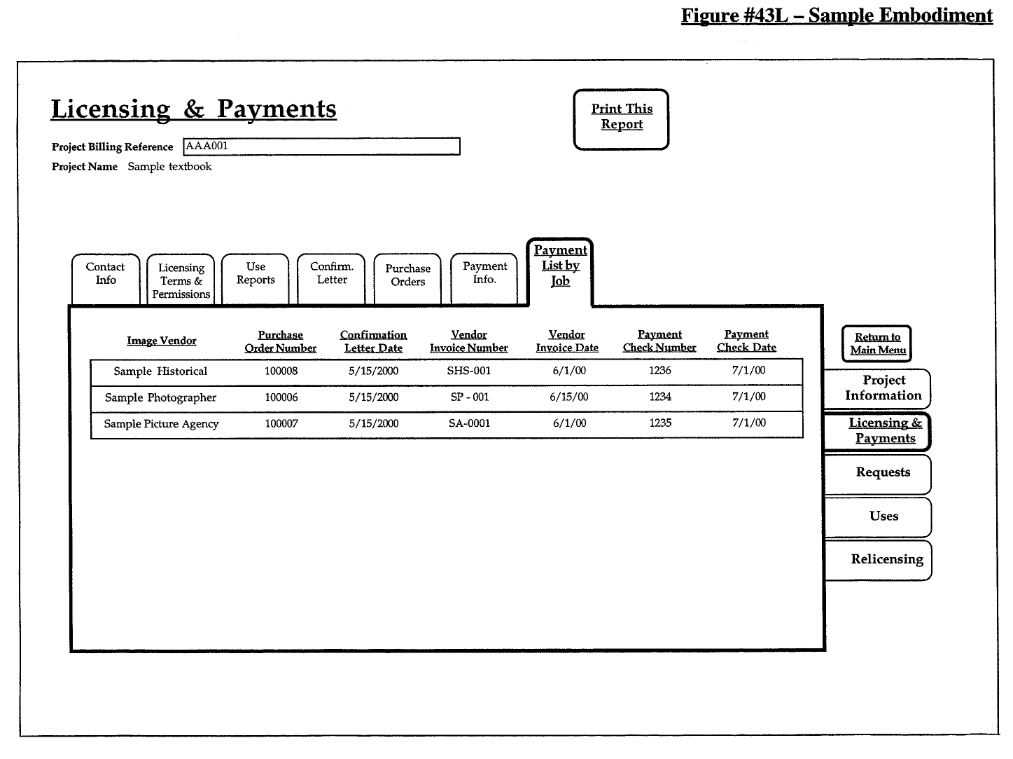

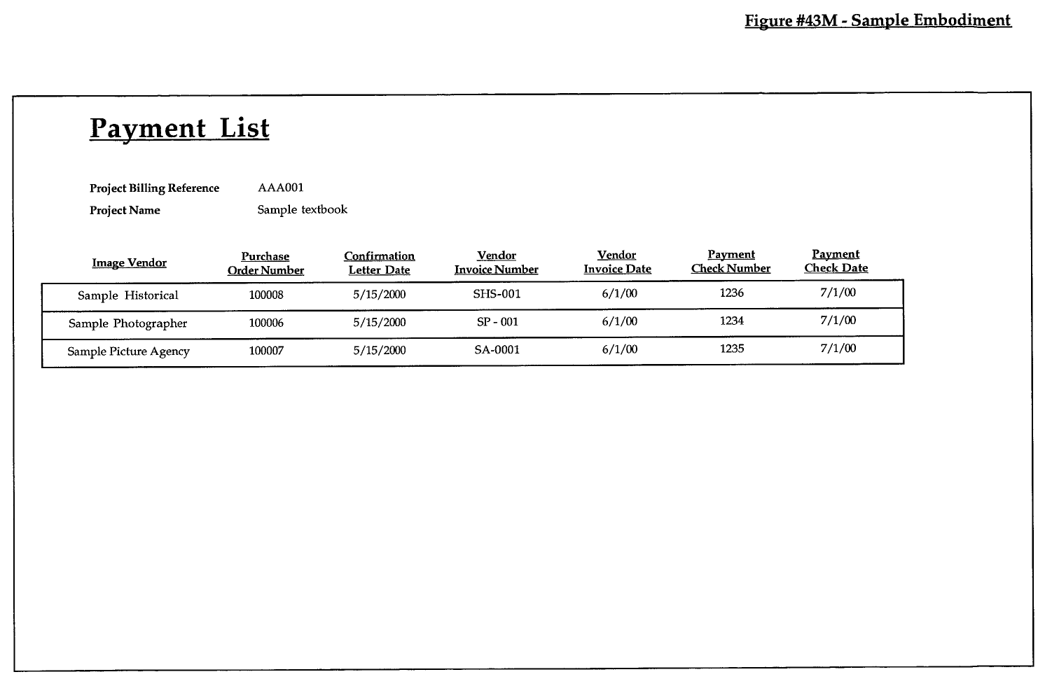

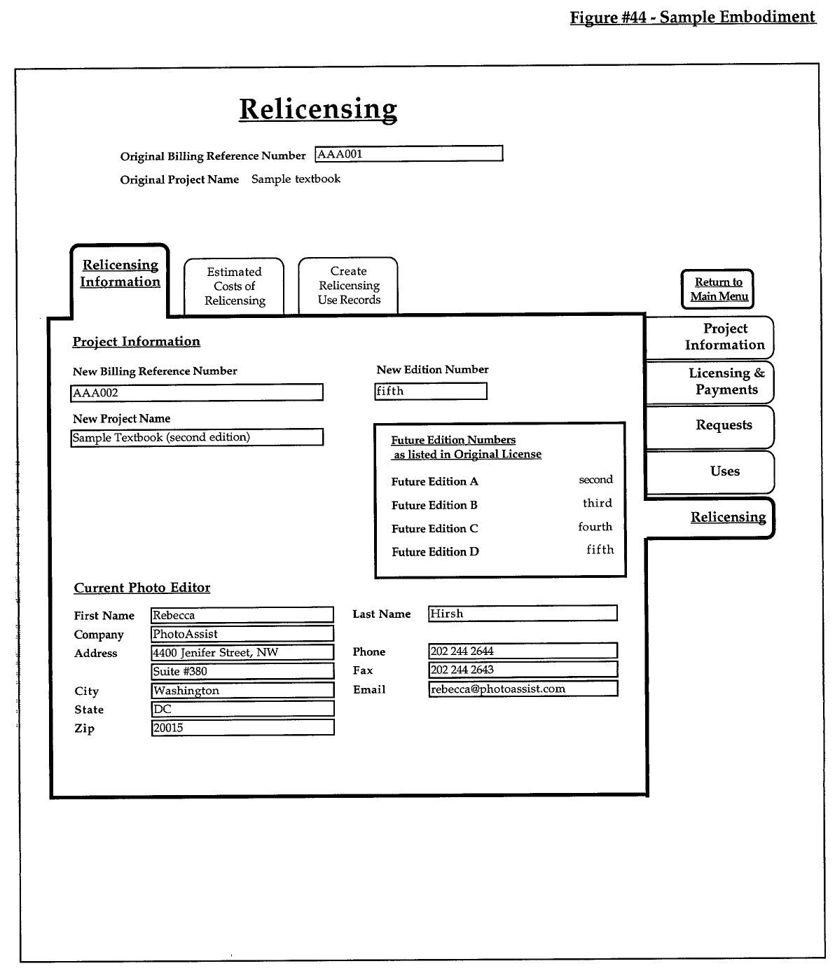

The Use Reports access the information recorded in the uses area of the user interface, automatically matching it with the previously entered licensing terms and project information. The Use Reports list the project name, project billing reference number, Content Vendor, image number, photographer, image thumbnail, contract number, contract date, submission delivery memo number, section and page designations, final use size, licensing fee, appropriate discounts, and final cost of the image/data. The Use Reports can be organized and/or sorted by image vendor, layout number, or section designation, and are then organized into a report format, as illustrated in FIG. 43. When combined with other use records within the Apparatus, the Use Reports can calculate a count of the number of images used from a particular Content Vendor, and the appropriate bulk discounts, as illustrated in FIG. 43A. Advantageously, the use information can be easily changed and/or reorganized, and can be labeled as a draft or final version. This allows the User the flexibility to create draft reports, which are labeled as such (FIG. 43B), to quickly and efficiently determine if particular design drafts meet her budget.

Should the User wish to review the research fees that are associated with the vendor's use report, she may click on the tab at the top of the screen. The Apparatus will then locate, organize, and display a list of all the research fee information associated with the Content Vendor for the project, as illustrated in FIG. 43C. The Apparatus will also provide a hard copy of the research fee list, as illustrated in FIG. 43D.

Confirmation letters, created and sent by the User to the Content Vendor, confirm which pieces of content were used in the project. In addition, the confirmation letter establishes which of the licensing terms previously negotiated apply to the final use of the content, and may also include instructions for the vendor to submit an invoice or other compliance request.

Confirmation letter data is administered according to FIG. 43E, and includes the letter date and the name of the User. Licensing fees for the Content Vendor are automatically displayed at the bottom of the screen for the User's reference. The Apparatus then organizes the confirmation letter information and previously entered information using a template to create the document (FIG. 43F). This previously entered information might include contract numbers, project information, the final costs for licensing fees, research fees, and bulk discounts. The User would thereby save all the time necessary to create the confirmation letters from scratch. The User would then convey the confirmation letter to the Content Vendor. She may wish to include additional documents with the confirmation letter, for example a summary of the publishing specifications and discounts, and the use report, as illustrated in FIGS. 43G-43H.

At the User's option, she might also employ the Apparatus to create purchase orders or other forms to assist her accounting process, as illustrated in FIG. 43I and printed in FIG. 43J. Again, the Apparatus optionally utilizes previously entered information and a template to organize the data and create the accounting forms. The Apparatus likewise optionally records any accounting codes from this form, such as a Purchase Order number, into the confirmation letter, thereby conveying the same information to both parties.

Information related to the payment of licensing fees is administered according to FIG. 43K. The Apparatus allows the User to record Content Vendors' invoice numbers and dates, as well as licensing payment check numbers and payment dates. The Apparatus also allows the User the option of recording multiple payments, should that be necessary.

Should the User wish to review the payments for an entire project, she may combine the payment information she entered with previously entered use information, to create a report of payments for the job. An example of this type of report is illustrated in FIG. 43L. This report will allow the User to, at a glance, confirm that all payments for a project have been made or determine which payments are outstanding. The Apparatus could also produce a hard copy of the report, as illustrated in FIG. 43M.

The present invention also includes the feature to arrange for re-licensing of the content/data, in an efficient manner, at a future date. That is, the present invention optionally permits the User to concurrently license future uses of the data, and/or set up the license to be reviewed at a later time for future uses. For example, a User licenses the content for the first edition of a book. Two years later, the User wishes to re-license the same book, or a portion of the same book, for a second edition.

Currently, the practice is for the User to begin the licensing process all over again for the second edition. This requires the User to re-record licensing information and repeat the licensing steps completed for the first edition. The current invention offers the User a more efficient way to re-license a project. Advantageously, the current invention also allows the User to combine new and re-licensed content within the project records, while still linking them to their proper licensing terms.

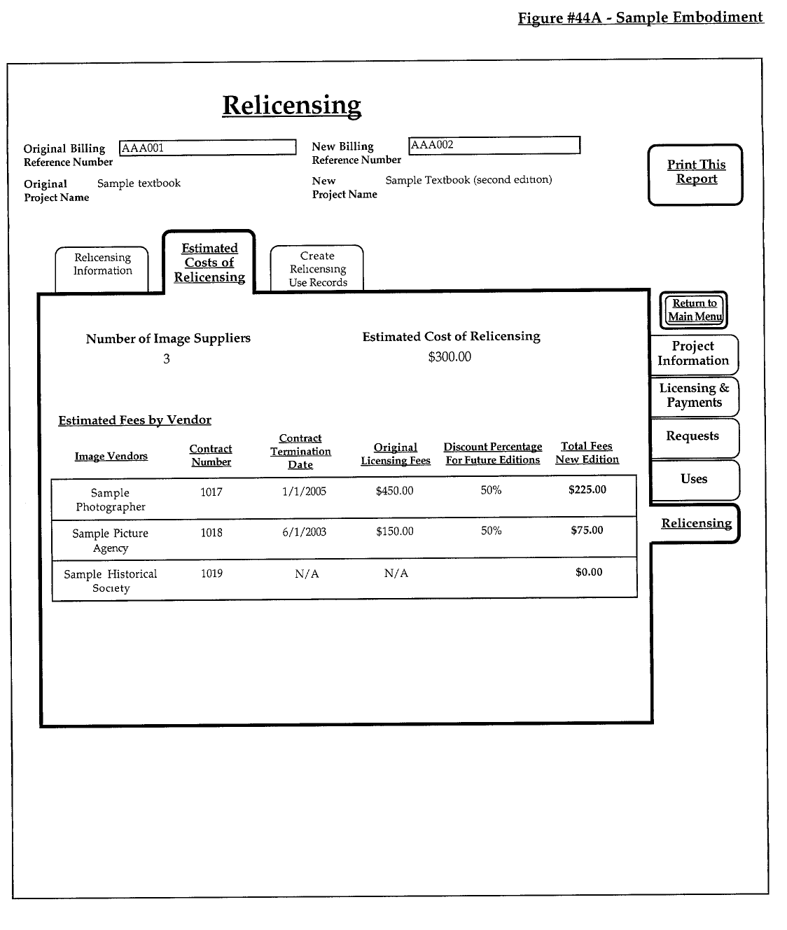

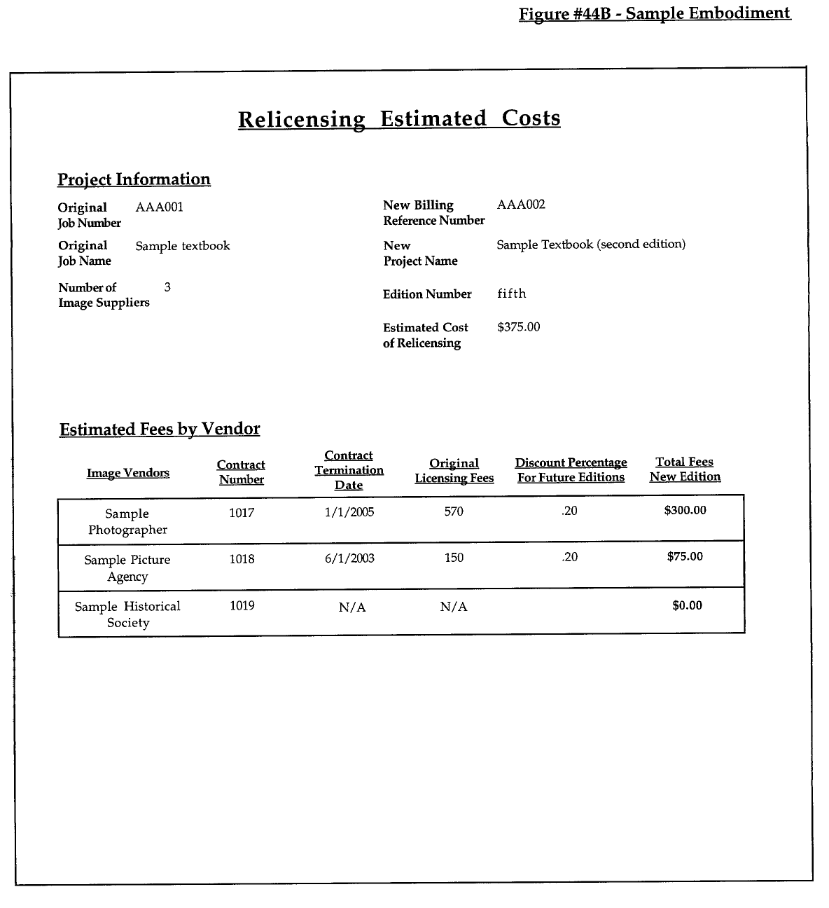

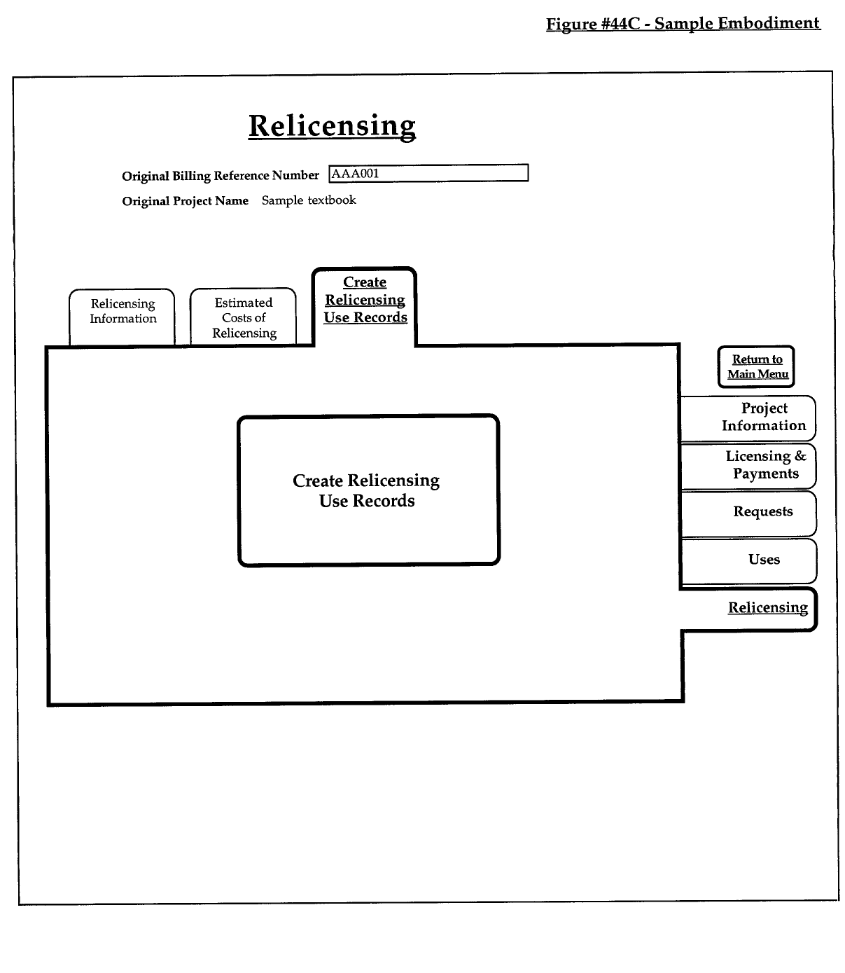

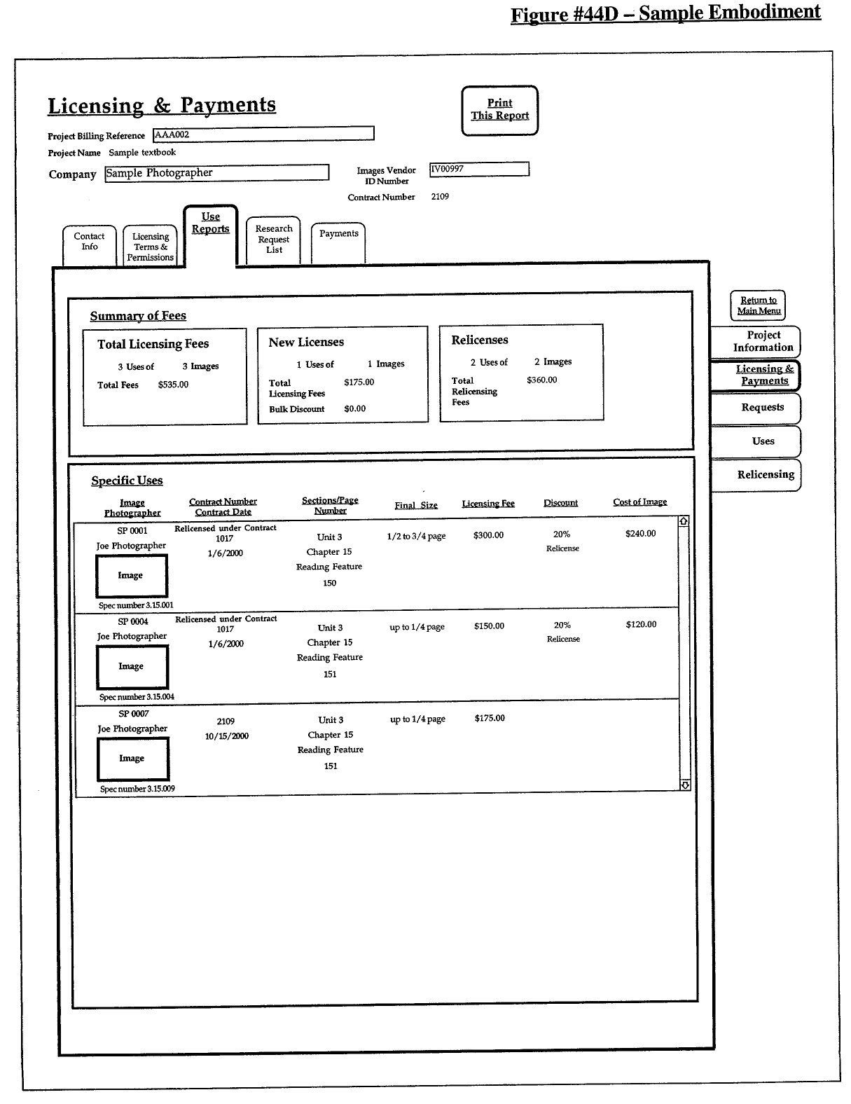

First, the User creates new project information records for the new edition using new tracking fields. She then proceeds to the re-licensing area of the Apparatus, and enters the new edition number and the tracking fields for both the original edition and the re-licensed edition, as outlined in FIG. 44. This screen also allows the User to view the future edition numbers for which she has already negotiated rates. It also allows the User to enter new User contact information, in case the re-licensing User and the original User are not the same person.

The Apparatus automatically matches licensing terns and use information from the original project to create a re-licensing estimate based on previous licensing fees. An example of this is illustrated in FIG. 44A. This estimate could display a count of the number of Content Vendors used in the project and a list of the individual Content Vendors' names, their associated contract numbers for the original edition, original edition licensing fees, re-licensing discounts, and licensing fees for the new edition.

The Apparatus also produces a printable copy of the estimate, as illustrated in FIG. 44B. The Apparatus optionally also automates the creation of use records for the re-licensed images, or for a subset of the re-licensed images, using a script process. The script, as illustrated in FIG. 44C, appears as a button on the screen. It sorts and organizes the original edition use records, or subsets of those records, duplicates them, marks the records as re-licensed from another project, and marks them with the new edition tracking fields. Once created and marked as re-licensed images, the Apparatus will match these use records with their original licensing terms, while still sorting and organizing them as part of the new edition records. Thereafter, the re-licensed use records can be incorporated into any of the reports, lists, and documents for the new edition while still displaying licensing terms for their original contract. For example, the Use Report in FIG. 44D shows both new images and re-licensed images used in the new edition. The re-licensed images are noted as such above the contract number within each individual use record. The number of re-licensed images and the total re-licensing fees are organized separately from first licenses at the top of the page.

By negotiating and tracking future edition rates, automating the creation of all or some of the re-licensing use records, and incorporating the re-licensed use records into the reports, lists, and documents created by the Apparatus, the User can substantially reduce the amount of time necessary to effectively re-license a new edition of a project. In addition, the process allows the User to effectively estimate the licensing costs for future editions of the project. A similar process is also available for expanding the rights of a particular project, such as adding an additional language to the publishing specifications.

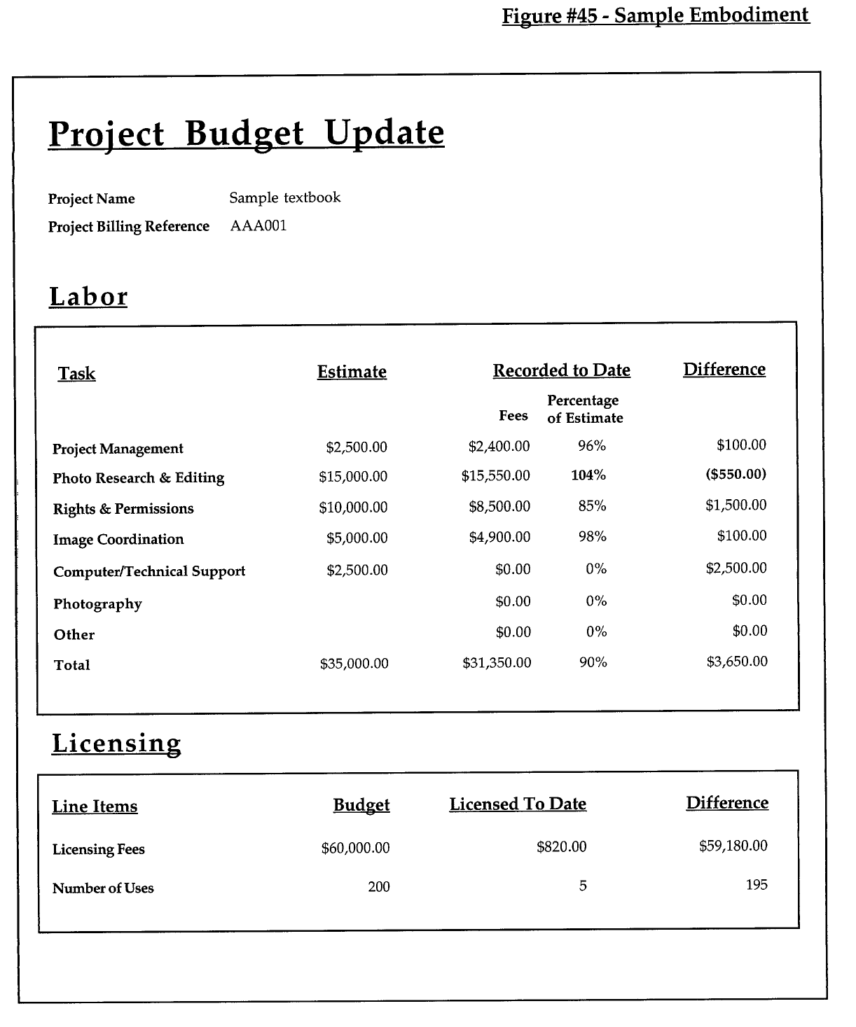

Finally, the User may wish to access final records to assist her in reviewing and analyzing the licensing and labor costs of the project or comparing the licensing and labor costs of many projects. (The User may input additional information regarding labor costs into the Apparatus to include this information in the reports.) She might employ the Apparatus to sort, organize, manipulate, and display labor and licensing information in a report form for a single project, such as FIG. 45. She might employ the Apparatus to sort, organize, manipulate, and display labor and licensing information in a report form for a group of projects, such as FIG. 45A. Additionally, she may wish to use old project records to assist her in estimating costs for future projects.

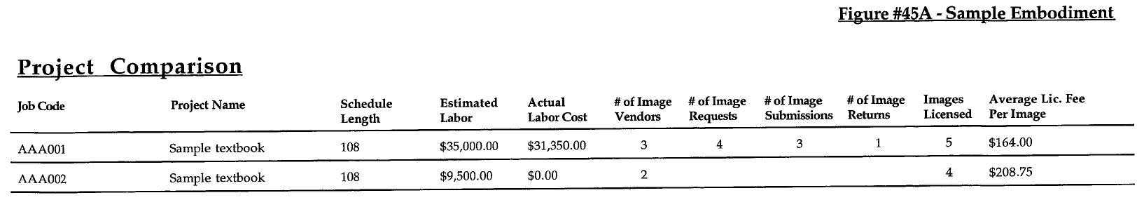

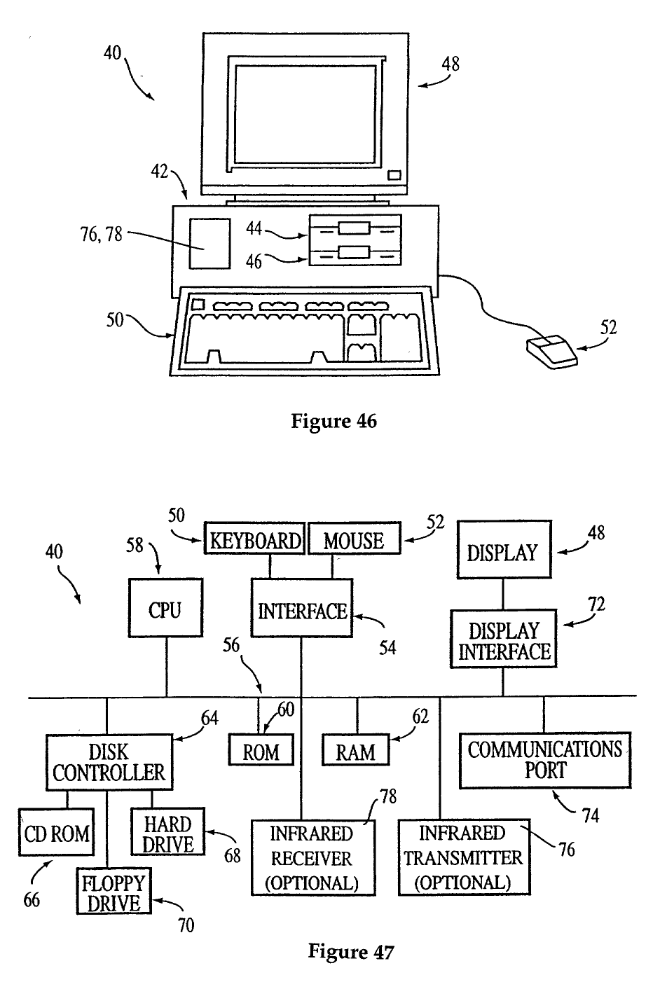

FIG. 46 is an illustration of a main central processing unit for implementing the computer processing in accordance with a computer implemented embodiment of the present invention. The procedures described above may be presented in terms of program procedures executed on, for example, a computer or network of computers.

Viewed externally in FIG. 46, a computer system designated by reference numeral 40 has a central processing unit 42 having disk drives 44 and 46. Disk drive indications 44 and 46 are merely symbolic of a number of disk drives which might be accommodated by the computer system. Typically these would include a floppy disk drive such as 44, a hard disk drive (not shown externally) and a CD ROM indicated by slot 46. The number and type of drives varies, typically with different computer configurations. Disk drives 44 and 46 are in fact optional, and for space considerations, may easily be omitted from the computer system used in conjunction with the production process/Apparatus described herein.

The computer also has an optional display 48 upon which information is displayed. In some situations, a keyboard 50 and a mouse 52 may be provided as input devices to interface with the central processing unit 42. Then again, for enhanced portability, the keyboard 50 may be either a limited function keyboard or omitted in its entirety. In addition, mouse 52 may be a touch pad control device, or a track ball device, or even omitted in its entirety as well. In addition, the computer system also optionally includes at least one infrared transmitter 76 and/or infrared receiver 78 for either transmitting and/or receiving infrared signals, as described below.

FIG. 47 illustrates a block diagram of the internal hardware of the computer of FIG. 46. A bus 56 serves as the main information highway interconnecting the other components of the computer. CPU 58 is the central processing unit of the system, performing calculations and logic operations required to execute a program. Read only memory (ROM) 60 and random access memory (RAM) 62 constitute the main memory of the computer. Disk controller 64 interfaces one or more disk drives to the system bus 56. These disk drives may be floppy disk drives such as 70, or CD ROM or DVD (digital video disks) drive such as 66, or internal or external hard drives 68. As indicated previously, these various disk drives and disk controllers are optional devices.

A display interface 72 interfaces display 48 and permits information from the bus 56 to be displayed on the display 48. Again as indicated, display 48 is also an optional accessory. For example, display 48 could be substituted or omitted. Communication with external devices, for example, the components of the Apparatus described herein, occurs utilizing communication port 74. For example, optical fibers and/or electrical cables and/or conductors and/or optical communication (e.g., infrared, and the like) and/or wireless communication (e.g., radio frequency (RF), and the like) can be used as the transport medium between the external devices and communication port 74.

In addition to the standard components of the computer, the computer also optionally includes at least one of infrared transmitter 76 or infrared receiver 78. Infrared transmitter 76 is utilized when the computer system is used in conjunction with one or more of the processing components/stations that transmits/receives data via infrared signal transmission.

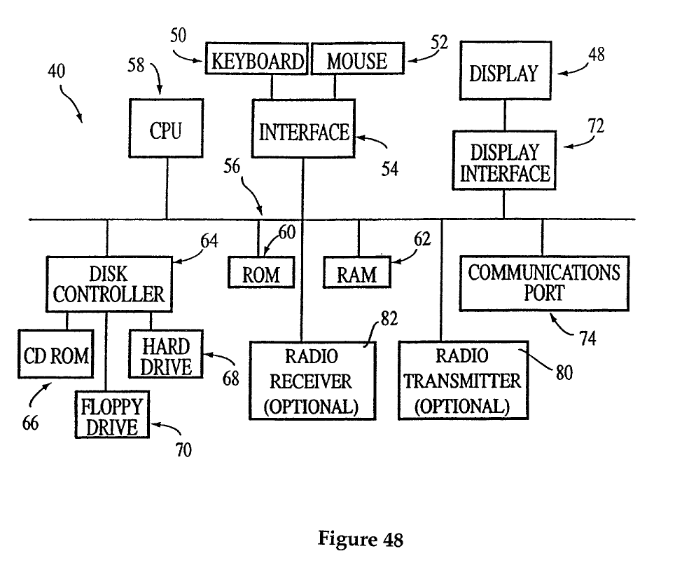

FIG. 48 is a block diagram of the internal hardware of the computer of FIG. 46 in accordance with a second embodiment. In FIG. 48, instead of utilizing an infrared transmitter or infrared receiver, the computer system uses at least one of a low power radio transmitter 80 and/or a low power radio receiver 82. The low power radio transmitter 80 transmits the signal for reception by components of the production process, and receives signals from the components via the low power radio receiver 82. The low power radio transmitter and/or receiver 80, 82 are standard devices in industry.

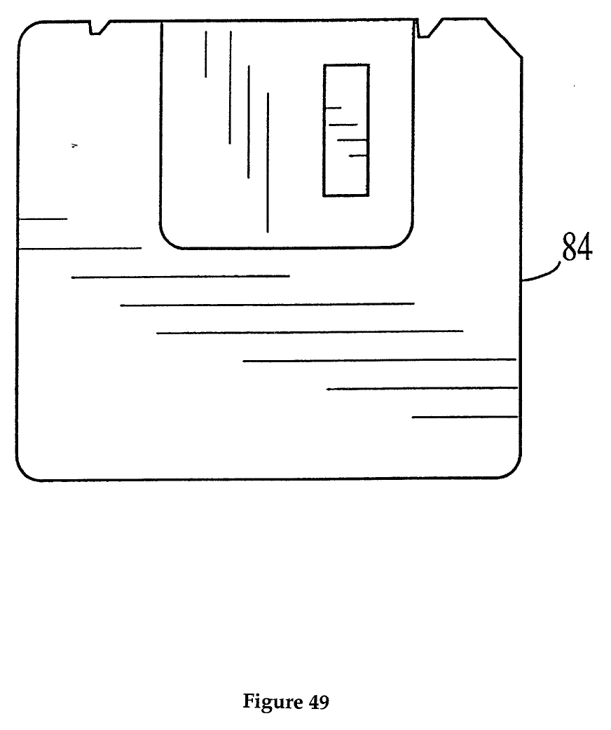

FIG. 49 is an illustration of an exemplary memory medium which can be used with disk drives illustrated in FIGS. 76-78. Typically, memory media such as floppy disks, or a CD ROM, or a digital video disk will contain, for example, a multi-byte locale for a single byte language and the program information for controlling the computer to enable the computer to perform the functions described herein. Alternatively, ROM 60 and/or RAM 62 illustrated in FIGS. 76-78 can also be used to store the program information that is used to instruct the central processing unit 58 to perform the operations associated with the production process.

Although processing system 40 is illustrated having a single processor, a single hard disk drive and a single local memory, processing system 40 may suitably be equipped with any multitude or combination of processors or storage devices. Processing system 40 may, in point of fact, be replaced by, or combined with, any suitable processing system operative in accordance with the principles of the present invention, including sophisticated calculators, and hand-held, laptop/notebook, mini, mainframe and super computers, as well as processing system network combinations of the same.

Conventional processing system architecture is more fully discussed in Computer Organization and Architecture, by William Stallings, MacMillam Publishing Co. (3rd ed. 1993); conventional processing system network design is more fully discussed in Data Network Design, by Darren L. Spohn, McGraw-Hill, Inc. (1993), and conventional data communications is more fully discussed in Data Communications Principles, by R. D. Gitlin, J. F. Hayes and S. B. Weinstain, Plenum Press (1992) and in The Irwin Handbook of Telecommunications, by James Harry Green, Irwin Professional Publishing (2nd ed. 1992). Each of the foregoing publications is incorporated herein by reference. Alternatively, the hardware configuration may be arranged according to the multiple instruction multiple data (MIMD) multiprocessor format for additional computing efficiency. The details of this form of computer architecture are disclosed in greater detail in, for example, U.S. Pat. No. 5,163,131; Boxer, A., Where Buses Cannot Go, IEEE Spectrum, February 1995, pp. 41-45; and Barroso, L. A. et al., RPM: A Rapid Prototyping Engine for Multiprocessor Systems, IEEE Computer February 1995, pp. 26-34, all of which are incorporated herein by reference.

In alternate preferred embodiments, the above-identified processor, and in particular microprocessing circuit 58, may be replaced by or combined with any other suitable processing circuits, including programmable logic devices, such as PALs (programmable array logic) and PLAs (programmable logic arrays), DSPs (digital signal processors), FPGAs (field programmable gate arrays), ASICs (application specific integrated circuits), VLSIs (very large scale integrated circuits) or the like.

It is to be understood that there are a large number of commercially available substitutes for each item of hardware which could be combined into fully compatible systems. Accordingly, the scope of the invention is not limited by the particularity of the hardware system described herein.

The methods which are described herein, are implemented, for example, on the hardware system(s) described herein (or other suitable computer system) by embodying the flow chart routines into a series of software packages that substantially follow the sequence of steps in the flow charts. There are conventional software packages that are commercially available that can also be adapted to perform one or more of the steps described herein. Accordingly, as described below, it would not be necessary in order to implement the invention to write separate software for each step from scratch.

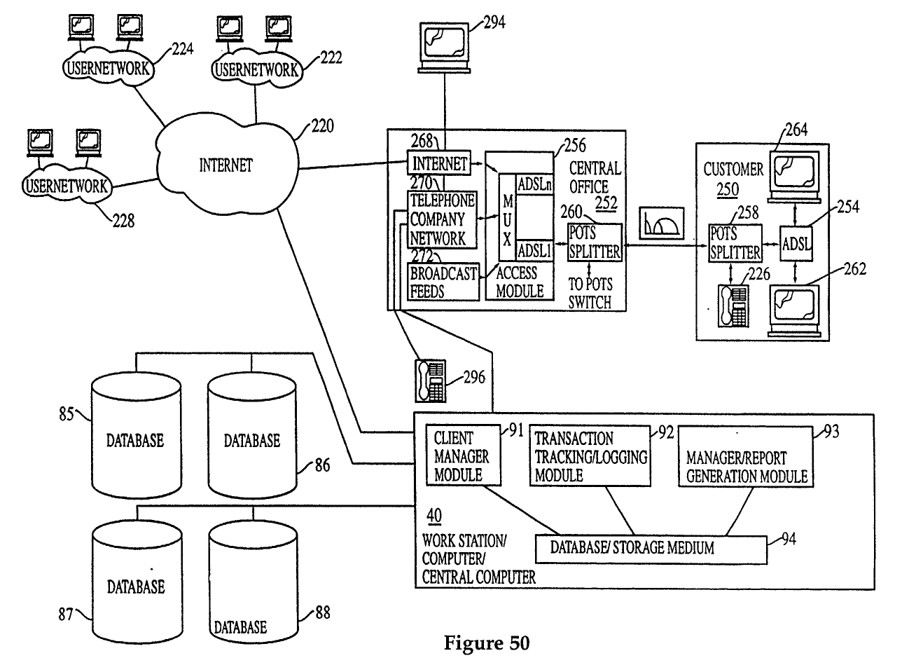

FIG. 50 is an illustration of the architecture of the combined internet, POTS, and ADSL architecture for use in the present invention in accordance with a first embodiment. In FIG. 50, to preserve POTS and to prevent a fault in the ADSL equipment 254, 256 from compromising analog voice traffic 226, 296 the voice part of the spectrum (the lowest 4 kHz) is separated from the rest by a passive filter, called a POTS splitter 258, 260. The rest of the available bandwidth—from about 10 kHz to 1 MHZ—carries data at rates up to 6 bits per second for every hertz of bandwidth from data equipment 262, 264, 294. The ADSL equipment 256 then has access to a number of destinations including significantly the Internet 268, and other destinations 270, 272.

To exploit the higher frequencies, ADSL makes use of advanced modulation techniques, the best known of which is the discrete multitone (DMT) technology. As its name implies, ADSL transmits data asymmetrically—at different rates upstream toward the central office 252 and downstream toward the subscriber 250. Cable television providers provide analogous Internet service to PC Users over their TV cable systems by means of special cable modems. Such modems are capable of transmitting up to 30 Mb/s over hybrid fiber/coax systems, which use fiber to bring signals to a neighborhood and coax to distribute it to individual subscribers.

Cable modems come in many forms. Most create a downstream data stream out of one of the 6-MHZ TV channels that occupy spectrum above 50 MHZ (and more likely 550 MHZ) and carve an upstream channel out of the 5-50-MHZ band, which is currently unused. Using 64-state quadrature amplitude modulation (64 QAM), a downstream channel can realistically transmit about 30 Mb/s (the oft-quoted lower speed of 10 Mb/s refers to PC rates associated with Ethernet connections). Upstream rates differ considerably from vendor to vendor, but good hybrid fiber/coax systems can deliver upstream speeds of a few megabits per second. Thus, like ADSL, cable modems transmit much more information downstream than upstream.

The internet architecture 220 and ADSL architecture 354, 356 may also be combined with, for example, User networks 222, 224, and 228. As illustrated in this first embodiment, Users may access or use or participate in the administration, management computer assisted program in computer 40 via various different access methods. In this first embodiment, the various databases are only accessible via access to and/or by computer system 40.

The above embodiments are only to be construed as examples of the various different types of computer systems that may be utilized in connection with the present invention. In addition, the various different reports may be modified and/or combined, to result in reports of different format, data arrangement, and the like. For example, data included in one report may be substituted, added and/or replaced for data in one or more other reports.

For example, the specific sequence of the above described process may be altered so that certain processes are conducted in parallel or independently of other processes, to the extent that the processes are not dependent upon each other. Thus, the specific order of steps described herein are not to be considered to imply a specific sequence of steps to perform the above described process. Each of the reports generated is not necessarily dependent on one another, and therefore, may be independently generated and/or utilized as described in the present application. Other alterations or modifications of the above processes are also contemplated. For example, further insubstantial approximations of the above processes are also considered within the scope of the processes described herein.

### CONCLUDING REMARKS

While the invention has been described in connection with specific and preferred embodiments thereof, it is capable of further modifications without departing from the spirit and scope of the invention. This application is intended to cover all variations, uses, or adaptations of the invention, following, in general, the principles of the invention and including such departures from the present disclosure as come within known or customary practice within the art to which the invention pertains, or are obvious to persons skilled in the art, at the time the departure is made. It should be appreciated that the scope of this invention is not limited to the detailed description of the invention hereinabove, which is intended merely to be illustrative, but rather comprehends the subject matter defined by the following claims.

As noted earlier, the term “Internet” includes closed proprietary data systems (dial-up networks) such as AOL. The term “article of manufacture” comprises an information storage medium encoded with a computer-readable data structure such as a storage device of an ISP used to encode HTML, JAVA, or other code.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Glossary of Terms

Compliance Request A written solicitation documenting the Content Vendor's acknowledgment of the final use of content within the project, and their wish that some or all of the licensing terms be enacted by the User. Compliance Requests might include invoices, requests for copies of the product and/or requests for other forms of compensation.

Content Commodity that enhances or describes a subject including but not limited to using visual, audio, or textual means.

Content Data Identification and technical information pertaining to content, such as captions, credit lines, cataloging numbers, and technical specifications.

Content Vendor An individual, group, or company that sells or licenses content.

Convey Transferring information or materials between Content Vendor(s), the Apparatus, third parties, and/or the User via any or all of the following means—e-mail, phone, fax, internet and/or world wide web, computer servers, electronic storage units (such as a CD Rom or hard drives), private shipping companies, and/or public mail services.

Enter Adding data into the Apparatus using a keyboard, software program, internet and/or world wide web application, modem, voice recognition, or other in-putting systems.

Fixed Publishing Specifications Guidelines that determine the potential commercial market for the project. They typically include, but are not limited to, the project medium (such as television broadcast, Web site, or trade book) purpose or genre (such as educational or promotional), the print run (such as “less than 40,000” or “four broadcasts within three years”), the geographic distribution (such as North America or worldwide), and the primary languages (such as English and Spanish) of the project. They may also include time frame (such as six months), companion products (such as an accompanying book or video), and/or release requirements (such as model or property releases). Fixed publishing specifications can be determined independently or substantially independent of the design and editing processes. Together with variable pricing specifications and qualitative content values, they are used to determine licensing terms for content.

Licensing Terms Contractual requirements, including but not limited to fees and complimentary copies of the product, imposed on the User by the Content Vendor as a condition for the use of the Content Vendor's content.

Manipulated (Content) Copy Content copy that has been incorporated into a draft of the project. A manipulated content copy may or may not be altered from its master/working content copy.

Master (Content) Copies Original embodiment of the content and/or a content embodiment that is suitable for printing, display, or broadcast.

Project Information Data that pertains to the administration, organization and management of the project, such as contact information for key personnel, service providers (such as shipping companies), budgets, accounting data, and technical requirements for the design/editing, printing, display, or broadcast of the project.

Qualitative Content Values Value premium assigned to content based on characteristics that can not be quantified, such as the significance of the content, the significance of the subject enhanced by the content, or the importance or reputation of the content creator. Together with fixed publishing specifications and variable pricing specifications, qualitative content values are used to determine licensing terms for content.

Research Fees Fees charged by the Content Vendor to provide content or a proposal of content for review and consideration by the User.

Submission Information Data pertaining to the source, components, action dates, physical condition, and/or identity of a piece or group of content or other valuable materials conveyed from one party to another.

Technical Requirements Mechanical or electronic standards for printing, displaying, or broadcasting content. There may be unique technical requirements for master and/or working copies of content.

Technical Specifications Mechanical or electronic attributes of a piece of content.

User Member or members of the project staff that are responsible for the obtaining, licensing, storing, and/or design and editing of content within the project.

Variable Pricing Specifications Guidelines that determine the value of a specific piece of content within the project. They typically include the size (such as a quarter page or full screen), location (such as front page, feature, or cover), and quantity of content used (such as four pieces of content from one source). Variable pricing specifications may also include value associated with non-traditional uses of content (such as flopping a photograph or manipulating the color of video footage.) Together with fixed publishing specifications and qualitative content values, they are used to determine licensing terms for content.

Potential Pricing Specifications Potential pricing specifications include all of the possible uses and combinations of uses of content within the project. They are typically determined before design and/or editing begin.

Final Pricing Specifications Final Pricing Specifications represent the use of content as designed and/or edited within the final published, broadcast, and/or displayed version of the project.

Working (Content) Copies Content embodiment that is used in the editing and design process. Working copies often do not meet the technical requirements for final publishing, display, or broadcast.

What is claimed is:

1. A computer implemented or computer assisted interactive process of facilitating at least one of licensing, management and tracking of valuable materials during production, tracking of budget expenditures, management of technical specifications, management of production specifications, compliance with contractual responsibilities, and storing of records associated therewith with a User and to authorize the User to use the content comprising at least one of images, sound, digital and/or analogue video footage, film footage, text, and data to be licensed within a project in accordance with the project specifications and the technical specifications, comprising at least one of the sequential, non-sequential and sequence independent steps of:
(a) generating administrative correspondence, documentation, and reports including administrative, technical, and contractual information to communicate and document at least one communication with third parties including at least one of Content Vendors, service providers and project staff;
(b) tracking content using at least one of submission, transfer, and return records and generating correspondence, documents, and reports to at least one of assist the User and automatically generate in completing and documenting each submission, transfer, and return of the content;
(c) designing and optionally editing content including determining associations of content, licensing terms and technical requirements, and generating a project proposal or use report relating to the licensing of the content to assist the User in obtaining and reviewing a financial estimate, contractual, and technical information; and
(d) optionally confirming final use of the content, compliance with the licensing terms, archiving of the content and the records associated therewith, and accessing and analyzing the records.

2. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said generating step (a) further comprises the step of generating the administrative correspondence, the documentation, and the reports to facilitate the licensing of the content and production of the content.

3. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said generating step (a) further comprises the step of generating the administrative correspondence, the documentation, and the reports in electronic format and transmitting to at least one of the third parties.

4. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said generating step (a) further comprises the step of using at least one template to organize licensing terms, technical specifications, and/or production specifications used to generate the administrative correspondence, the documentation, and the reports.

5. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said tracking step (b) further comprises the step of creating records of the content and related materials and tracking the content and the related materials associated therewith throughout the interactive process.

6. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said tracking step (b) further comprises the step of using at least one template to organize submission, transfer, and return records, and using at least one template to generate the correspondence, the documents, and the reports associated with submission, transfer, and return records.

7. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said designing step (c) further comprises the steps of linking master, working, and manipulated content copies of the content to content data, the technical specifications, and the licensing terms; generating the project proposal or the use report and the financial estimate; and optionally revising use information of the content responsive to said linking of at least one of the master, the working and the manipulated content, to assist the User in obtaining and reviewing the financial estimate for the licensing of the content.

8. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said confirming step (d) further comprises the steps of determining final pricing specifications for each piece of the content within the design; integrating the final pricing specifications with the contractual information; and creating notifications including listing final use specifications, associated licensing terms, and compliance instructions to the Content Vendors.

9. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said confirming step (d) further comprises the steps of storing the administrative information, the contractual information, the technical specifications, and use information together in an archive.

10. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said confirming step (d) further comprises the step of optionally linking and/or integrating the process with external processes including at least one of accounting, shipping, printing, and project management systems.

11. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said confirming step (d) further comprises the steps of accessing project records to verify compliance with the licensing terms; generating forms and documents to assist the User in re-licensing content for at least one of later editions and variations of the project; and generating reports comparing the financial, licensing, and use information with other projects to generate estimates for new projects.

12. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said confirming step (d) further comprises the steps of determining estimated re-licensing pricing specifications for each piece of the content when the design is to be re-licensed by accessing previously stored pricing specifications and licensing terms for the project when previously licensed; integrating the estimated re-licensing pricing specifications with the contractual information; and creating re-licensing use notifications including pricing specifications, publishing specifications, associated licensing terms, and compliance instructions for the Content Vendors for at least one of later editions and variations of the project; and optionally combining re-licensing notifications with notifications for new uses of new content with new licensing terms.

13. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said tracking step (b) further comprises the step of tracking the content and the records associated therewith, the records including working copy records, and optionally content data records and manipulated content records.

14. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein the records include a plurality of records associated with the project.

15. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said generating step (a) further comprises the step of using at least one template to organize and generate the administrative correspondence, the documentation, and the reports including the administrative, technical, and contractual information.

16. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User according to claim 1, wherein said confirming step (d) further comprises the steps of using at least one template to organize the use information and the content data, including the technical information, to generate lists and reports that assist the user in verifying that no technical or contractual problems exist in a final design; and organizing the use information and the content data, including the technical information, to generate the lists and the reports to assist the user in communicating the design and licensing information to a third party.

17. A computer implemented or computer assisted interactive process of facilitating at least one of licensing, management and tracking of valuable materials during production, tracking of budget expenditures, management of technical specifications, management of production specifications, compliance with contractual responsibilities, and archiving of records associated therewith with a User and to authorize the User to use the content comprising at least one of images, sound, digital and/or analogue video footage, film footage, text, and data to be licensed within a project in accordance with the project specifications and the technical specifications, comprising at least one of the sequential, non-sequential and sequence independent steps of:
(a) generating administrative correspondence, documentation, and reports including administrative, technical, and contractual information to communicate and document at least one communication with third parties including at least one of Content Vendors, service providers and project staff;
(b) tracking the content using a plurality of records, wherein at least one record is associated with a different data content to be licensed and the project includes a plurality of different data content to be licensed, and generating correspondence, documents, and reports to at least one of assist the User and automatically generate in completing and documenting the content to be licensed; and
(c) determining the licensing terms and the technical requirements, and generating a project proposal or use report for the project related to the licensing of the content to assist the User in obtaining and reviewing a financial estimate, contractual obligations, and technical information.

18. A computer program product storing computer instructions therein for instructing a computer to perform a process of facilitating at least one of licensing, management and tracking of valuable materials during production, tracking of budget expenditures, management of technical specifications, management of production specifications, compliance with contractual responsibilities, and archiving of records associated therewith with a User and to authorize the User to use the content comprising at least one of images, sound, digital and/or analogue video footage, film footage, text, and data to be licensed within a project in accordance with the project specifications and the technical specifications, the program product comprising:
a recording medium readable by the computer; and
the computer instructions stored on said recording medium instructing the computer to perform the process, the instructions and the process including at least one of the sequential, non-sequential and sequence independent functions of:
(a) generating administrative correspondence, documentation, and reports including administrative, technical, and contractual information to communicate and document at least one communication with third parties including at least one of Content Vendors, service providers and project staff;
(b) tracking the content using a plurality of records, wherein at least one record is associated with a different data content to be licensed and the project includes a plurality of different data content to be licensed, and generating correspondence, documents, and reports to at least one of assist the User and automatically generate in completing and documenting the content to be licensed; and
(c) determining the licensing terms and the technical requirements, and generating a project proposal or use report for the project relating to the licensing of the content to assist the User in obtaining and reviewing a financial estimate, contractual obligations, and technical information.

19. A computer implementing a process or assisting in interactive process of facilitating at least one of licensing, management and tracking of valuable materials during production, tracking of budget expenditures, management of technical specifications, management of production specifications, compliance with contractual responsibilities, and archiving of records associated therewith with a User and to authorize the User to use the content comprising at least one of images, sound, digital and/or analogue video footage, film footage, text, and data to be licensed within a project in accordance with the project specifications and the technical specifications, comprising:
(a) means for generating administrative correspondence, documentation, and reports including administrative, technical, and contractual information to communicate and document at least one communication with third parties including at least one of Content Vendors, service providers and project staff;
(b) means for tracking the content using a plurality of records, wherein at least one record is associated with a different data content to be licensed and the project includes a plurality of different data content to be licensed, and generating correspondence, documents, and reports to at least one of assist the User and automatically generate in completing and documenting the content to be licensed; and
(c) means for determining the licensing terms and the technical requirements, and generating a project proposal or use report for the project relating to the licensing of the content to assist the User in obtaining and reviewing a financial estimate, contractual obligations, and technical information.

20. A computer implemented or computer assisted process of facilitating at least one of the licensing of content, tracking of materials, management of technical requirements and technical specifications, estimating costs for the licensing of content, compliance with contractual responsibilities, tracking of budget expenditures, and/or archiving of records associated therewith between parties including a User and a Content Vendor, comprising at least one of the sequential, non-sequential, and sequence independent steps of:
(a) recording, accessing, and organizing at least one of administrative, vendor, contractual, technical and content information to create correspondence, documents, and reports required for at least one of the licensing process and the production process;
(b) tracking the materials including the content as the content is transferred between the parties;
(c) designing with the content, tracking and recording manipulations of the content during said design process, and optionally associating the manipulated content with the licensing terms and at least one of the technical specifications and the technical requirements; and
(d) reporting final licensing terms and archiving the records so that information can be accessed and manipulated to verify at least one of compliance of licensing terms, analyze financial information from the project, create estimates, track trends within the industry or with particular vendors, and re-license the content.
